(19) United States
(12) Patent Application Publication
(10) Pub. No.: US 2025/0214828 A1
(43) Pub. Date: Jul. 3, 2025

(54) COLORANT DISPENSER AND COLOR-PASTE OUTPOURING METHOD FOR COLORANT DISPENSER

(71) Applicant: ZHENGZHOU SANHUA TECHNOLOGY & INDUSTRY CO., LTD., Zhengzhou (CN)

(72) Inventor: Song Huang, Zhengzhou (CN)

(21) Appl. No.: 18/953,165

(22) Filed: Nov. 20, 2024

(30) Foreign Application Priority Data
Dec. 29, 2023 (CN) 202311871917.4

(51) Int. Cl. B67D 7/02; B67D 7/58; B67D 7/84

(52) U.S. Cl. CPC B67D 7/0288; B67D 7/58; B67D 7/84

(57) ABSTRACT

A colorant dispenser and a color-paste outpouring method for a colorant dispenser are provided. The colorant dispenser includes a pump, a first container, an outpouring tube and a second container, wherein the first container is configured to accommodate a color paste; the outpouring tube has an inlet end and an outlet end, wherein the inlet end is connected to the first container through the pump, and the outlet end is used for pouring out the color paste; and the outlet end has an operating state and a non-operating state, when the outlet end is in the operating state, the color paste is pumped into the second container from the outlet end, and when the outlet end is in the non-operating state, at least a part of the outlet end is located in a moisturizing space of the first container.

### CROSS REFERENCE TO RELATED APPLICATIONS

The present application claims the benefit of Chinese Patent Application No. 2023118719174 filed on Dec. 29, 2023, the contents of which are incorporated herein by reference in their entirety.

### TECHNICAL FIELD

The present disclosure relates to the field of colorant dispensing technologies, and specifically to a colorant dispenser and a color-paste outpouring method for a colorant dispenser.

### BACKGROUND ART

There is a time interval between two outpouring actions of an outpouring nozzle of a colorant dispenser, and thus problems of dryness and blockage of the outpouring nozzle may occur. Patent CN201310045508.9 and patent CN201410792555.4 propose an end recirculation technology for a color paste and an end recirculation compound-pump technology, which two solve the worldwide problems of dryness and blockage of a color-paste outpouring nozzle at low costs. In recent years, innovation of technologies in the industry has changed from improving colorant dispensing efficiency to developing anti-dryness and anti-blockage high-performance products, and particularly, different types of anti-blockage structures have been developed based on a concept of anti-blockage technology of the patent CN201410792555.4, and many extended patents based on the patent CN201410792555.4 have been applied.

As the colorant dispensing efficiency is difficult to improve, in order to improve competitiveness of products and win more user market, the idea of colorant dispensing innovation in the industry, based on the patent CN201410792555.4, is to refine and improve application of the anti-dryness and anti-blockage structure for the end recirculation in products, and based on this patent, many different models come into being and are also fully recognized by users around the world. Therefore, CN201410792555.4 not only extends from the latex paint dispensing field to the automotive refinishing paint field, but also constantly expanding to other fields in need of colorant dispensing, such as ink field, particularly nail enamel, oil wood paint and other fields in which there is no automatic colorant dispensing before.

To sum up, at least in the latex paint colorant dispensing field and the automotive refinishing paint dispensing field, there are a large number of colorant dispensing patent technologies centered on CN201410792555.4 worldwide, and thus in recent years, technical developments and technical improvements in the colorant dispensing field substantially focus on how to better use the technology of patent CN201310045508.9 and the technology of patent CN201410792555.4, and how to solve new technical problems arising from using the patent CN201310045508.9 and the patent CN201410792555.4.

For example, in the patent CN201310045508.9 and the patent CN201410792555.4, a reversing valve device is used to moisturize the outpouring nozzle. The reversing valve device includes a valve body and a valve core. The valve core is pivotally provided inside the valve body. The outpouring nozzle on the valve core has an outpouring position exposed outside and a moisturizing position hidden in the valve body. When the color paste is not poured out from the outpouring nozzle, the outpouring nozzle can be hidden in the valve body, and thus the outpouring nozzle can be prevented from blockage to some extent. However, the valve body with an outpouring nozzle may swell for some specific color pastes, and the valve body and the valve core have different swelling degrees, which causes a too large gap generated between the valve body and the valve core with the outpouring nozzle, easily causes leakage of the color paste or a color paint, and reduces accuracy of an outpouring amount of the color paste and color paint. The above problems are particularly more prominent for oil paints such as the automotive refinishing paint. Regarding some mineral-containing color pastes, wear is generated between the valve body and the valve core with an outpouring nozzle in the patent CN201310045508.9, the problem of leakage of the color paste may occur between the valve body and the valve core after long-term use, and likewise, the accuracy of the outpouring amount of the color paste and the color paint is also reduced. This problem is more prominent for water-based color pastes such as the latex paint.

In addition, for the colorant dispensing of oil paints, in the patent CN201310045508.9 and the patent CN201410792555.4, each time the color paint is poured out, the outpouring nozzle needs to be cleaned using a cleaning box containing an organic solvent and provided with a brush (or a flexible roller), while the organic solvent is volatile, a large amount of volatile gases adversely affect health of operators, and if such volatile organic gases are discharged from the colorant dispenser, manufacturing and using costs of the dispenser will be increased; moreover, a waste color paste brought about by cleaning the color-paste outpouring nozzle or a waste cleaning liquid appearing after cleaning the color paint, after being discarded, may pollute the environment.

### SUMMARY

The present disclosure provides a colorant dispenser. This colorant dispenser not only can moisturize an outlet end used for pouring out a color paste and reduce probability of problems of dryness and blockage occurring to the outlet end, but also can solve a problem of poor accuracy of an outpouring amount of the color paste caused by moisturizing the outlet end using a reversing valve device, a problem of wear of the valve core and the valve body, and a problem of environmental pollution.

The present disclosure is realized through following technical solutions.

In the first aspect, embodiments of the present disclosure provide a colorant dispenser, including a pump, a first container, an outpouring tube and a second container, wherein the first container is configured to accommodate a color paste; the outpouring tube has an inlet end and an outlet end, wherein the inlet end is connected to the first container through the pump, and the outlet end is configured for pouring out the color paste; and the outlet end has an operating state and a non-operating state, when the outlet end is in the operating state, the color paste is pumped into the second container from the outlet end, and when the outlet end is in the non-operating state, at least a part of the outlet end is located in a moisturizing space of the first container.

According to the colorant dispenser in the embodiments of the present disclosure, when the outlet end is in the non-operating state, by locating the outlet end in the moisturizing space, the humid environment in the moisturizing space can moisturize the outlet end, thus reducing the probability of problems of dryness and blockage occurring to the outlet end, and thus the accuracy of an outpouring amount from the outlet end meets requirements.

Moreover, the colorant dispenser of the embodiments of the present disclosure abandons the solution of moisturizing an outpouring nozzle (equivalent to the outlet end in the present disclosure) using the conventional reversing valve device, thus, there is no condition of poor accuracy of the outpouring amount of the color paste caused by swelling and wear. Moreover, when the gas appears in the color paste pipeline, the outlet end can be made in the non-operating state, and then the pump operates so as to discharge the color paste into the first container from the outlet end, so that the color paste can be directly poured into the first container while the gas in the color paste pipeline is discharged, and the problems of color paste waste and pollution will not occur.

Besides, for the colorant dispenser of the embodiments of the present disclosure, an evaporated gas of the color paste in the first container can be used to moisturize the outlet end, and thus it is unnecessary to clean the outlet end with any cleaning liquid, so that no waste cleaning liquid will be brought about by cleaning the outlet end, thereby avoiding occurrence of the problem of pollution to the environment caused by discarding the waste cleaning liquid.

According to some embodiments of the present disclosure, the moisturizing space is a space in the first container above a liquid level of the color paste. In the above technical solution, as there is the color paste in the first container, the color paste evaporates color paste vapor upwards into the moisturizing space, so that the humidity in the moisturizing space is relatively high. After the outlet end is located in the moisturizing space, the outlet end can be moisturized, thus reducing the probability of dryness and blockage occurring to the outlet end.

According to some embodiments of the present disclosure, the first container has a first highest liquid-level line, and the moisturizing space is a space in the first container above the first highest liquid-level line. In the above solution, the space in the first container is not completely filled up with the color paste, even if the liquid level of the color paste is flush with a first highest liquid level, an upper part of the space in the first container is still not filled up with the color paste, and in this case, a space above the first highest liquid-level line is the moisturizing space. As the outlet end is located above the first highest liquid-level line, the outlet end will never be inserted into the color paste, and the outlet end can be moisturized by a humid gas in the moisturizing space.

According to some embodiments of the present disclosure, a position of the outlet end is fixed; when the outlet end is in the non-operating state, the moisturizing space is closed; and when the outlet end is in the operating state, the moisturizing space is opened to allow the second container to enter the first container. In the above solution, the outlet end is fixed in position, and by closing or opening the moisturizing space, the outlet end is switched between the operating state and the non-operating state.

According to some embodiments of the present disclosure, the first container includes a canister body and a canister lid, wherein the canister body is configured for accommodating the color paste, the canister body has an opening, and the canister lid is configured for covering the opening; the canister lid includes a fixed portion and a movable portion, the fixed portion is fixed to the canister body, the outlet end is coupled to the fixed portion, and the outlet end is fixed relative to the canister body; and the movable portion is configured to move relative to the fixed portion, so as to close or open the moisturizing space. In the above solution, when the movable portion is moved to a position where the moisturizing space is opened, the second container in this case can be moved into the first container, so that the color paste can be pumped out from the outlet end into the second container, and in this case, the outlet end is in the operating state; when the movable portion is moved to a position where the moisturizing space is closed, the moisturizing space does not communicate with the outer space, the moisturizing space is a humid space, and in this case, the outlet end is located in the moisturizing space and is in the non-operating state, so that the moisturizing space can moisturize the outlet end.

According to some embodiments of the present disclosure, two movable portions are provided, the fixed portion is located between the two movable portions, and the two movable portions are configured to be rotatable relative to the fixed portion, so as to make the two movable portions move closer to or farther away from each other, thereby closing or opening the moisturizing space. In the above solution, after the two movable portions are close to each other, the moisturizing space is closed, so that the color paste vapor inside the moisturizing space will not overflow, and the outlet end can be ensured to be moisturized in the moisturizing space. After the two movable portions are away from each other, the moisturizing space is opened, so that the second container can enter the first container, thus facilitating pumping the color paste into the second container from the outlet end.

According to some embodiments of the present disclosure, the moisturizing space is a space in the first container below a liquid level of the color paste. In the above solution, the outlet end is no longer moisturized using the humid air in the moisturizing space, but is directly inserted into the color paste in the first container, thus reducing water loss of the color paste at the outlet end, so as to moisturize the outlet end, and reduce the probability of the problems of dryness and blockage occurring to the outlet end.

According to some embodiments of the present disclosure, when the outlet end is in the non-operating state, the outlet end is coupled to the first container, and when the outlet end is in the operating state, the outlet end is detached from the first container. In the above solution, the outlet end is optionally inserted into the first container. The outlet end has at least two states: a first state is that the outlet end is not inserted into the first container, and in this case, the outlet end is separated from the first container, and the color paste can be poured out into the second container; and a second state is that the outlet end is inserted into the first container, and in this case, the outlet end is coupled with the first container, and the outlet end is located in the moisturizing space, which can achieve the moisturizing effect.

According to some embodiments of the present disclosure, the first container has a first opening in a wall portion, and when the outlet end is in the non-operating state, the outlet end is coupled to the first opening. In the above solution, the outlet end can enter the first container through the first opening, so that when the outlet end is in the non-operating state, the humid air or the color paste in the first container can moisturize the outlet end, thus reducing the probability of the problems of dryness and blockage occurring to the outlet end.

According to some embodiments of the present disclosure, when the outlet end is in the non-operating state, the outlet end closes the first opening. In the above solution, the probability of the vapor in the first container escaping outwards can be reduced, so that the humidity in the first container is relatively high, and thus the outlet end can be moisturized more effectively, and the probability of dryness and blockage occurring to the outlet end is reduced.

According to some embodiments of the present disclosure, the first container includes a canister body and a leading-out pipe, wherein the leading-out pipe has a first end and a second end, the first end is connected to the canister body and communicates with an inner space of the canister body, and the second end has the first opening. In the above solution, the canister body no longer needs to be provided with an opening, and the outlet end can be directly inserted into the second end of the leading-out pipe. As the inner space of the leading-out pipe communicates with the inner space of the canister body, the color paste or the humid air in the canister body can enter the inner space of the leading-out pipe, so that the inner space of the leading-out pipe is a humid environment; therefore, the outlet end placed inside the leading-out pipe can be moisturized, thus reducing the probability of the problems of dryness and blockage occurring to the outlet end.

According to some embodiments of the present disclosure, the second end is higher than the first end. In the above solution, when there is no color paste inside the leading-out pipe, the gas with higher humidity can move upwards, and the humidity of the second end is higher, so that when the outlet end is inserted into the second end, the outlet end can be better moisturized.

According to some embodiments of the present disclosure, the first end is located below a liquid level of the color paste in the canister body, and the second end is located above the liquid level of the color paste in the canister body. In the above solution, the color paste in the canister body can flow towards the leading-out pipe, and part of water vapor of the color paste in the leading-out pipe evaporates, so that an upper space of the leading-out pipe is a humid environment, and when the outlet end is extended into the leading-out pipe, the outlet end can be moisturized. It may be understood that, when the outlet end is inserted into the leading-out pipe, the outlet end may be located in the upper space of the leading-out pipe and is not inserted into the color paste in the leading-out pipe, and certainly, the outlet end may also be directly inserted into the color paste in the leading-out pipe to be moisturized.

According to some embodiments of the present disclosure, the first end is located above a liquid level of the color paste in the canister body. In the above solution, the color paste in the canister body will not flow into the leading-out pipe. However, the humid air in the canister body may flow into the leading-out pipe, so that the inner space of the leading-out pipe always maintains a humid environment. After the outlet end is inserted into the inner space of the leading-out pipe, the outlet end can be moisturized, thus reducing the probability of the problems of dryness and blockage occurring to the outlet end.

According to some embodiments of the present disclosure, the first container includes a canister body and a canister lid, the canister body has a second opening in a top, the canister lid covers the second opening, and the first opening is formed at the canister lid. In the above solution, the canister body is used for accommodating the color paste. The canister body and the canister lid together define an inner space of the first container. The canister body is provided with a second opening in a top. The color paste can be poured into the first container through the second opening. The preceding process is a process of feeding the first container, and after the preceding process is finished, the second opening can be closed by the canister lid.

According to some embodiments of the present disclosure, the outlet end is provided with a sealing structure, and when the outlet end is in the non-operating state, the sealing structure closes the first opening. In the above solution, in the process of the moisturizing space moisturizes the outlet end, the first opening is sealed by the sealing structure, so that the first opening will not communicate the inner space of the first container with the outer space, the high-humidity gas in the moisturing space will not flow to the outer space, so that relatively high humidity is always kept for the air in the first container.

According to some embodiments of the present disclosure, the sealing structure is a sealing lid, and when the outlet end is in the non-operating state, the sealing lid is coupled with the canister lid. In the above solution, the sealing structure is a sealing lid, when the outlet end is in the non-operating state, the sealing lid is coupled with the canister lid, so that the sealing lid can be firmly mounted on the canister lid, the sealing stability of the sealing lid sealing the first opening is improved, and the probability of the high-humidity gas in the first container escaping outwards is further reduced.

According to some embodiments of the present disclosure, the sealing lid has a first through hole, the outlet end passes through the first through hole and is fixedly connected to the sealing lid. In the above solution, the outlet end can pass through the first through hole and communicate with the inner space of the first container, and the high-humidity gas or the color paste in the inner space of the first container can moisturize the outlet end.

According to some embodiments of the present disclosure, when the outlet end is in the non-operating state, the sealing lid is magnetically connected to the canister lid. In the above solution, the sealing lid and the canister lid can be magnetically fitted; therefore, when the sealing lid approaches the canister lid, a magnetic attraction between the two will pull the sealing lid closer to the canister lid, which can play a role in positioning. In addition, when the outlet end needs to be switched to the operating state, the magnetic attraction may be easily overcome to complete this action.

According to some embodiments of the present disclosure, when the outlet end is in the non-operating state, the sealing lid is snap-fitted with the canister lid. In the above solution, the sealing lid is clamped with the canister lid, thus the connection is convenient, the structure is simple, and the sealing lid can be easily detached from the canister body when the outlet end needs to be switched from the non-operating state to the operating

According to some embodiments of the present disclosure, a plane where the first opening is located is provided obliquely relative to a horizontal plane. In the above solution, the plane where the first opening is located is provided obliquely relative to the horizontal plane, so that the first opening is an oblique opening, and in this way, covering the sealing lid at the first opening facilitates separation or coupling of the sealing lid from or with the canister lid.

According to some embodiments of the present disclosure, the first container is fixed, and the colorant dispenser further includes a first driving mechanism, wherein the first driving mechanism is connected to the sealing lid, and the first driving mechanism is configured to drive the sealing lid to move, so as to make the sealing lid to be couple with or separate from the canister lid. In the above solution, the sealing lid is driven by the first driving mechanism to move, so that the sealing lid is coupled with or separated from the canister lid; further, the first driving mechanism can indirectly drive the outlet end to be inserted into the inner space of the first container or detached from the inner space of the first container.

According to some embodiments of the present disclosure, the sealing structure is a sealing cone. In the above solution, in a process of switching the outlet end to the non-operating state, a small end of the sealing cone is gradually inserted into the first opening. The sealing cone can play a role in positioning, and the small head of the sealing cone gradually presses against an inner peripheral wall of the first opening, so that at least a part of the sealing cone is in interference fit with the first opening, and thus when the outlet end is in the non-operating state, the sealing structure can seal the first opening more effectively, reducing the probability of the high-humidity gas in the inner space of the first container escaping outwards.

According to some embodiments of the present disclosure, the first container includes a first sub-container and a second sub-container, wherein the first sub-container has a paste outlet at bottom, the paste outlet communicates with an inner space of the second sub-container, the first opening is formed on a top wall of the second sub-container, the inner space of the second sub-container communicates with outside, and the paste outlet is lower than the top wall of the second sub-container;

an inlet of the pump communicates with the inner space of the second sub-container, and when the outlet end is in the non-operating state, the outlet end is coupled to the first opening and inserted into the inner space of the second sub-container. In the above solution, as long as there is color paste in the first sub-container, when the liquid level of the color paste in the second sub-container is lower than the paste outlet, the color paste in the first sub-container can be supplemented into the second sub-container. The first sub-container can supplement the color paste for the second sub-container.

According to some embodiments of the present disclosure, the moisturizing space is a space in the second sub-container above the liquid level of the color paste. In the above solution, the outlet end is not inserted into the color paste in the second sub-container, but is inserted into the humid air in the second sub-container, and is moisturized by the humid air in the second sub-container, thus reducing the probability of the problems of dryness and blockage occurring to the outlet end.

According to some embodiments of the present disclosure, the moisturizing space is a space in the second sub-container below the liquid level of the color paste. In the above solution, the outlet end can be moisturized by the color paste in the second sub-container when being in the non-operating state, thus reducing the probability of the problems of dryness and blockage occurring to the outlet end.

According to some embodiments of the present disclosure, the first container includes a first sub-container and a second sub-container, wherein the second sub-container is located outside the first sub-container, and an inner space of the first sub-container does not communicate with an inner space of the second sub-container;
the first sub-container is configured for accommodating the color paste, an inlet of the pump communicates with the inner space of the first sub-container, the first opening is formed in the second sub-container, and when the outlet end is in the non-operating state, the outlet end is coupled to the first opening and is inserted into the inner space of the second sub-container. In the above solution, an independent second sub-container is additionally provided to moisturize the outlet end. The second sub-container can be provided therein with the color paste, or the second sub-container may contain an object capable of wetting the inner space of the second sub-container. For example, this object may be water contained in the second sub-container, and the water may evaporate to make the space above water surface be a humid space. Alternatively, this object is a humidifier inside the second sub-container, and the inner space of the second sub-container is humidified by a humidifying effect of the humidifier.

According to some embodiments of the present disclosure, the first container includes a canister body, the canister body has a first opening in a top, the outlet end is provided with a canister lid, and when the outlet end is in the non-operating state, the canister lid seals the first opening. In the above solution, when the outlet end is in the non-operating state, the canister lid fixedly connected to the outlet end can seal the inner space of the first container, thus reducing the probability of the color paste vapor in the inner space of the first container escaping outwards, and thereby improving the moisturizing effect of the inner space of the first container on the outlet end.

According to some embodiments of the present disclosure, the first container is provided therein with a partitioning portion so as to divide the inner space of the first container into a first subspace and a second subspace, wherein the first subspace has a volume larger than that of the second subspace, an inlet of the pump communicates with the first subspace; and when the outlet end is in the non-operating state, the outlet end is inserted into the second subspace. In the above solution, by inserting the outlet end into the second subspace to be moisturized, when there is less color paste in the first subspace or the humidity of the gas in an upper part of the first subspace is relatively low, the color paste in the second subspace can still make humidity of an upper space of the second subspace higher, thus moisturizing the outlet end more effectively.

According to some embodiments of the present disclosure, the partitioning portion has an overflow hole, the overflow hole is configured to guide the color paste in the second subspace to the first subspace when an amount of the color paste in the second subspace reaches a threshold. In the above solution, the color paste in the second subspace can be kept at the threshold, and a case that the outlet end has no accommodation space due to excess color paste is avoided. For example, the outlet end is inserted into the humid air in the second subspace, and if the color paste fills the second subspace without constraint, the outlet end is necessarily flooded with the color paste.

According to some embodiments of the present disclosure, a position of the outlet end is fixed, and the first container is movable relative to the outlet end. In the above solution, the first container may be an active member, so as to make the first container couple with or separate from the outlet end, so that the outlet end can be switched between the operating state and the non-operating state.

According to some embodiments of the present disclosure, a position of the outlet end is fixed, and the colorant dispenser further includes: a first driving mechanism, wherein the first driving mechanism is connected to the first container, and the first driving mechanism is configured to drive the first container to move, so as to make the first container couple with or separate from the outlet end. In the above solution, the first container may be an active member, and the first driving mechanism can drive the first container to move actively so as to make the first container couple with or separate from the outlet end.

According to some embodiments of the present disclosure, the colorant dispenser further includes a fixed frame, and the outlet end is fixedly connected to the fixed frame. In the above solution, the outlet end can remain stationary, and the first container is driven by the first driving mechanism to move, so that the first container is close to or away from the outlet end.

According to some embodiments of the present disclosure, the first driving mechanism is configured to drive the first container to rotate. In the above solution, the first container can rotate around an axis, and particularly, a part of the first container connected to the outlet end can move along an arc-shaped track, so that the first container is connected to or separated from the outlet end.

According to some embodiments of the present disclosure, the colorant dispenser further includes: a second driving mechanism, connected to the second container, so as to drive the second container to move to below the outlet end after the outlet end is separated from the first container. In the above solution, after the outlet end is separated from the first container, the second driving mechanism can drive the second container to move to below the outlet end, so that the outlet end can be in the operating state.

According to some embodiments of the present disclosure, a position of the first container is fixed, and the outlet end is movable relative to the first container. In the above solution, the outlet end can be an active member, so that the outlet end is coupled with or separated from the first container, and thus the outlet end can be switched between the operating state and the non-operating state.

According to some embodiments of the present disclosure, the position of the first container is fixed, and the colorant dispenser further includes: a first driving mechanism, wherein the first driving mechanism is connected to the outlet end, and the first driving mechanism is configured to drive the outlet end to move, so as to make the outlet end connect with or separate from the first container. In the above solution, the outlet end may be an active member, and the first driving mechanism can drive the outlet end to move actively, so as to couple or separate the outlet end.

According to some embodiments of the present disclosure, a plurality of the first containers are provided, and the colorant dispenser further includes: a carrying mechanism, configured to carry a plurality of the first containers and choose one of a plurality of the first containers and move it to a position butt-joined with the first driving mechanism. In the above solution, the carrying mechanism can drive the first containers thereon to move to the position butt-joined with the first driving mechanism. Thus, the outlet end on the first container located in the position butt-joined with the first driving mechanism or the first container can be driven by the first driving mechanism to be connected or separated.

According to some embodiments of the present disclosure, the carrying mechanism is a linear reciprocating mechanism. In the above solution, the carrying mechanism can move back and forth in a linear direction, so that when the color paste of a certain color is needed, the first container loaded with the color paste of this color can be moved to the position butt-joined with the first driving mechanism, and the color paste is pumped outwards from the outlet end corresponding to this first container. After the color paste of this color is completely poured out, the outlet end can be inserted into this first container, and then the carrying mechanism is moved to reset this first container, or the carrying mechanism is moved to move the first container loaded with the color paste of another color to the position butt-joined with the first driving mechanism.

According to some embodiments of the present disclosure, the carrying mechanism is a rotating mechanism. In the above solution, the carrying mechanism can rotate, so that when the color paste of a certain color is needed, the first container loaded with the color paste of this color can be rotated to the position butt-joined with the first driving mechanism, so that the color paste is pumped outwards from the outlet end corresponding to this first container. After the color paste of this color is completely poured out, the outlet end can be inserted into this first container, and then the carrying mechanism is rotated to reset this first container, or the carrying mechanism is moved to rotate the first container loaded with the color paste of another color to the position butt-joined with the first driving mechanism.

According to some embodiments of the present disclosure, a plurality of the first driving mechanism and a plurality of the first container are provided and are in a one-to-one correspondence, wherein each of the first driving mechanisms is configured to drive the corresponding outlet end to move, so as to make the outlet end couple with or separate from the first container. In the above solution, each first container has a dedicated first driving mechanism to drive the outlet end to move, so that the outlet end can be switched between the non-operating state and the operating state. Each outlet end moves more flexibly, and a plurality of outlet ends can even be switched together to the operating state for pouring out the color paste into the second container.

According to some embodiments of the present disclosure, the outpouring tube is provided with a valve structure configured to control an outpouring amount or opening and closing of the outlet end. In the above solution, when the outlet end is in the operating state, the amount of color paste pumped out from the outlet end into the second container can be controlled by the valve structure, so that the second container can be ensured to receive an appropriate amount of color paste.

In the second aspect, embodiments of the present disclosure provide a color-paste outpouring method for a colorant dispenser, wherein the colorant dispenser is the colorant dispenser according to any one of the above embodiments, and the color-paste outpouring method at least includes steps of:
pumping out the color paste from the outlet end; and
the pump operating so as to make the color paste in the outpouring tube move in a direction towards the first container by a preset distance.

In the color-paste outpouring method provided in the embodiments of the present disclosure, in the process of switching the outlet end between the non-operating state and the operating state, if the position of the outlet end in the operating state is different from the position in the non-operating state, in the process of moving the outlet end, by using the color-paste outpouring method of the embodiments of the present disclosure, the problem of the color paste drop dropping downwards from the outlet end and contaminating the canister body is alleviated. Meanwhile, as the color paste drop no longer protrudes from the end portion of the outlet end, when the outlet end is in the operating state and the color paste is poured outwards, the accuracy of the outpouring amount of the color paste is improved.

According to some embodiments of the present disclosure, pumping out the color paste from the outlet end refers to pumping out the color paste from the outlet end in the operating state, or pumping out the color paste from the outlet end in the non-operating state. In the above solution, after the outlet end is in the operating state and the color paste is poured out, the pump can operate and make the color paste in the outpouring tube to be sucked back for a certain distance, so that the color paste drop will not protrude from an end surface of the outlet end. Alternatively, after the outlet end is in the non-operating state and the color paste is poured out, the pump can operate and make the color paste in the outpouring tube to be sucked back for a certain distance, so that the color paste drop will not protrude from the end surface of the outlet end.

According to some embodiments of the present disclosure, a distance between a liquid level of the color paste in the outpouring tube and the end surface of the outlet end is s, satisfying 0 mm≤s≤5 mm. In the above solution, the color paste drop in the outpouring tube can be ensured not to protrude from the end surface of the outlet end, and meanwhile, the problem that the accuracy of outpouring amount of the color paste is reduced due to a too large distance between the liquid level of the color paste in the outpouring tube and the end surface of the outlet end will not appear.

In the third aspect, embodiments of the present disclosure provide a color-paste outpouring method for a colorant dispenser, wherein the colorant dispenser is the colorant dispenser according to any one of the above embodiments, and the color-paste outpouring method at least includes a plurality of of:
making the outlet end in the non-operating state; and
the pump operating so as to pour out the color paste in the outlet end into the first container.

According to the color-paste outpouring method in the embodiments of the present disclosure, when the outlet end is in the non-operating state, the color paste vapor in the moisturizing space or the color paste can moisturize the outlet end, and when the outlet end is in the non-operating state, the color paste at the outlet end can be poured out through the pump, the previous color paste at the outlet end is replaced by the fresh color paste, thus further reducing the probability of dryness and blockage occurring to the outlet end. In addition, as the outlet end is located in the first container, the color paste pumped out from the outlet end can flow back into the color paste in the first container, and the problem of wasting the color paste will not occur.

Additional aspects and advantages of the present disclosure will be partially given in the following description, and partially become apparent from the following description, or be comprehended by practicing the present disclosure.

### BRIEF DESCRIPTION OF DRAWINGS

In order to more clearly illustrate technical solutions of embodiments of the present disclosure, drawings which need to be used in the embodiments will be briefly introduced below. It should be understood that the drawings merely show some embodiments of the present disclosure, and thus should not be considered as limitation to the scope. Those ordinarily skilled in the art still could obtain other relevant drawings according to these drawings, without using any inventive efforts.

FIG. 1 is a schematic view of a colorant dispenser provided in an embodiment of the present disclosure (an outlet end is in a non-operating state);

FIG. 2 is a schematic view of the colorant dispenser provided in an embodiment of the present disclosure (the outlet end is in an operating state);

FIG. 3 is a schematic view of the colorant dispenser provided in another embodiment of the present disclosure (the outlet end is in the non-operating state and a part of the outlet end is configured as a spray nozzle);

FIG. 4 is a schematic view of the colorant dispenser provided in another embodiment of the present disclosure (the outlet end is in the operating state and a part of the outlet end is configured as the spray nozzle);

FIG. 5 is a sectional view of a first container provided in an embodiment of the present disclosure;

FIG. 6 is a schematic view of the colorant dispenser provided in a further embodiment of the present disclosure (the outlet end is in the non-operating state);

FIG. 7 is a schematic view of the colorant dispenser provided in a further embodiment of the present disclosure (the outlet end is in the operating state);

FIG. 8 is a schematic view of the colorant dispenser provided in a further embodiment of the present disclosure (the outlet end is in the non-operating state);

FIG. 9 is a schematic view of the colorant dispenser provided in a further embodiment of the present disclosure (the outlet end is in the operating state);

FIG. 10 is a schematic view of the colorant dispenser provided in a further embodiment of the present disclosure (the outlet end is in the non-operating state);

FIG. 11 is a schematic view of the colorant dispenser provided in a further embodiment of the present disclosure (the outlet end is in the operating state);

FIG. 12 is a schematic view of the colorant dispenser provided in a further embodiment of the present disclosure (the outlet end is in the non-operating state);

FIG. 13 is a schematic view of the colorant dispenser provided in a further embodiment of the present disclosure (the outlet end is in the operating state);

FIG. 14 is a schematic view of the colorant dispenser provided in a further embodiment of the present disclosure (the outlet end is in the non-operating state);

FIG. 15 is a schematic view of the colorant dispenser provided in a further embodiment of the present disclosure (the outlet end is in the operating state);

FIG. 16 is a schematic view of the colorant dispenser provided in a further embodiment of the present disclosure (the outlet end is in the non-operating state);

FIG. 17 is a schematic view of the colorant dispenser provided in a further embodiment of the present disclosure (the outlet end is in the operating state);

FIG. 18 is a schematic view of the colorant dispenser provided in a further embodiment of the present disclosure (the outlet end is in the non-operating state);

FIG. 19 is a schematic view of the colorant dispenser provided in a further embodiment of the present disclosure (the outlet end is in the operating state);

FIG. 20 is a schematic view of the colorant dispenser provided in a further embodiment of the present disclosure (a carrying mechanism is a linear reciprocating mechanism);

FIG. 21 is a schematic view of the colorant dispenser provided in a further embodiment of the present disclosure (the carrying mechanism is a rotating mechanism);

FIG. 22 is a schematic view of the colorant dispenser provided in a further embodiment of the present disclosure (a pump is in an inverted state);

FIG. 23 is a schematic view of the colorant dispenser provided in a further embodiment of the present disclosure (the pump is in an upright state);

FIG. 24 is a schematic view of the colorant dispenser provided in a further embodiment of the present disclosure (an outpouring tube is mounted with a valve structure);

FIG. 25 is a schematic view of the colorant dispenser provided in a further embodiment of the present disclosure (a lid body is provided at the outlet end, and the outlet end is in the non-operating state);

FIG. 26 is a partial sectional view of the colorant dispenser provided in a further embodiment of the present disclosure (the lid body is provided at the outlet end, and the outlet end is in the non-operating state);

FIG. 27 is a schematic view of the colorant dispenser provided in a further embodiment of the present disclosure (the lid body is provided at the outlet end, and the outlet end is in the operating state);

FIG. 28 is a schematic view of the colorant dispenser provided in a further embodiment of the present disclosure (a second sub-container is located outside a first sub-container, and the outlet end is in the non-operating state);

FIG. 29 is a schematic view of the colorant dispenser provided in a further embodiment of the present disclosure (the second sub-container is located outside the first sub-container, and the outlet end is in the operating state);

FIG. 30 is a schematic view of the colorant dispenser provided in a further embodiment of the present disclosure (a movable portion is closed so as to make the outlet end in the non-operating state);

FIG. 31 is a schematic view of the colorant dispenser provided in a further embodiment of the present disclosure (the movable portion is opened so as to make the outlet end in the operating state);

FIG. 32 is a flowchart of a color-paste outpouring method in an embodiment of the present disclosure;

FIG. 33 is a flowchart of the color-paste outpouring method in another embodiment of the present disclosure;

FIG. 34 is a structural schematic view of the first container and the outpouring tube in the colorant dispenser provided in some embodiments of the present disclosure;

FIG. 35 is a structural schematic view of the outlet end along with a sealing lid in FIG. 34 being separated from the first container;

FIG. 36 is a structural schematic view of a guiding mechanism connected between the sealing lid and a canister lid in the colorant dispenser provided in some embodiments of the present disclosure;

FIG. 37 is a schematic view of a state in which the sealing lid and the canister lid in FIG. 36 are separated;

FIG. 38 is an exploded schematic view of the first container in the colorant dispenser provided in some embodiments of the present disclosure;

FIG. 39 is a structural schematic view of the outpouring tube and the sealing lid in the colorant dispenser provided in some embodiments of the present disclosure;

FIG. 40 is a structural schematic view of the sealing lid provided in some embodiments of the present disclosure;

FIG. 41 is a partial sectional view of the outlet end in FIG. 40;

FIG. 42 is a structural schematic view of the canister lid provided in some embodiments of the present disclosure;

FIG. 43 is a structural schematic view of a separated state of the sealing lid and the canister lid provided in some embodiments of the present disclosure;

FIG. 44 is a structural schematic view of an opening plane of a first opening in the canister lid being a multi-plane provided in some embodiments of the present disclosure;

FIG. 45 is a structural schematic view of magnetic connection between the sealing lid and the canister lid provided in some embodiments of the present disclosure;

FIG. 46 is a structural schematic view of clamping of the sealing lid and the canister lid provided in some embodiments of the present disclosure;

FIG. 47 is an enlarged schematic view of A in FIG. 46;

FIG. 48 is a structural schematic view of a first driving mechanism provided in some embodiments of the present disclosure;

FIG. 49 is a structural schematic view of a moving member and clamping arms in FIG. 48;

FIG. 50 is a structural schematic view of the clamping arms in the first driving mechanism being in an unfolded state provided in some embodiments of the present disclosure;

FIG. 51 is a structural schematic view of the clamping arms in the first driving mechanism being about to clamp the sealing lid provided in some embodiments of the present disclosure;

FIG. 52 is a structural schematic view of the clamping arms in the first driving mechanism clamping the sealing lid provided in some embodiments of the present disclosure;

FIG. 53 is a structural schematic view of the clamping arms in the first driving mechanism clamping the sealing lid to move provided in some embodiments of the present disclosure;

FIG. 54 is a structural schematic view of the clamping arms in the first driving mechanism clamping the sealing lid to move to a paste outlet position provided in some embodiments of the present disclosure;

FIG. 55 is a structural schematic view of the colorant dispenser provided in some embodiments of the present disclosure;

FIG. 56 is a structural schematic view of inner sides of the clamping arms in a pulling structure being provided with anti-slip stripes provided in some embodiments of the present disclosure;

FIG. 57 is a structural schematic view of the clamping arms in FIG. 56 clamping the sealing lid;

FIG. 58 is a structural schematic view of a clamping component in the pulling structure being in an open state provided in some other embodiments of the present disclosure;

FIG. 59 is a structural schematic view of the clamping component in the pulling structure clamping the sealing lid provided in some other embodiments of the present disclosure;

FIG. 60 is a structural schematic view of the clamping component in the pulling structure pulling the sealing lid to move provided in some other embodiments of the present disclosure;

FIG. 61 is a structural schematic view of the pulling structure being in an up-down clamping manner provided in some embodiments of the present disclosure;

FIG. 62 is a structural schematic view of FIG. 61 from another angle;

FIG. 63 is a structural schematic view of the pulling structure clamping the sealing lid in an up-down moving manner provided in some embodiments of the present disclosure;

FIG. 64 is a structural schematic view of a press-down portion in FIG. 63 moving along a first guiding slot after being in contact with the sealing lid;

FIG. 65 is an enlarged schematic view of B in FIG. 64;

FIG. 66 is a structural schematic view of the press-down portion in FIG. 63 moving to a third position; and

FIG. 67 is an enlarged schematic view of C in FIG. 66.

### REFERENCE SIGNS

100—colorant dispenser;
10—first container; 11—canister body; 12—leading—out pipe; 121—first end; 122—second end; 13—canister lid; 134—fixed portion; 135—movable portion; 14—first sub—container; 141—supplementing pipe; 15—second sub—container; 131—second magnetic part; 132—second mounting groove; 133—mating portion; 101—moisturizing space; 102—first opening; 1021—first plane; 1022—second plane; 103—paste outlet; 104—second opening;
20—outpouring tube; 21—inlet end; 22—outlet end; 221a—sealing cone; 221—first pipe section; 222—second pipe section; 222a—fifth end; 222b—sixth end; 23—bent section; 201—first through hole;
30—sealing lid; 31—body; 310—top wall; 311—first side wall; 312—second side wall; 313—reinforcing rib; 314—first magnetic part; 315—first mounting groove; 316—snap-in portion; 3160—third end; 3161—fourth end; 3162—notch; 317—flip-top; 3170—protrusion; 3171—second raised point; 3172—first pull-connection end; 3173—second pull-connection end; 32—sleeve; 33—guiding unit; 331—first hinge member; 332—second hinge member;
40—second container;
50—pump; 51—diversion valve;
60—partitioning portion; 101b—first subspace; 101c—second subspace; 601—overflow hole;
70—first driving mechanism; 71—base; 72—grabbing unit; 7201—moving member; 7202—clamping arm; 72021—slot; 72022—first anti-slip stripe; 7203—guiding plate; 72031—front end; 7204—resilient member; 73—driving unit; 730—first driving member; 7301—motor base; 7302—pull rod rack; 7303—coupling; 731—first lead screw; 732—guiding rod; 733—first screw nut; 734—pulley; 735—timing belt; 7352—second lead screw; 7353—second screw nut; 7354—guiding mechanism; 736—bracket; 737—sliding rail; 7371—first guiding slot; 7372—first opening end; 738—press-down portion; 7381—press-down claw; 7382—second guiding slot; 7383—second opening end; 7384—first upper stop end; 739—supporting portion; 7391—tension spring;
81—fixed frame; 810—mounting rack; 8101—grappler-arm guiding rail; 8102—top leaf spring; 811—gripper base; 8110—guiding hole; 812—grappler-arm push column; 813—clamping component; 8130—grappler arm; 8131—grappler-arm reset spring; 8132—grappler-arm driving plate; 8134—sliding hole; 8135—grappler-arm rotation shaft; 814—screw motor; 815—screw; 816—blocking plate; 817—grappler-arm guiding shaft; 82—carrying mechanism; 83—valve structure; X—first direction; Y—second direction;
91—second driving mechanism; 92—third driving mechanism.

### DETAILED DESCRIPTION OF EMBODIMENTS

In order to make objectives, technical solutions and advantages of the embodiments of the present disclosure more clear, the technical solutions in the embodiments of the present disclosure will be described clearly and completely below in conjunction with the drawings in the embodiments of the present disclosure. Apparently, some but not all embodiments of the present disclosure are described. All of other embodiments obtained by those ordinarily skilled in the art based on the embodiments in the present disclosure without using any inventive efforts shall fall within the scope of protection of the present disclosure.

Unless otherwise defined, all of the technical and scientific terms used in the present disclosure have the same meanings as those commonly understood by those skilled in the art to which the present disclosure belongs; the terms used in the description of the present disclosure are merely for the purpose of describing specific embodiments, but are not intended to limit the present disclosure; the terms “comprise (include)” and “have” and any variations thereof in the description, the claims and the above BRIEF DESCRIPTION OF DRAWINGS of the present disclosure are intended to cover non-exclusive inclusions. The terms “first”, “second” and the like in the description and the claims or the above drawings of the present disclosure are used to distinguish different objects, rather than describing a specific order or a primary-secondary relationship.

The phrase “embodiment” referred to in the present disclosure means that specific features, structures or characteristics described in conjunction with the embodiment may be contained in at least one embodiment of the present disclosure. This phrase appearing at various positions of the description does not necessarily refer to the same embodiment, or an independent or alternative embodiment mutually exclusive of another embodiment. Those skilled in the art understand, in explicit and implicit manners, that an embodiment described in the present disclosure may be combined with other embodiments.

In the description of the present disclosure, it needs to be indicated that unless otherwise specified and defined explicitly, the terms “mount” and “connect” should be construed in a broad sense. For example, it may be a fixed connection, a detachable connection, or an integrated connection; it may be a direct connection, an indirect connection through an intermediary, or inner communication between two elements. For those ordinarily skilled in the art, specific meanings of the above terms in the present disclosure could be understood according to specific circumstances.

The term “and/or” in the present disclosure is merely an association relationship describing associated objects, and indicates that three relationships may exist, for example, “A and/or B” may indicates three situations: A exists alone, both A and B exist, and B exists alone. In addition, the character “/” in the present disclosure generally means that associated objects before and after the character are in an “or” relationship.

The term “a plurality of” appearing in the present disclosure means two or more (including two).

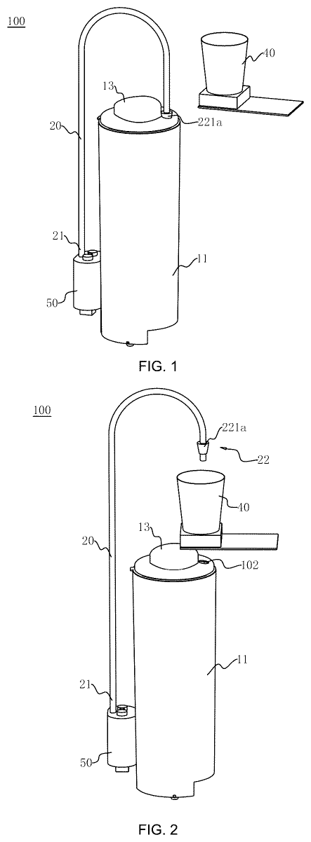

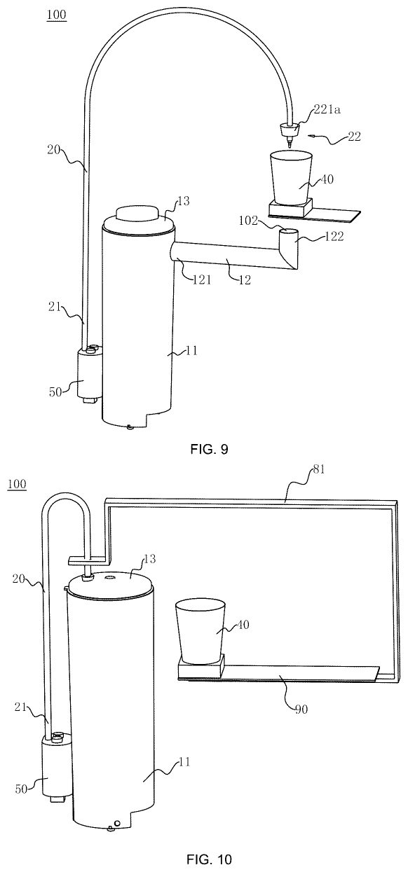

As shown in FIG. 1 to FIG. 24, a colorant dispenser 100 according to embodiments of the present disclosure may include a pump, a first container 10, a second container 40 and an outpouring tube 20.

The first container 10 may be a metal or plastic housing, so as to ensure structural strength of the first container 10. Certainly, the first container 10 may also be configured as a housing of other materials, as long as the first container 10 is ensured to have certain structural strength, which is not limited in the present disclosure.

The first container 10 may be a rigid structural member that is hard to deform (for example, a polyoxymethylene (POM) material part), or the first container 10 may be a flexible structural member. When the first container 10 is a flexible structural member, the first container 10 may have certain deformation in during pouring out a color paste or after pouring out the color paste. The first container 10 may be of a structure similar to that of a medical infusion bag. The first container 10 may be made of a plastic material, for example, the first container 10 is made of a polyethylene (PE) material.

The first container 10 is provided with a color paste therein. The color paste in the first container 10 may be a single-color masterbatch. Certainly, the color paste in the first container 10 may also be a color paste formed by mixing masterbatches of different colors, or the color paste in the first container 10 is a standard color paste (for example, base paint).

In the embodiments of the present disclosure, when the color paste in the first container 10 is not poured out, the color paste can completely fill up an inner space of the first container 10. Certainly, in order to ensure structural stability of the first container 10 and ensure safety of the first container 10 during operation, it is also feasible to fill a large part of the inner space of the first container 10 with the color paste, and the other small part is vacant.

For example, if the inner space of the first container 10 is filled up with the color paste, the container may be broken due to thermal expansion and contraction, and meanwhile, for safety reason, the color paste may shake during transportation and thus cause volume expansion, if the first container is full, the problem of overflow may occur, thereby causing a potential safety hazard, and also increasing transportation difficulty.

The second container 40 may be a container for receiving the color paste poured out from an outlet end 22. The second container 40 may be a paint receiving cup. A material of the second container 40 may be metal, plastic or paper. A plurality of color pastes of different colors can be mixed in the second container 40, so as to render a color paste of a desired color.

The outpouring tube 20 may be a flexible tube, so as to ensure the outlet end 22 to move between a position where it is inserted into the inner space of the first container 10 and a position where the color paste is poured outwards. Certainly, the outpouring tube 20 may also be a rigid tube in some special cases, that is to say, at least in a process of being switched between an operating state and a non-operating state, the outpouring tube 20 and the outlet end 22 thereon stay stationary in position.

When the outpouring tube 20 may be an elastic bent tube, movement amplitude of the outlet end 22 can be further increased. Certainly, it may be understood that, in a process of the outpouring tube 20 being stretched and compressed, a cross-sectional area of a passage in the outpouring tube 20 may change, so that after the outlet end 22 is located in the inner space of the first container 10 (for example, the outlet end 22 is inserted into a moisturizing space 101), a position of the color paste in the outlet end 22 relative to a port may be inconsistent, and further a problem of poor outpouring accuracy occurs. Therefore, a material of the outpouring tube 20 needs to be carefully selected, so as to reduce or eliminate variation in the cross-sectional area of the passage in the outpouring tube 20 as far as possible.

The outpouring tube 20 is connected to the first container 10. The term “connected” herein means that an inner space of the outpouring tube 20 can communicate with the inner space of the first container 10, so that the color paste in the first container 10 can enter the inner space of the outpouring tube 20.

The outpouring tube 20 may have an inlet end 21, wherein the inlet end 21 may directly communicate with the inner space of the first container 10, or the inlet end 21 may indirectly communicate with the inner space of the first container 10, so that the color paste in the inner space of the first container 10 may enter interior of the outpouring tube 20 through the inlet end 21.

It may be understood that, in order to ensure that the color paste in the inner space of the first container 10 can completely enter the outpouring tube 20 through the inlet end 21, the inlet end 21 can be made to communicate with a bottommost portion of the inner space of the first container 10.

The inlet end 21 may be connected to the first container 10 through a pump 50, and thus the color paste in the first container 10 may be pumped into the outpouring tube 20 under driving of the pump 50.

The outpouring tube 20 may have the outlet end 22, and the outlet end 22 can be used for pouring out the color paste. That is to say, the color paste in the inner space of the first container 10 can enter the outpouring tube 20, and then the color paste in the outpouring tube 20 can be poured out via the outlet end 22.

The outlet end 22 may be an end region of the outpouring tube 20, and a part of the outlet end 22 may also be configured as a spray nozzle. A specific structure of the outlet end 22 is not limited in the present disclosure.

Optionally, a cross-sectional area of a channel in the spray nozzle or a cross-sectional area of a channel in the outlet end 22 may be gradually decreased in an outpouring direction. Thus, an outpouring speed of the color paste can be increased, and in addition, the outpouring accuracy of the color paste can also be improved to some extent.

The outlet end 22 has an operating state and a non-operating state, wherein the operating state is a state in which the color paste is pumped into the second container 40 from the outlet end 22, and the non-operating state is a state in which the color paste is not poured into the second container 40 after an outpouring action at the outlet end 22 is completed.

When the outlet end 22 is in the non-operating state, at least a part of the outlet end 22 is located in the moisturizing space 101 of the first container 10. The moisturizing space 101 may be at least a part of the inner space of the first container 10, for example, the moisturizing space 101 may be a space of the inner space of the first container 10 above a liquid level of the color paste, or the moisturizing space 101 may be a space of the inner space of the first container 10 below the liquid level of the color paste.

Thus, the moisturizing space 101 may have color paste vapor or the color paste therein, and the moisturizing space 101 is a humid environment, so that when at least a part of the outlet end 22 is located in the moisturizing space 101, a moisturizing effect can be exerted on the outlet end 22, thereby effectively reducing probability of dryness and blockage occurring to the outlet end 22 when it is in a non-outpouring state.

It should be noted that, when the outlet end 22 is in the non-operating state, the outlet end 22 may be completely located in the moisturizing space 101, or only a part of the outlet end 22 is located in the moisturizing space 101, for example, an end surface of the outlet end 22 is located in the moisturizing space 101, thus, the color paste vapor can enter a color paste channel of the outlet end 22, or the color paste vapor can moisturize the color paste in the color paste channel of the outlet end 22, thereby reducing moisture volatilization of the color paste in the color paste channel of the outlet end 22.

That is to say, the outlet end 22 is optionally located in the moisturizing space 101, and the outlet end 22 has at least two states: a first state is that the color paste is pumped into the second container 40 from the outlet end 22, and a second state is that at least part of the outlet end 22 is located in the moisturizing space 101, so that the moisturizing space 101 can moisturize the outlet end 22.

The first container 10 can isolate the inner space of the first container 10 from an outer space, and meanwhile, as a part of water vapor or other volatile gases in the color paste may be evaporated from the color paste in the inner space of the first container 10, humidity inside the inner space of the first container 10 is higher than that of the outer space, or density of the color paste inside the inner space of the first container 10 is higher than that of a color paste gas in the outer space. Locating the outlet end 22 in the moisturizing space 101 can have a moisturizing effect on the outlet end 22, thus effectively reducing the probability of dryness and blockage occurring to the outlet end 22 when it is in the non-outpouring state.

Certainly, after the outlet end 22 is located in the moisturizing space 101, the outlet end 22 is directly inserted into the color paste in the first container 10, and the color paste, as being in a liquid state, likewise may have the moisturizing effect on the outlet end 22, thus reducing the probability of dryness or blockage occurring to the outlet end 22 when it is in the non-outpouring state.

It should be noted that, after the outlet end 22 is located in the moisturizing space 101, in order to further improve the moisturizing effect on the outlet end 22 and reduce the blockage probability of the outlet end 22, the color paste can be pumped out from the outlet end 22 at intervals, so that the color paste which has stayed at the outlet end 22 for a period of time is discharged, and a fresh color paste can stay at the outlet end 22, thus reducing the blockage probability of the outlet end 22. As the outlet end 22 is located in the moisturizing space 101, the discharged color paste can enter the inner space of the first container 10 again, so as to realize recirculation of the color paste.

The above recirculation step can be applied only to a case where the outlet end 22 is located in the moisturizing space 101 of the inner space of the first container 10 not filled with the color paste. Certainly, if the outlet end 22 is located in the moisturizing space 101 of the inner space of the first container 10 filled with the color paste, the above recirculation step can also be used.

According to the colorant dispenser 100 in the embodiments of the present disclosure, when the outlet end 22 is in the non-operating state, by locating the outlet end 22 in the moisturizing space 101, the humid environment in the moisturizing space 101 can moisturize the outlet end 22, thus reducing the probability of problems of dryness and blockage occurring to the outlet end 22, and thereby making the accuracy of an outpouring amount of the color paste from the outlet end 22 meet requirements.

The colorant dispenser 100 of the embodiments of the present disclosure abandons the solution of moisturizing the outpouring nozzle (equivalent to the outlet end 22 in the present disclosure) using the conventional reversing valve device, thus, there is no condition of poor accuracy of the outpouring amount of the color paste caused by swelling and wear, and these problems are fundamentally solved. Moreover, the present disclosure omits the reversing valve device, and a brand new moisturizing technical solution for the outlet end 22 is used, where a whole structure is simple, a production cost is reduced, and a low-cost anti-blockage solution for the outlet end 22 is used, which facilitates bringing the colorant dispenser 100 to the market.

According to the colorant dispenser 100 of the embodiments of the present disclosure, it is more convenient to discharge the gas in a color paste pipeline (which may include the outpouring tube 20 and other channels for the color paste to pass through). For previous one-by-one outpouring type colorant dispensers, if it is desired to discharge the gas in the color paste pipeline, the color paste needs to be dispensed into a cup from the outpouring nozzle, and then the color paste in the cup is poured back into a color-paste canister (equivalent to the first container 10 in the present disclosure), which practice, on the one hand, is troublesome, and on the other hand, causes problems of color paste waste and pollution. However, for the colorant dispenser 100 of the embodiments of the present disclosure, when the gas appears in the color paste pipeline, the outlet end 22 can be made in the non-operating state, and then the pump 50 operates so as to discharge the color paste into the first container 10 from the outlet end 22, so that the color paste can be directly poured into the first container 10 while the gas in the color paste pipeline is discharged, and the problems of color paste waste and pollution will not occur.

For the colorant dispenser 100 of the embodiments of the present disclosure, an evaporated gas of the color paste in the first container 10 can be used to moisturize the outlet end 22, and thus it is unnecessary to clean the outlet end 22 with any cleaning liquid, so that manufacturing and using costs of the colorant dispenser 100 are reduced. As the colorant dispenser 100 of the embodiments of the present disclosure does not need to clean the outlet end 22 with any cleaning liquid, no waste cleaning liquid will be brought about by cleaning the outlet end 22, thereby avoiding occurrence of the problem of pollution to the environment caused by discarding the waste cleaning liquid.

In some embodiments of the present disclosure, the outlet end 22 has the operating state, and when the outlet end 22 is in the operating state, the outlet end 22 is used for pouring the color paste into the second container 40. That is to say, the operating state can be a color-paste outpouring state of the outlet end 22.

The outlet end 22 also has the non-operating state, and when the outlet end 22 is in the non-operating state, at least part of the outlet end 22 is located in the moisturizing space 101. That is to say, after the outpouring action is completed, the outlet end 22 can be located or closed in the first container 10, so that the outlet end 22 can be effectively moisturized.

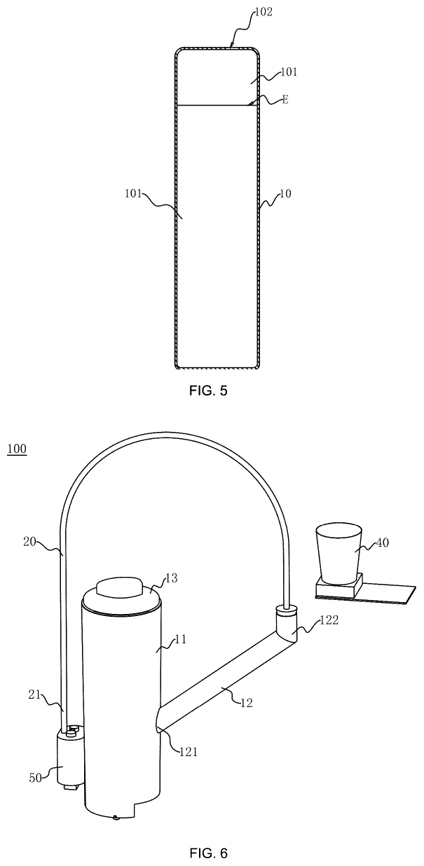

In some embodiments of the present disclosure, as shown in FIG. 5, the moisturizing space 101 is a space in the first container 10 above a liquid level E of the color paste. As the color paste in the inner space of the first container 10 can be continuously poured out, an amount of the color paste in the inner space of the first container 10 is not unalterable, and thus the liquid level E of the color paste in the inner space of the first container 10 also gradually drops along with use, and further the moisturizing space 101 above the liquid level of the color paste also gradually increases.

As there is the color paste in the inner space of the first container 10, the color paste evaporates water vapor or other volatile gases upwards into the moisturizing space 101, so that the humidity or density of the color paste gas in the moisturizing space 101 is relatively high. After the outlet end 22 is located in the moisturizing space 101, the outlet end 22 can be moisturized, thus reducing the probability of dryness and blockage occurring to the outlet end 22.

The outlet end 22 is optionally located in the moisturizing space 101, and when the color paste needs to be pumped outwards from the outlet end 22, the outlet end 22 can be detached from the moisturizing space 101 and switched to the operating state, so as to facilitate pouring the color paste outwards. After the outpouring action is completed, that is, when the outlet end 22 is in the non-operating state, the outlet end 22 can be located in the moisturizing space 101. As the humidity in the moisturizing space 101 is relatively high, after the outlet end 22 is located in the moisturizing space 101, the outlet end 22 can be moisturized, thus reducing the probability of dryness and blockage occurring to the outlet end 22.

A position of the outlet end 22 in the moisturizing space 101 may be unchanged, and certainly, the position of the outlet end 22 in the moisturizing space 101 may also be changed, for example, the outlet end 22 may keep a preset distance from the liquid level of the color paste all the time, so that with movement of the liquid level of the color paste, the position of the outlet end 22 may also be changed. The present disclosure does not define a distance between the outlet end 22 and the liquid level, as long as the outlet end 22 is ensured not to be inserted into the color paste in the inner space of the first container 10.

According to some embodiments of the present disclosure, the first container 10 has a first highest liquid-level line (not shown), and when the color paste in the first container 10 is not poured out and the first container 10 is located in a correct placement position, the amount of the color paste in the first container 10 is the largest, and the liquid level of the color paste is flush with the first highest liquid-level line.

When the outlet end 22 is in the non-operating state, that is, when the outlet end 22 is located in the moisturizing space 101, the outlet end 22 is located above the first highest liquid-level line. That is to say, the inner space of the first container 10 is not completely filled up with the color paste, even if the liquid level of the color paste is flush with a first highest liquid level, an upper part of the inner space of the first container 10 is still not filled up with the color paste, and in this case, a space above the first highest liquid-level line is the moisturizing space 101. As the outlet end 22 is located above the first highest liquid-level line, the outlet end 22 will never be inserted into the color paste, and the outlet end 22 can be moisturized by a humid gas in the moisturizing space 101.

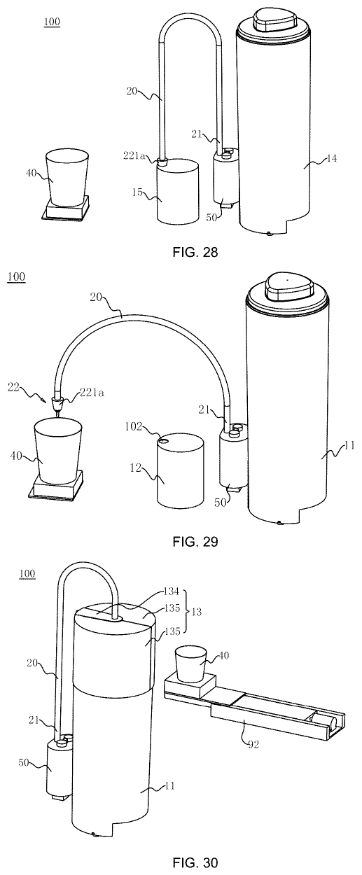

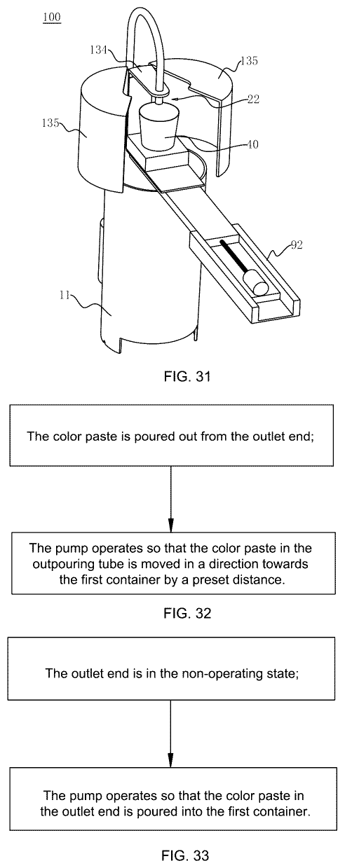

According to some embodiments of the present disclosure, as shown in FIG. 30 and FIG. 31, the position of the outlet end 22 is fixed. That is to say, at least in a process of the outlet end 22 being switched between the operating state and the non-operating state, the outlet end 22 stays stationary in position.

When the outlet end 22 is in the non-operating state, the moisturizing space 101 is closed, that is to say, when the color paste is no longer pumped outwards from the outlet end 22, the moisturizing space 101 is closed space, and in this case, the moisturizing space 101 does not communicate with the outer space, and the humid gas in the moisturizing space 101 will not escape into the outer space. In this way, the moisturizing space 101 can moisturize the outlet end 22, thus reducing the probability of dryness and blockage occurring to the outlet end 22.

When the outlet end 22 is in the operating state, the moisturizing space 101 is opened, thereby the moisturizing space 101 may communicate with the outer space, so that the second container 40 can enter the first container 10, for example, the second container 40 can move to below the outlet end 22, so that the color paste pumped out from the outlet end 22 can fall into the second container 40.

That is to say, the position of the outlet end 22 is fixed, and by closing or opening the moisturizing space 101, the outlet end 22 is switched between the operating state and the non-operating state.

In some embodiments of the present disclosure, as shown in FIG. 30 and FIG. 31, the first container 10 includes a canister body 11, wherein the canister body 11 is used for accommodating the color paste, and the color paste can be stored in the canister body 11.

The canister body 11 has an opening which can be opened or closed, and when the opening is opened, the color paste can be poured into an inner space of the canister body 11 through the opening.

The first container 10 further includes a canister lid 13, and the canister lid 13 is used for covering the opening, that is to say, the canister lid 13 can close or open the opening.

The canister lid 13 includes a fixed portion 134 and a movable portion 135, wherein the fixed portion 134 is fixed to the canister body 11 and thus does not move relative to the canister body 11, and the outlet end 22 is coupled to the fixed portion 134 and thus stays stationary relative to the canister body 11. That is to say, in the embodiments of the present disclosure, at least when the outlet end 22 is switched between the operating state and the non-operating state, the positions of the outlet end 22 and the canister body 11 stay stationary.

The movable portion 135 is configured to move relative to the fixed portion 134, so as to close or open the moisturizing space 101. When the movable portion 135 is moved to a position where the moisturizing space 101 is opened, the second container 40 in this case can be moved into the first container 10, so that the color paste can be pumped into the second container 40 from the outlet end 22, and in this case, the outlet end 22 is in the operating state; when the movable portion 135 is moved to a position where the moisturizing space 101 is closed, the moisturizing space 101 does not communicate with the outer space, the moisturizing space 101 is a humid space, and in this case, the outlet end 22 is located in the moisturizing space 101 and is in the non-operating state, so that the moisturizing space 101 can moisturize the outlet end 22.

Optionally, after the movable portion 135 opens the moisturizing space 101, the second container 40 can be driven by a third driving mechanism 92 to move into the first container 10.

According to some embodiments of the present disclosure, as shown in FIG. 31 and FIG. 32, there are two movable portions 135, the fixed portion 134 is located between the two movable portions 135, and the two movable portions 135 are configured to be rotatable relative to the fixed portion 134, so that the two movable portions 135 are close to or away from each other, thereby closing or opening the moisturizing space 101.

After the two movable portions 135 are close to each other, the moisturizing space 101 is closed, so that the color paste vapor inside the moisturizing space 101 will not overflow, and the outlet end 22 can be ensured to be moisturized in the moisturizing space 101. After the two movable portions 135 are away from each other, the moisturizing space 101 is opened, so that the second container 40 can enter the first container 10, thus facilitating pumping the color paste into the second container 40 from the outlet end 22.

In some embodiments of the present disclosure, the moisturizing space 101 is a space in the first container 10 below the liquid level of the color paste. That is to say, the outlet end 22 is no longer moisturized using the humid air in the first container 10, but is directly inserted into the color paste in the first container 10, thus reducing water loss of the color paste at the outlet end 22, so as to moisturize the outlet end 22, and reduce the probability of the problems of dryness and blockage occurring to the outlet end 22.

Certainly, it may be understood that, even if the outlet end 22 is inserted into the color paste in the first container 10, the color paste may also be pumped out from the outlet end 22 at intervals, so as to discharge the color paste which has stayed at the outlet end 22 for a period of time, ensure that the fresh color paste can stay at the outlet end 22, and thus reduce the probability of the problem of blockage occurring to the outlet end 22. As the outlet end 22 is inserted into the color paste in the first container 10, the discharged color paste can enter the first container 10 again, thus realizing the recirculation of the color paste.

In some embodiments of the present disclosure, when the outlet end 22 is in the non-operating state, the outlet end 22 is coupled to the first container 10, and when the outlet end 22 is in the operating state, the outlet end 22 is detached from the first container 10 so as to pour out the color paste into the second container 40.

When the outlet end 22 is coupled to the first container 10, at least part of the outlet end 22 is located in the moisturizing space 101, that is to say, the outlet end 22 can be inserted into the first container 10.

That is to say, the outlet end 22 is optionally inserted into the first container 10. The outlet end 22 has at least two states: in a first state, the outlet end 22 is not inserted into the first container 10, and in this case, the outlet end 22 is separated from the first container 10, and the color paste can be poured into the second container 40; and in a second state, the outlet end 22 is inserted into the first container 10, and in this case, the outlet end 22 is coupled with the first container 10, and the outlet end 22 is located in the moisturizing space 101, which can achieve the moisturizing effect.

The first container 10 isolates the inner space of the first container 10 from the outer space, and meanwhile, as a part of water vapor or other volatile gases in the color paste may be evaporated from the color paste in the inner space of the first container 10, the humidity inside the inner space of the first container 10 is higher than that of the outer space, or the density of the color paste inside the inner space of the first container 10 is higher than that of the color paste gas in the outer space. Inserting the outlet end 22 into the first container 10 can have the moisturizing effect on the outlet end 22, thus effectively reducing the probability of dryness and blockage occurring to the outlet end 22 when being in the non-outpouring state.

Certainly, after the outlet end 22 is inserted into the first container 10, the outlet end 22 is directly inserted into the color paste in the first container 10, and the color paste, as being in a liquid state, likewise may have the moisturizing effect on the outlet end 22, thus reducing the probability of dryness or blockage occurring to the outlet end 22 when it is in the non-outpouring state.

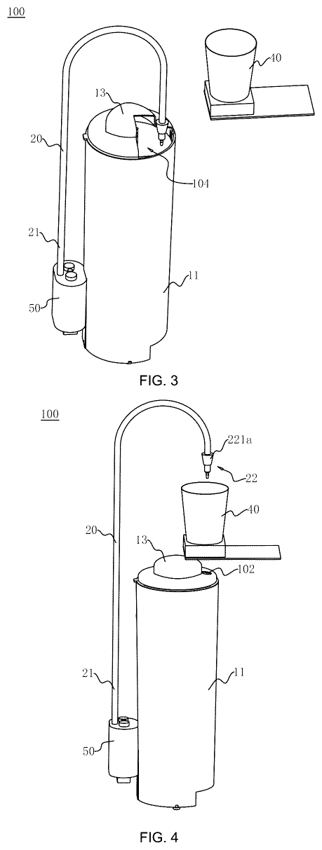

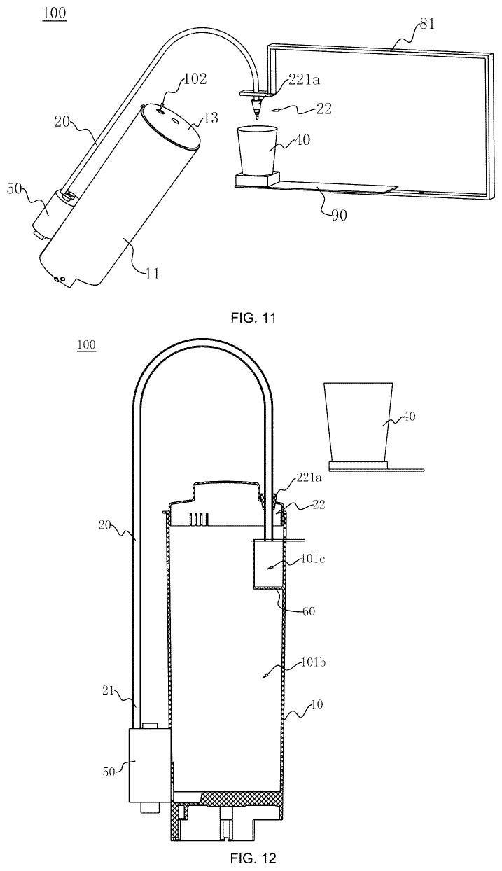

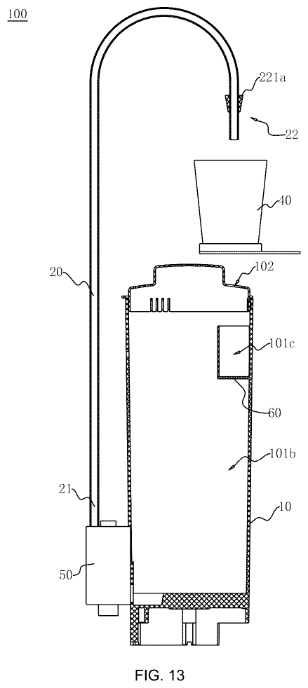

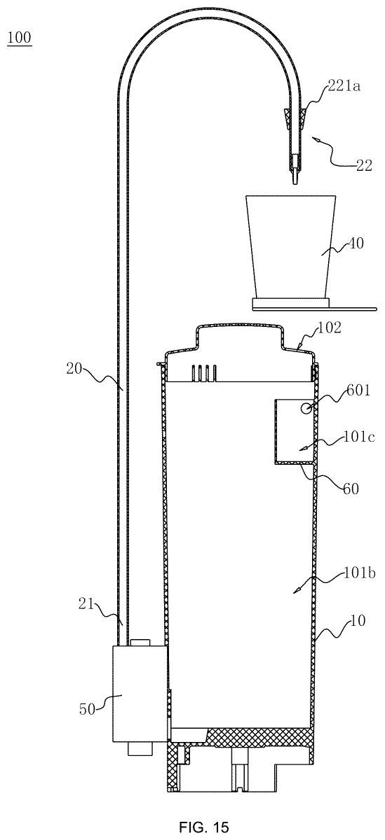

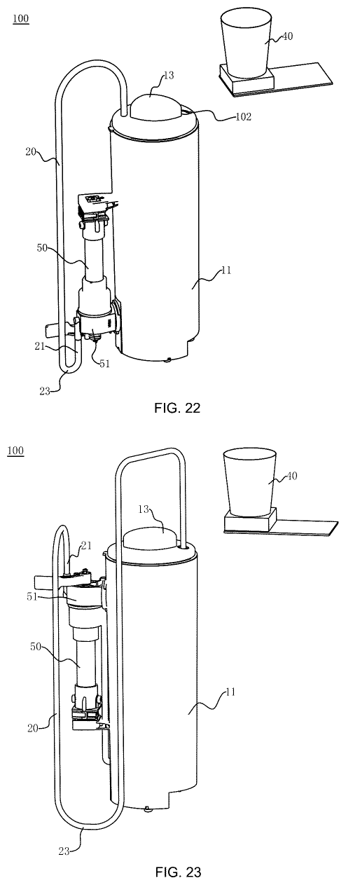

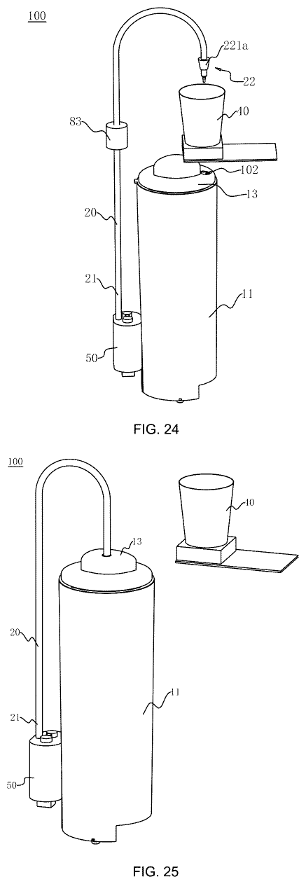

In some embodiments of the present disclosure, as shown in FIG. 2, FIG. 4, FIG. 11, FIG. 13, FIG. 15, FIG. 17, FIG. 19, FIG. 22, FIG. 24 and FIG. 29, a wall portion of the first container 10 has a first opening 102 in a wall portion, and when the outlet end 22 is in the non-operating state, the outlet end 22 is coupled to the first opening 102.

The first opening 102 can allow the outlet end 22 to pass therethrough, and after the outlet end 22 passes through the first opening 102, the outlet end 22 is inserted into the first container 10.

The “setting” in the expression “when the outlet end 22 is in the non-operating state, the outlet end 22 is coupled to the first opening 102” may be understood as that the outlet end 22 is fitted with the first opening 102, and the outlet end 22 is fitted with the first opening 102, so that the outlet end 22 is coupled to the first container 10. It can also understood as that the outlet end 22 is located in the first opening 102, and the outlet end 22 may be spaced from an inner peripheral wall of the first opening 102, but at least part of the outlet end 22 should be ensured to be inserted into the inner space of the first container 10.

Thus, the outlet end 22 can enter the first container 10 through the first opening 102, so that when the outlet end 22 is in the operating state, the humid air or the color paste in the first container 10 can moisturize the outlet end 22, thus reducing the probability of the problems of dryness and blockage occurring to the outlet end 22.

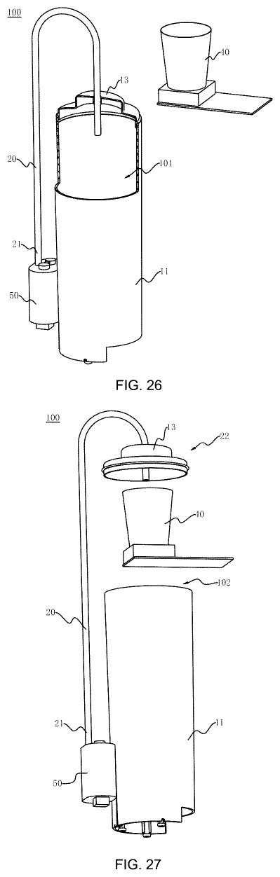

In some embodiments of the present disclosure, as shown in FIG. 1 to FIG. 31, when the outlet end 22 is in the non-operating state, the outlet end 22 closes the first opening 102. That is to say, after the outlet end 22 is inserted into the first container 10, the outlet end 22 can also close the first opening 102. Thus, the probability of the color paste vapor in the first container 10 escaping outwards can be reduced, so that the humidity in the first container 10 is relatively high, and thus the outlet end 22 can be moisturized more effectively, and the probability of dryness and blockage occurring to the outlet end 22 is reduced.

In some embodiments of the present disclosure, as shown in FIG. 6 to FIG. 9, the first container 10 includes a canister body 11 and a leading-out pipe 12, wherein the leading-out pipe 12 can be located outside the canister body 11.

For example, the canister body 11 may be a container mainly for storing the color paste, the leading-out pipe 12 is only provided on the canister body 11, and the leading-out pipe 12 can be merely used for receiving the outlet end 22, and is not used for accommodating the color paste by itself. Certainly, the leading-out pipe 12 not only can be used for receiving the outlet end 22, but also can be used for accommodating the color paste, which is not limited in the present disclosure.

The leading-out pipe 12 has a first end 121 and a second end 122.

The first end 121 and the second end 122 may be two ends of the leading-out pipe 12 in a length direction.

The first end 121 is connected to the canister body 11, and the first end 121 may be fixedly connected to the canister body 11, for example, the first end 121 may be fixedly connected to the canister body 11 by means of welding or bonding. Certainly, the leading-out pipe 12 may be integrally formed with the canister body 11.

The first end 121 may communicate with the inner space of the canister body 11, and thus the inner space of the canister body 11 communicates with an inner space of the leading-out pipe 12.

The second end 122 has a first opening 102, thus the canister body 11 no longer needs to be formed with an opening, and the outlet end 22 can be directly inserted into the second end 122 of the leading-out pipe 12. As the inner space of the leading-out pipe 12 communicates with the inner space of the canister body 11, the color paste or the humid air in the canister body 11 can enter the inner space of the leading-out pipe 12, so that the inner space of the leading-out pipe 12 is a humid environment; therefore, the outlet end 22 placed inside the leading-out pipe 12 can be moisturized, thus reducing the probability of the problems of dryness and blockage occurring to the outlet end 22.

When the first container 10 is not in use, the color paste can completely fill the inner space of the canister body 11, or only fill most of the inner space of the canister body 11, and a small part of the space is reserved to improve safety performance of the first container 10.

For example, a position of the first end 121 is relatively low, and the color paste in the canister body 11 can enter the leading-out pipe 12, consequently, the vapor generated by the color paste in the leading-out pipe 12 can move upwards, so that the humidity of the air in an upper part of the leading-out pipe 12 is relatively high. Alternatively, the position of the first end 121 is relatively high, the color paste in the canister body 11 cannot enter the leading-out pipe 12, but the humid air generated by evaporation of the color paste in an upper part of the canister body 11 can enter the leading-out pipe 12, and the leading-out pipe 12 still has a humid environment therein.

When the outlet end 22 is in the non-operating state, the outlet end 22 can be inserted into the inner space of the leading-out pipe 12, that is to say, when the color paste needs to be poured into the second container 40, the outlet end 22 can be detached from the inner space of the leading-out pipe 12, facilitating the outpouring of the color paste to the second container 40. After the outpouring action is completed, the outlet end 22 can be inserted into the inner space of the leading-out pipe 12, and as the humidity of the inner space of the leading-out pipe 12 is much higher than that of the outside, the outlet end 22 inserted into the inner space of the leading-out pipe 12 can be moisturized, thus reducing the probability of the problems of dryness and blockage occurring to the outlet end 22.

Certainly, it may be understood that if the color paste can enter the inner space of the leading-out pipe 12, the outlet end 22 can be directly inserted into the color paste in the inner space of the leading-out pipe 12 after the outpouring action is completed, so as to further moisturize the outlet end 22, and reduce the probability of dryness and blockage occurring to the outlet end 22.

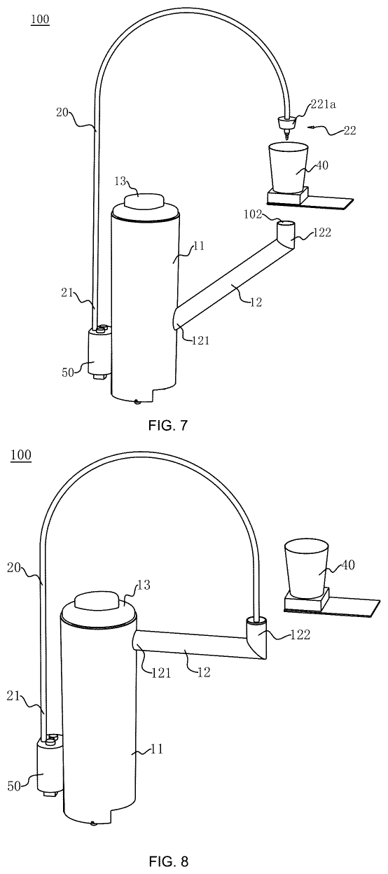

In some embodiments of the present disclosure, as shown in FIG. 6 and FIG. 7, the second end 122 is higher than the first end 121. Thus, when there is no color paste inside the leading-out pipe 12, the gas with higher humidity can move upwards, and the humidity of the second end 122 is higher, so that when the outlet end 22 is inserted into the second end 122, the outlet end 22 can be better moisturized.

Certainly, as the second end 122 is higher than the first end 121, when there is the color paste in the leading-out pipe 12, a situation that the color paste moves towards the second end 122 under action of gravity and flows out from the second end 122 will not occur.

The leading-out pipe 12 has the first end 121 and the second end 122, and the first end 121 is connected to the canister body 11. It may be understood that the leading-out pipe 12 can be configured as an elongated structure, and the first end 121 and the second end 122 may be two ends of the leading-out pipe 12 in the length direction.

The first end 121 is an end of the leading-out pipe 12 connected to the canister body 11, and the second end 122 has the first opening 102, so that when the outlet end 22 is in the non-operating state, the outlet end 22 can be provided at the first opening 102 and extend into the inner space of the leading-out pipe 12.

In some embodiments of the present disclosure, the first end 121 is located below the liquid level of the color paste in the canister body 11, and the second end 122 is located above the liquid level of the color paste in the canister body 11. Thus, the color paste in the canister body 11 can flow towards the leading-out pipe 12, and part of water vapor of the color paste in the leading-out pipe 12 evaporates, so that an upper space of the leading-out pipe 12 is a humid environment, and when the outlet end 22 extends into the leading-out pipe 12, the outlet end 22 can be moisturized.

It may be understood that, when the outlet end 22 is inserted into the leading-out pipe 12, the outlet end 22 may be located in the upper space of the leading-out pipe 12 and is not inserted into the color paste in the leading-out pipe 12, and certainly, the outlet end 22 may also be directly inserted into the color paste in the leading-out pipe 12 to be moisturized.

The first end 121 may be located below a highest liquid-level line of the canister body 11, and the second end 122 is located above the highest liquid-level line of the canister body 11. Therefore, at least when the color paste in the first container 10 is not used or a small part is used, a part of the color paste in the canister body 11 may flow towards the leading-out pipe 12. Certainly, when the first end 121 is quite distant from the highest liquid-level line of the canister body 11, even if a lot of the color paste in the first container 10 is used, a part of the color paste in the canister body 11 may still flow towards the leading-out pipe 12. When the liquid level of the color paste in the canister body 11 is lower than the first end 121, the color paste cannot flow towards the leading-out pipe 12, but the humid air in an upper part of the space in the canister body 11 can still flow towards the leading-out pipe 12.

As there is always color paste or humid air flowing into the leading-out pipe 12, the inner space of the leading-out pipe 12 always maintains a humid environment. Therefore, after the outlet end 22 is inserted into the inner space of the leading-out pipe 12, the outlet end 22 can be moisturized, thus reducing the probability of the problems of dryness and blockage occurring to the outlet end 22.

In some embodiments of the present disclosure, the first end 121 is located above the liquid level of the color paste in the canister body 11. Therefore, the color paste in the canister body 11 will not flow into the leading-out pipe 12. However, the humid air in the canister body 11 may flow into the leading-out pipe 12, so that the inner space of the leading-out pipe 12 always maintains a humid environment. After the outlet end 22 is inserted into the inner space of the leading-out pipe 12, the outlet end 22 can be moisturized, thus reducing the probability of the problems of dryness and blockage occurring to the outlet end 22.

The first end 121 is located above the liquid level of the color paste in the canister body 11, and the second end 122 may be higher than the first end 121, or the second end 122 may be lower than the first end 121, or the second end 122 and the first end 121 have the same height, as long as the color paste is ensured not to flow from the canister body 11 to the leading-out pipe 12.

In some embodiments of the present disclosure, the first end 121 may be located above the highest liquid-level line of the canister body 11; therefore, even if the color paste in the first container 10 is not used, and the color paste liquid level of the color paste in the canister body 11 is flush with the highest liquid-level line of the canister body 11, the color paste still cannot flow towards the leading-out pipe 12, but the humid air in the upper part of the space in the canister body 11 can still flow towards the leading-out pipe 12.

As there is always humid air flowing into the leading-out pipe 12, the inner space of the leading-out pipe 12 always maintains a humid environment. Therefore, after the outlet end 22 is inserted into the inner space of the leading-out pipe 12, the outlet end 22 can be moisturized, thus reducing the probability of the problems of dryness and blockage occurring to the outlet end 22.

The outlet end 22 can be inserted into the inner space of the first container 10, or the outlet end 22 can communicate with the inner space of the first container 10. In this case, a space where the outlet end 22 is located is the moisturizing space 101, and the moisturizing space 101 is a part of the inner space of the first container 10. Regardless of whether the outlet end 22 is located in a space in the first container 10 above the liquid level of the color paste or in a space below the liquid level of the color paste, the inner space of the first container 10 can moisturize the outlet end 22.

In some embodiments of the present disclosure, the first container 10 may include a canister body 11 and a canister lid 13.

The canister body 11 is used for accommodating the color paste. The canister body 11 and the canister lid 13 together define an inner space of the first container 10. The canister body 11 is formed with a second opening 104 in a top. The color paste can be poured into the first container 10 through the second opening 104. The preceding process is a process of feeding the first container 10, and after the preceding process is finished, the second opening 104 can be closed by the canister lid 13.

The canister lid 13 covers the second opening 104, so that the second opening 104 can be closed, and thus the canister lid 13 and the canister body 11 together can form the inner space for accommodating the color paste.

The first opening 102 is formed at the canister lid 13, that is to say, when the outlet end 22 is in the non-operating state, the outlet end 22 can be provided at the first opening 102, and the outlet end 22 may communicate with the inner space of the first container 10.

For example, the outlet end 22 can pass through the first opening 102 and extend into the first container 10, for instance, the outlet end 22 can extend into the air with higher humidity in the first container 10, or the outlet end 22 can be inserted into the color paste in the first container 10.

Thus, the high-humidity gas or the color paste in the first container 10 can moisturize the outlet end 22, reducing the probability of the problems of dryness and blockage occurring to the outlet end 22.

In some embodiments of the present disclosure, the outlet end 22 is provided with a sealing structure. When the outlet end 22 is in the non-operating state, the sealing structure closes the first opening. After the outlet end 22 is inserted into the first container 10, the sealing structure can close the first opening 102. Thus, the probability of the color paste vapor in the first container 10 escaping outwards can be reduced, so that the humidity in the first container 10 is relatively high, and thus the outlet end 22 can be moisturized more effectively, and the probability of dryness and blockage occurring to the outlet end 22 can be reduced.

In some embodiments of the present disclosure, the sealing structure is a sealing lid 30.

The sealing lid 30 may be sized larger than the outlet end 22.

The sealing lid 30 may be provided on an outer periphery of the outlet end 22, or the sealing lid 30 may be formed with a through hole, through which the outlet end 22 passes.

The sealing lid 30 may be integrally formed with the outlet end 22, or the sealing lid 30 may be fixed to the outlet end 22 by means of bonding or welding.

When the outlet end 22 is in the non-operating state, the sealing lid 30 can seal the first opening 102. That is to say, in a process of the inner space of the first container 10 moisturizing the outlet end 22, the first opening 102 is sealed by the sealing lid 30, so that the first opening 102 will not communicate the inner space of the first container 10 with the outer space, the high-humidity gas in the first container 10 will not flow to the outer space, so that relatively high humidity is always kept for the air in the first container 10.

Thus, when the outlet end 22 is in the first container 10, not only the color paste vapor in the first container 10 will not escape outwards, but also evaporation of the color paste at the outlet end 22 to the outside is reduced, thus improving the moisturizing effect on the outlet end 22 in the first container 10, and reducing the probability of the problems of dryness and blockage occurring to the outlet end 22.

In some embodiments of the present disclosure, the sealing lid 30 has a first through hole 201, the outlet end 22 passes through the first through hole 201, and the outlet end 22 is fixedly connected to the sealing lid 30.

In this way, the outlet end 22 can pass through the first through hole 201 and communicate with the inner space of the first container 10, and the high-humidity gas or the color paste in the first container 10 can moisturize the outlet end 22.

The outlet end 22 and the first through hole 201 may be in interference fit, or the outlet end 22 and the first through hole 201 may be fixed together by bonding or in a fixing manner such as through a fastener.

In some embodiments of the present disclosure, when the outlet end 22 is in the non-operating state, the sealing lid 30 is magnetically fitted with the canister lid 13. Thus, when the outlet end 22 is in the non-operating state, the sealing lid 30 can be firmly mounted on the canister lid 13. As the sealing lid 30 can be fixedly connected to the outlet end 22, the outlet end 22 can be firmly mounted on the canister lid 13.

The sealing lid 30 may be provided with a first magnetic member, and the canister lid 13 may be provided with a second magnetic member. In this way, when the outlet end 22 is in the non-operating state, the first magnetic member and the second magnetic member can be attracted together, so that the sealing lid 30 and the canister lid 13 can be firmly connected together.

Certainly, the sealing lid 30 itself may also be a magnetic member, and the canister lid 13 itself may also be a magnetic member, that is, the sealing lid 30 and the canister lid 13 are both magnetic members, so that the sealing lid 30 and the canister lid 13 can be magnetically fitted with each other.

As the sealing lid 30 and the canister lid 13 can be magnetically fitted, when the sealing lid 30 approaches the canister lid 13, a magnetic attraction between the two will pull the sealing lid 30 closer to the canister lid 13, which may have a positioning effect. In addition, when the outlet end 22 needs to be switched to the operating state, the magnetic attraction may be easily overcome to complete this action.

In some embodiments of the present disclosure, when the outlet end 22 is in the non-operating state, the sealing lid 30 is snap-fitted with the canister lid 13.

That is to say, when the outlet end 22 is in the non-operating state, the sealing lid 30 can be fixed with the canister body 11 in a snap-fit manner. Thus, the outlet end 22 is more stable in the non-operating state, and the risk of shaking is reduced.

For example, the sealing lid 30 may be provided with a first buckle, the canister lid 13 may be provided with a second buckle, the sealing lid 30 can be fixed on the canister body 11 through fit between the first buckle and the second buckle, and in this case, the outlet end 22 is in the non-operating state.

As the sealing lid 30 is snap-fitted with the canister lid 13, the connection is convenient, the structure is simple, and the sealing lid 30 can be easily detached from the canister body 11 when the outlet end 22 needs to be switched from the non-operating state to the operating state.

According to some embodiments of the present disclosure, a plane where the first opening 102 is located is provided obliquely relative to a horizontal plane. Thus, by providing the plane where the first opening 102 is located obliquely relative to the horizontal plane, the first opening 102 is an oblique opening, and in this way, covering the sealing lid 30 at the first opening facilitates separation or coupling of the sealing lid 30 from or with the canister lid 13. For example, the sealing lid 30 can be pulled to move in a horizontal direction and/or an up-down direction, so as to separate or couple the sealing lid 30 from or with the canister lid 13.

In some embodiments of the present disclosure, the first container 10 is fixed, and the colorant dispenser 100 further includes a first driving mechanism 70 which can be connected to or detached from the sealing lid 30.

That is to say, the sealing lid 30 may be an active member, and the first driving mechanism 70 can drive the sealing lid 30 to move actively.

As the outlet end 22 is connected to the sealing lid 30, the sealing lid 30 is driven by the first driving mechanism 70 to move, so that the sealing lid 30 is coupled with or separated from the canister lid 13; further, the first driving mechanism 70 can indirectly drive the outlet end 22 to be inserted into the first container 10 or detached from the inner space of the first container 10.

When the sealing lid 30 is coupled with the canister lid 13, the outlet end 22 is inserted into the first container 10, so that the outlet end 22 can be moisturized. After the sealing lid 30 is separated from the canister lid 13, the outlet end 22 can be in the operating state, so that the outlet end 22 can discharge the color paste to the second container 40.

It should be noted that “the first container 10 is fixed” herein means a position where the first container 10 is located can make the first driving mechanism 70 connected with the sealing lid 30, and in a process of driving the sealing lid 30 to move, the first container 10 does not move.

That is to say, in a process of the outlet end 22 moving between the operating state and the non-operating state, the first container 10 is fixed.

For example, there are a plurality of first containers 10, and when one of the first containers 10 is moved to a position where it can be butt-joined with the first driving mechanism 70, in a process of the first driving mechanism 70 driving the sealing lid 30 or the outlet end 22 to move, the first container 10 is fixed, and the first container 10 is no longer moved.

The first container 10 does not stay stationary all the time, but the first container 10 is fixed in the process of the first driving mechanism 70 driving the sealing lid 30 or the outlet end 22 to move.

In some embodiments of the present disclosure, the sealing structure may be configured as a sealing cone 221a. Two ends of the sealing cone 221a have different cross-sectional areas. The sealing cone 221a has a big end and a small end, and the cross-sectional area of the sealing cone 221a is gradually increased in a direction from the small end to the big end.

In a process of switching the outlet end 22 to the non-operating state, the small end of the sealing cone 221a is gradually inserted into the first opening 102. The sealing cone 221a can have a positioning effect, and the small head of the sealing cone 221a gradually presses against the inner peripheral wall of the first opening, so that at least a part of the sealing cone 221a is in interference fit with the first opening 102, and thus when the outlet end 22 is in the non-operating state, the sealing structure can seal the first opening 102 more effectively, reducing the probability of the high-humidity gas in the first container 10 escaping outwards.

A part of the outer periphery of the outlet end 22 may be the sealing cone 221a, as a result, in a process of inserting the outlet end 22 into the first container 10, the sealing cone 221a can be gradually inserted into the first opening 102 until the first opening 102 is completely sealed, and after the sealing cone 221a completely seals the first opening 102, the small end of the sealing cone 221a is inserted into the first opening 102.

Certainly, it may be understood that, one sealing cone 221a can be installed at the outer periphery of the outlet end 22, for example, the sealing cone 221a can be bonded and fixed to the outer periphery of the outlet end 22, or a hole is formed on the sealing cone 221a, and the outlet end 22 is in interference fit with the hole on the sealing cone 221a.

Certainly, the sealing cone 221a is only one type of sealing the first opening 102 after the outlet end 22 is inserted into the first container 10, and other types of sealing structures can also be used to seal the first opening 102, which is not limited in the present disclosure.

In some embodiments of the present disclosure, the colorant dispenser 100 further may include a pump 50.

The pump 50 may be a machine that delivers or pressurizes a fluid. It delivers mechanical energy from a prime mover or other external energy to a liquid, to increase energy of the liquid.

The pump 50 can be used for delivering a liquid such as water, oil, an acid-base liquid, an emulsion, a suspension and a liquid metal, and can also be used for delivering a liquid-gas mixture and a liquid containing a suspended solid. In the present disclosure, the pump 50 can be used for delivering the color paste.

The pump 50 can be classified into three types according to operating principles: positive displacement pump, dynamic pump and other types of pumps. Apart from the classification according to the operating principles, the pump can also be classified and named according to other methods. For example, the pump can be divided into electric pump, water-turbine pump, etc. according to driving methods; single-stage pump and multi-stage pump according to structures; boiler feed pump, metering pump, etc. according to uses; water pump, oil pump, mud pump, etc. according to properties of liquids delivered; and linear pump, conventional pump, or piston pump, gear pump, plunger pump, screw pump, peristaltic pump, folding pump (diaphragm pump), and swash plate pump which are commonly used in the color-dispensing industry, according to whether there is a shaft structure or not.

In the embodiments of the present disclosure, the outpouring tube 20 has an inlet end 21, an inlet of the pump 50 communicates with the inner space of the first container 10, and an outlet of the pump 50 communicates with the inlet end 21.

Thus, the pump 50 can pump the color paste in the first container 10 into the outpouring tube 20, and meanwhile, the color paste can be pumped outwards from the outlet end 22 of the outpouring tube 20. For example, when the outlet end 22 is in the non-operating state, the color paste can be pumped into the first container 10 from the outlet end 22, and in this case, the color paste at the outlet end 22 can be replaced with a color paste with better humidity; and if the outlet end 22 is in the operating state, the color paste can be pumped into the second container 40 from the outlet end 22.

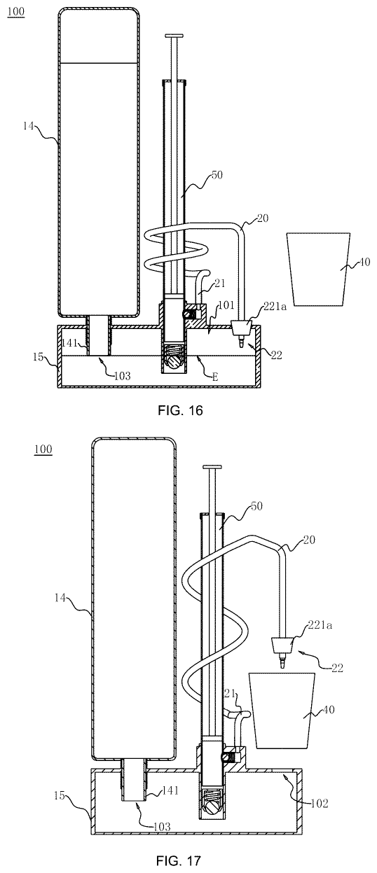

In some embodiments of the present disclosure, as shown in FIG. 16 to FIG. 19, the first container 10 includes a first sub-container 14 and a second sub-container 15.

The first sub-container 14 and the second sub-container 15 each have a space for accommodating the color paste, and the space of the first sub-container 14 and the space of the second sub-container 15 can communicate with each other.

The first sub-container 14 is provided with a paste outlet 103 at bottom. The color paste in the first sub-container 14 can be discharged from the paste outlet 103. When the first sub-container 14 is normally placed, the paste outlet 103 of the first sub-container 14 can make the color paste in the first sub-container 14 automatically restricted and discharged from the paste outlet 103 under the action of an atmospheric pressure difference between inside and outside of the canister and gravity of the color paste itself.

The paste outlet 103 communicates with an inner space of the second sub-container 15, and the color paste in the first sub-container 14 can enter the inner space of the second sub-container 15 through the paste outlet 103.

The first opening 102 is formed on a top wall of the second sub-container 15, thereby the outlet end 22 can be coupled with the top wall of the second sub-container 15, thus realizing insertion of the outlet end 22 into the inner space of the second sub-container 15.

The paste outlet 103 is lower than the top wall of the second sub-container 15, that is to say, the paste outlet 103 is spaced from the top wall of the second sub-container 15 by a certain distance.

The second sub-container 15 can also communicate with the outer space all the time or occasionally, thereby under the action of ambient atmospheric pressure, a height of a liquid level of the color paste in the second sub-container 15 is approximately the same as that of the paste outlet 103.

Moreover, when the liquid level of the color paste in the second sub-container 15 is flush with the paste outlet 103, a force exerted by the ambient atmospheric pressure on the liquid level of the color paste in the second sub-container 15 can prevent the color paste in the first sub-container 14 from continuing to flow towards the second sub-container 15.

Therefore, as long as there is color paste in the first sub-container 14, when the liquid level of the color paste in the second sub-container 15 is lower than the paste outlet 103, the color paste in the first sub-container 14 can be supplemented into the second sub-container 15. The first sub-container 14 can supplement the color paste for the second sub-container 15.

The inlet of the pump 50 communicates with the inner space of the second sub-container 15, and when the outlet end 22 is in the non-operating state, the outlet end 22 is coupled to the first opening 102 and inserted into the inner space of the second sub-container 15.

That is to say, the outlet end 22 can be moisturized through a second subspace 101c by inserting the outlet end 22 into the second sub-container 15.

As the paste outlet 103 is lower than the top wall of the second sub-container 15, the top wall of the second sub-container 15 and the liquid level of the color paste in the second sub-container 15 have a space therebetween, wherein humidity of this space is relatively high, so that when the outlet end 22 is inserted into this space, the outlet end 22 can be moisturized. Alternatively, the outlet end 22 can be directly inserted into the color paste in the second sub-container 15, so as to moisturize the outlet end 22.

In some embodiments of the present disclosure, the moisturizing space 101 is a space in the second sub-container 15 above the liquid level of the color paste. When the outlet end 22 is in the non-operating state, the outlet end 22 is located in the second sub-container 15 and above the liquid level of the color paste in the second sub-container 15.

That is to say, the outlet end 22 will not be inserted into the color paste in the second sub-container 15, but is inserted into the humid air in the second sub-container 15, and is moisturized by the humid air in the second sub-container 15, thus reducing the probability of the problems of dryness and blockage occurring to the outlet end 22.

In some embodiments of the present disclosure, a volume in the first sub-container 14 is larger than that in the second sub-container 15, and after the color paste in the second sub-container 15 is pumped out from the outlet end 22 of the outpouring tube 20, the color paste in the first sub-container 14 can be supplemented into the second sub-container 15.

As the second sub-container 15 is located below the first sub-container 14, the liquid level of the color paste in the second sub-container 15 is below the first sub-container 14 all the time. After a period of use, the color paste in the space of the first sub-container 14 can be completely supplemented into the second sub-container 15.

The outlet end 22 is optionally inserted into the second sub-container 15, wherein the outlet end 22 can be inserted into the humid air in the second sub-container 15, and certainly can also be inserted into the color paste in the second sub-container 15.

As there is always color paste in the second sub-container 15, the space in the second sub-container 15 maintains a humid environment all the time, the outlet end 22 can be inserted into the humid air in the second sub-container 15, and also can be inserted into the color paste in the second sub-container 15. Therefore, after the outlet end 22 is inserted into the second sub-container 15, the outlet end 22 can be moisturized, thus reducing the probability of the problems of dryness and blockage occurring to the outlet end 22.

The first sub-container 14 may be provided with a supplementing pipe 141 at bottom, wherein the supplementing pipe 141 may pass through the top wall of the second sub-container 15, and the top wall of the second sub-container 15 may be formed with three through holes for the supplementing pipe 141 to pass through, the inlet of the pump 50 to pass through, and the outlet end 22 to pass through.

After the outlet end 22 is detached from the second sub-container 15 and reaches the operating state, the outpouring tube 20 can pour out the color paste in the second sub-container 15 to the second container 40 through the outlet end 22; after the outlet end 22 is inserted into the second sub-container 15, as the outlet end 22 is in the humid environment, the outlet end 22 can be moisturized, thus reducing the probability of the problems of dryness and blockage occurring to the outlet end 22.

Certainly, after the outlet end 22 is inserted into the second sub-container 15, in order to further improve the moisturizing effect on the outlet end 22 and reduce the blockage probability of the outlet end 22, the color paste can be pumped out from the outlet end 22 at intervals, so that the color paste which has stayed at the outlet end 22 for a period of time is discharged, and the fresh color paste can stay at the outlet end 22, thus reducing the blockage probability of the outlet end 22. As the outlet end 22 is inserted into the second sub-container 15, the discharged color paste can enter the second sub-container 15 again, thereby realizing recirculation of the color paste.

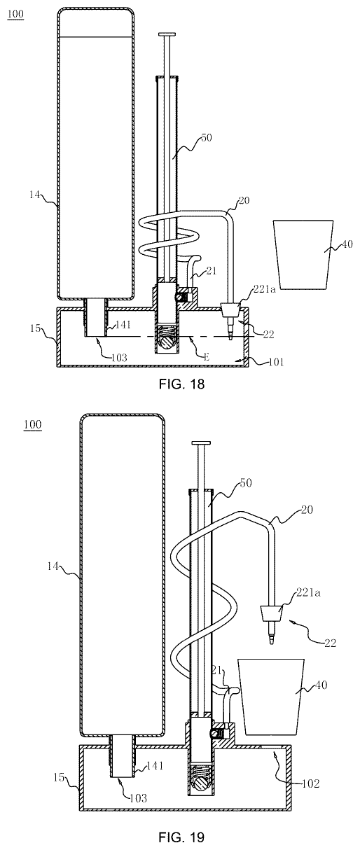

In some embodiments of the present disclosure, as shown in FIG. 18, the moisturizing space 101 is a space in the second container 15 below the liquid level of the color paste. That is to say, when the outlet end 22 is in the non-operating state, the outlet end 22 is inserted into the color paste in the second sub-container 15. Thus, the outlet end 22 can be moisturized by the color paste in the second sub-container 15 when being in the non-operating state, thus reducing the probability of the problems of dryness and blockage occurring to the outlet end 22.

In some embodiments of the present disclosure, as shown in FIG. 28 and FIG. 29, the first container 10 includes a first sub-container 14 and a second sub-container 15, wherein the first sub-container 14 may have a space therein, and the second sub-container 15 may also have a space therein.

The second sub-container 15 is provided outside the first sub-container 14, and an inner space of the first sub-container 14 does not communicate with an inner space of the second sub-container 15. That is to say, the color paste vapor generated by the color paste in the inner space of the first sub-container 14 will not enter interior of the second sub-container 15.

A volume of the first sub-container 14 can be larger than that of the second sub-container 15, and the first sub-container 14 can be mainly used for accommodating the color paste.

The inlet of the pump 50 communicates with the inner space of the first sub-container 14, so that the color paste in the first sub-container 14 can be pumped into the outpouring tube 20, and thus can be discharged from the outlet end 22.

The first opening 102 is provided on the second sub-container 15, that is to say, the outlet end 22 can be fitted with the first opening 102.

The outlet end 22 can be provided with a sealing cone 221a, and when the outlet end 22 is fitted with the first opening 102, the sealing cone 221a seals the first opening 102.

When the outlet end 22 is in the non-operating state, the outlet end 22 is coupled to the first opening 102 and inserted into the inner space of the second sub-container 15.

That is to say, in the embodiments of the present disclosure, an independent second sub-container 15 is additionally provided to moisturize the outlet end 22. The second sub-container 15 can be provided therein with the color paste, or the second sub-container 15 may contain an object capable of wetting the inner space of the second sub-container 15. For example, this object may be water contained in the second sub-container 15, and the water may evaporate to make the space above water surface a humid space. Alternatively, this object is a humidifier inside the second sub-container 15, and the inner space of the second sub-container 15 is humidified by a humidifying effect of the humidifier.

For example, in order to prevent the color paste at the outlet end 22 from being dried, the color paste at the outlet end 22 can be discharged outwards at intervals, and in this case, the discharged color paste can enter the interior of the second sub-container 15. Alternatively, in order to improve the accuracy of the outpouring amount of the color paste, before pouring out the color paste into the second sub-container 15 each time, the color paste at the outlet end 22 can be discharged into the second sub-container 15.

After the color paste in the second sub-container 15 reaches a preset amount, the color paste in the second sub-container 15 can be poured into the first sub-container 14, so as to realize recirculation of the color paste and reduce waste of the color paste.

In some embodiments of the present disclosure, as shown in FIG. 25 to FIG. 27, the first container 10 includes a canister body 11, and the canister body 11 can contain the color paste therein.

The canister body 11 has a first opening 102 in a top, and the color paste can be fed into the canister body 11 through the first opening 102.

The outlet end 22 is provided with a canister lid 13, and the outlet end 22 can be fixedly connected to the canister lid 13.

The outlet end 22 can be fixed to the canister lid 13 by bonding, and by a fastener, etc., which is not limited in the present disclosure.

When the outlet end 22 is switched from the non-operating state to the operating state, the canister lid 13 and the outlet end 22 are moved together so as to switch the outlet end 22 to the operating state, and detach the canister lid 13 from the canister body 11, and in this case, a top of the inner space of the first container 10 is opened, that is, the first opening 102 is opened; when the outlet end 22 is moved from the operating state to the non-operating state, the canister lid 13 is also moved with the outlet end 22, and in this case, the canister lid 13 is fitted with the canister body 11, the inner space of the first container 10 is closed, that is, the canister lid 13 closes the first opening 102, and the outlet end 22 can be inserted into the inner space of the first container 10.

The canister lid 13 is detachably fitted with the canister body 11. For example, the canister lid 13 can be magnetically fitted with the canister body 11, or the canister lid 13 is snap-fitted with the canister body 11.

Thus, when the outlet end 22 is in the non-operating state, the canister lid 13 fixedly connected to the outlet end 22 can seal the inner space of the first container 10, thus reducing the probability of the color paste vapor in the inner space of the first container 10 escaping outwards, and thereby improving the moisturizing effect of the inner space of the first container 10 on the outlet end.

In some embodiments of the present disclosure, as shown in FIG. 12 to FIG. 15, the first container 10 has a partitioning portion 60 therein, wherein the partitioning portion 60 divides the inner space of the first container 10 into a first subspace 101b and a second subspace 101c.

The partitioning portion 60 may itself define the second subspace 101c, and certainly, the partitioning portion 60 may define the second subspace 101c together with the first container 10.

The first subspace 101b has a volume larger than that of the second subspace 101c, so that the first subspace 101b can accommodate most of the color paste.

The first subspace 101b can communicate with the second subspace 101c, the color paste in the first subspace 101b can enter the second subspace 101c, or the high-humidity gas in the first subspace 101b can enter the second subspace 101c.

The inlet of the pump 50 communicates with the first subspace 101b, that is to say, the pump 50 can pump the color paste in the first subspace 101b into the outpouring tube 20.

When the outlet end 22 is in the non-operating state, the outlet end 22 is inserted into the second subspace 101c. That is to say, when the outlet end 22 is in the non-operating state, the outlet end 22 can be moisturized through the second subspace 101c.

The second subspace 101c can be provided therein with the color paste, vapor generated by the color paste can make the humidity above the second subspace 101c relatively high, and thus inserting the outlet end 22 into the second subspace 101c can render the moisturizing effect. Certainly, the outlet end 22 can also be directly inserted into the color paste in the second subspace 101c.

The color paste in the second subspace 101c may be the color paste flowing from the first subspace 101b, and certainly, the color paste in the first subspace 101b may be pumped by the pump 50 into the second subspace 101c through the outpouring tube 20.

By inserting the outlet end 22 into the second subspace 101c to be moisturized, when there is less color paste in the first subspace 101b or the humidity of the gas in an upper part of the first subspace 101b is relatively low, the color paste in the second subspace 101c can still make humidity of an upper space of the second subspace 101c higher, thus moisturizing the outlet end 22 more effectively.

The partitioning portion 60 may be located in an area of the first subspace 101b near the top, so that the outlet end 22 can be quickly inserted into the second subspace 101c when being in the non-operating state. Moreover, the reason of locating the partitioning portion 60 in the area close to the top of the first subspace 101b is also that the vapor of the color paste can converge upwards, so that the humidity of an area where the second subspace 101c is located is higher, thus further improving the moisturizing effect of the outlet end 22.

The partitioning portion 60 may be of a cubic structure, and includes a rectangular bottom plate and a plurality of side plates provided at edges of the rectangular bottom plate, so that the partitioning portion 60 and the first container 10 together can enclose the second subspace 101c.

Alternatively, the partitioning portion 60 is of a cylindrical structure, and includes a semicircular bottom plate and an arc-shaped plate provided at an edge of the semicircular bottom plate, and the partitioning portion 60 and the first container 10 together can enclose the second subspace 101c.

A bottom wall of the partitioning portion 60 and a peripheral wall of the partitioning portion 60 define the second subspace 101c. An overflow hole 601 may be formed on the peripheral wall of the partitioning portion 60, and the overflow hole 601 may be spaced apart from the bottom wall of the partitioning portion 60, so that a certain amount of color paste can be stored in the second subspace 101c, and once the liquid level of the color paste exceeds a height of the overflow hole 601, excess color paste will flow into the first subspace 101b from the overflow hole 601.

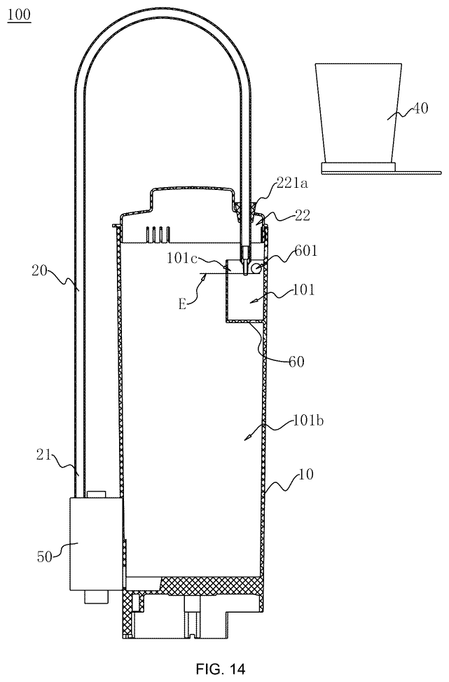

In some embodiments of the present disclosure, as shown in FIG. 14 and FIG. 15, the partitioning portion 60 further includes an overflow hole 601 configured to guide the color paste in the second subspace 101c to the first subspace 101b when the amount of the color paste in the second subspace 101c reaches a threshold.

For example, when the color paste in the second subspace 101c reaches a half of the volume of the second subspace 101c, the overflow hole 601 guides excess color paste to the first subspace 101b.

Thus, the color paste in the second subspace 101c can be kept at the threshold, and a case that the outlet end 22 has no accommodation space due to excess color paste is avoided. For example, the outlet end 22 is inserted into the humid air in the second subspace 101c, and if the color paste fills the second subspace 101c without constraint, the outlet end 22 is necessarily flooded with the color paste.

In some embodiments according to the present disclosure, there is color paste in the second subspace 101c, wherein the color paste in the second subspace 101c can be specially poured therein, and can also be obtained after the color paste in the first subspace 101b flows into the second subspace 101c.

For example, when the outlet end 22 is inserted into the second subspace 101c, the color paste can be poured into the second subspace 101c through the outlet end 22, so that there is a certain amount of color paste in the second subspace 101c. Certainly, in order to further reduce the probability of dryness and blockage of the outlet end 22, the color paste can be controlled to be pumped out from the outlet end 22 at intervals, so that the color paste having stayed at the outlet end 22 for a period of time is discharged into the second subspace 101c, and then new color paste stays at the outlet end 22.

Water vapor evaporated from the color paste in the second subspace 101c can stay in an area in the second subspace 101c above the liquid level of the color paste, so that the high-humidity environment of the second subspace 101c above the liquid level of the color paste can moisturize the outlet end 22. Certainly, it may be understood that, the second subspace 101c can also communicate with the first subspace 101b, so that the high-humidity air in the first subspace 101b can enter the second subspace 101c.

As the outlet end 22 is located in the area of the second subspace 101c above the liquid level of the color paste, the outlet end 22 will not be inserted into the color paste in the second subspace 101c, thus reducing influence of the color paste hanging on an outer wall of the outlet end 22 on outpouring accuracy of the outlet end 22 when the color paste is pumped out from the outlet end 22.

It may be understood that the overflow hole 601 may be in various shapes, for example, the overflow hole 601 may be in a circular shape, a polygonal shape or other irregular shapes. There may be one overflow hole 601, and certainly, there may also be a plurality of overflow holes. When a plurality of overflow holes 601 are formed, the plurality of the overflow holes 601 can be formed at intervals along a circumferential direction of the partitioning portion 60.

In some embodiments of the present disclosure, the outlet end 22 is fixed in position, and the first container 10 is movable relative to the outlet end 22. Thus, the first container 10 may be an active member, so as to make the first container 10 couple with or separate from the outlet end 22, so that the outlet end 22 can be switched between the operating state and the non-operating state.

In some embodiments of the present disclosure, the outlet end 22 is fixed in position, the colorant dispenser 100 includes a first driving mechanism 70, and the first driving mechanism 70 is connected to the first container 10.

The first driving mechanism 70 may be directly connected to the first container 10, or may be indirectly connected to the first container 10 through an intermediary, as long as it is ensured that the first container 10 can move under driving of the first driving mechanism 70.

The first driving mechanism 70 is configured to drive the first container 10 to move, so as to make the first container 10 couple with or separate from the outlet end 22.

That is to say, the first container 10 may be an active member, and the first driving mechanism 70 can drive the first container 10 to move actively so as to make the first container 10 couple with or separate from the outlet end 22.

When the first container 10 is coupled with the outlet end 22, the first driving mechanism 70 can drive the first container 10 to move, so that the first container 10 can be separated from the outlet end 22; when the first container 10 is separated from the outlet end 22, the first driving mechanism 70 can drive the first container 10 to move, so that the first container 10 can be coupled with the outlet end 22.

Thus, when the first container 10 is coupled with the outlet end 22, the outlet end 22 is inserted into the moisturizing space 101, so that the outlet end 22 can be moisturized; after the first container 10 is separated from the outlet end 22, the outlet end 22 can be in the operating state, so that the color paste can be discharged to the second container 40 from the outlet end 22.

The first container 10 can be driven by the first driving mechanism 70 to translate, move in a curve, rotate, or swing, which is not limited in the present disclosure.

In some embodiments of the present disclosure, as shown in FIG. 10 and FIG. 11, the colorant dispenser 100 further includes a fixed frame 81, and the outlet end 22 is fixedly connected to the fixed frame 81.

Thus, the outlet end 22 can stay stationary, and the first container 10 is driven by the first driving mechanism 70 to move, so that the first container 10 is close to or away from the outlet end 22.

In some embodiments of the present disclosure, as shown in FIG. 10 and FIG. 11, the first driving mechanism 70 is configured to drive the first container 10 to rotate. That is to say, the first container 10 can rotate around an axis, and particularly, a part of the first container 10 connected to the outlet end 22 can move along an arc-shaped track, so that the first container 10 is connected to or separated from the outlet end 22.

The first container 10 can be forwardly rotated by a preset angle, so that the outlet end 22 reaches outside the first container 10 in the operating state from inside the first container 10. If it still cannot be realized that the color paste is pumped into the second container 40 from the outlet end 22, a position of the second container 40 can be adjusted so that the color paste is pumped out to the second container 40 from the outlet end 22, for example, the second container 40 can be moved so as to make the second container 40 locate directly below the outlet end 22.

After the outpouring action is completed, the first container 10 can be reversely rotated by a preset angle, so that the outlet end 22 is switched from the operating state of being outside the first container 10 to the non-operating state of being inserted into the first container 10, thus reducing water loss of the outlet end 22 in the non-outpouring state, and reducing the probability of the problems of dryness and blockage occurring to the outlet end 22.

In some embodiments of the present disclosure, as shown in FIG. 10 and FIG. 11, the colorant dispenser 100 further includes a second driving mechanism 91, and the second driving mechanism 91 is connected to the second container 40.

The second driving mechanism 91 may be directly connected to the second container 40, or may be indirectly connected to the second container 40 through an intermediary, as long as it is ensured that the second container 40 can move under driving of the second driving mechanism 91.

As the second driving mechanism 91 is connected to the second container 40, after the outlet end 22 is separated from the first container 10, that is, when the outlet end 22 is in the operating state, the second driving mechanism 91 can drive the second container 40 to move to below the outlet end 22.

For example, the first driving mechanism 70 can be provided in the above fixed frame 81, so that the second container 40 can move relative to the fixed frame 81. Thus, the second container 40 can be moved to below the outlet end 22 when the outlet end 22 is in the operating state, and can be retracted when the outlet end 22 is in the non-operating state.

According to some embodiments of the present disclosure, the first container 10 is fixed in position and the outlet end 22 is movable relative to the first container 10. Thus, the outlet end 22 can be an active member, so that the outlet end 22 is coupled with or separated from the first container 10, and thus the outlet end 22 can be switched between the operating state and the non-operating state.

In some embodiments of the present disclosure, the first container 10 is fixed in position, and the colorant dispenser 100 further includes a first driving mechanism 70, wherein the first driving mechanism 70 is connected to the outlet end 22, thus power of the first driving mechanism 70 can be transmitted to the outlet end 22, and the outlet end 22 can move under driving of the first driving mechanism 70.

The first driving mechanism 70 may be directly connected to the outlet end 22, or may be indirectly connected to the outlet end 22 through an intermediary, as long as it is ensured that the outlet end 22 can move under driving of the first driving mechanism 70.

The first driving mechanism 70 is configured to drive the outlet end 22 to move, so as to make the outlet end 22 to be coupled with or separated from the outlet end 10.

That is to say, the outlet end 22 may be an active member, and the first driving mechanism 70 can drive the outlet end 22 to move actively, so as to make the outlet end 22 couple with or separate from the first container 10.

When the outlet end 22 is coupled with the first container 10, the first driving mechanism 70 can drive the outlet end 22 to move, so that the outlet end 22 can be separated from the first container 10; when the outlet end 22 is separated from the first container 10, the first driving mechanism 70 can drive the outlet end 22 to move, so that the outlet end 22 can be coupled with the first container 10.

Thus, when the outlet end 22 is coupled with the first container 10, the outlet end 22 is inserted into the moisturizing space 101, so that the outlet end 22 can be moisturized; after the outlet end 22 is separated from the first container 10, the outlet end 22 can be in the operating state, so that the color paste can be discharged to the second container 40 from the outlet end 22.

That is to say, the first container 10 and the outlet end 22 can move relative to each other, so as to make the outlet end 22 close to or away from the first container 10. The first container 10 may be an active member, and the first container 10 actively moves to make the outlet end 22 close to or away from the first container 10; or the outlet end 22 is an active member, and the outlet end 22 actively moves to make the outlet end 22 close to or away from the first container 10. Certainly, it may be understood that the first container 10 and the outlet end 22 both may be active members, and both may actively move so as to be close to each other or away from each other.

The outlet end 22 may be configured to move in a vertical direction or/and move a horizontal direction so as to be close to or away from the first container 10.

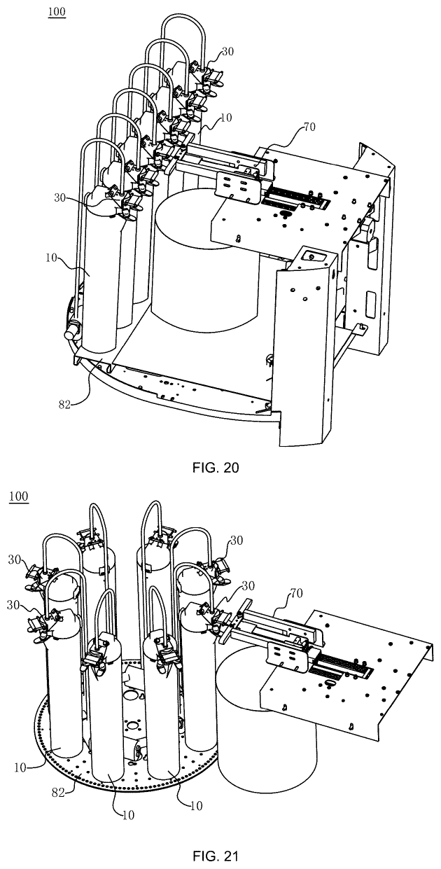

In some embodiments of the present disclosure, as shown in FIG. 20 and FIG. 21, a plurality of first containers 10 are provided, the color paste in each of the first containers 10 may have a different color, and certainly, colors of the color pastes in the plurality of first containers 10 may also be the same.

The colorant dispenser 100 further includes a carrying mechanism 82, wherein the carrying mechanism 82 is configured to carry the plurality of first containers 10, that is to say, the plurality of first containers 10 are all placed on the carrying mechanism 82.

The carrying mechanism 82 may choose one of the plurality of first containers 10 to move it to a position butt-joined with the first driving mechanism 70. The plurality of first containers 10 can move in a horizontal plane or a vertical plane, and also can move in a three-dimensional space.

That is to say, for example, the carrying mechanism 82 can move, so that the carrying mechanism 82 can drive the first containers 82 thereon to move to the position butt-joined with the first driving mechanism 70. Thus, the outlet end 22 on the first container 10 located in the position butt-joined with the first driving mechanism 70 or the first container 10 can be driven by the first driving mechanism to be connected or separated.

In some embodiments of the present disclosure, as shown in FIG. 20, the carrying mechanism 82 is a linear reciprocating mechanism. Therefore, the carrying mechanism 82 can move back and forth in a linear direction, so that when the color paste of a certain color is needed, the first container 10 containing the color paste of this color can be moved to the position butt-joined with the first driving mechanism 70, and the color paste is pumped outwards from the outlet end 22 corresponding to this first container 10. After the color paste of this color is completely poured out, the outlet end 22 can be inserted into this first container 10, and then the carrying mechanism 82 is moved to reset this first container 10, or the carrying mechanism 82 is moved to move the first container 10 containing the color paste of another color to the position butt-joined with the first driving mechanism 70.

The carrying mechanism 82 may be a linear plate portion, and the plurality of first containers 10 can be arranged in sequence in a length direction of the linear plate portion.

Certainly, a driving mechanism may be provided to drive the carrying mechanism 82 to move back and forth in the length direction of the linear plate portion.

In some embodiments of the present disclosure, as shown in FIG. 21, the carrying mechanism 82 is a rotating mechanism. Therefore, the carrying mechanism 82 can rotate, so that when the color paste of a certain color is needed, the first container 10 containing the color paste of this color can be rotated to the position butt-joined with the first driving mechanism 70, so that the color paste is pumped outwards from the outlet end 22 corresponding to this first container 10. After the color paste of this color is completely poured out, the outlet end 22 can be inserted into this first container 10, and then the carrying mechanism 82 is rotated to reset this first container 10, or the carrying mechanism 82 is moved to rotate the first container 10 containing the color paste of another color to the position butt-joined with the first driving mechanism 70.

The carrying mechanism 82 may be an arc-shaped plate portion, and the plurality of first containers 10 can be arranged in sequence in a circumferential direction of the arc-shaped plate portion.

Certainly, a driving mechanism can be provided to drive the carrying mechanism 82 to rotate in the circumferential direction of the arc-shaped plate portion.

In some embodiments of the present disclosure, there are a plurality of first driving mechanisms 70 and a plurality of first containers 10, and the plurality of first driving mechanisms 70 are in one-to-one correspondence with the plurality of first containers 10.

Each first driving mechanism 70 is configured to drive the corresponding outlet end 22 to move, so as to make the outlet end 22 couple with or separate from the first container 10.

That is to say, each first container 10 has a dedicated first driving mechanism 70 to drive the outlet end 22 to move, so that the outlet end 22 can be switched between the non-operating state and the operating state. Each outlet end 22 moves more flexibly, and a plurality of outlet ends 22 can even be switched together to the operating state for pouring out the color paste into the second container 40, which solution particularly can be used for a simultaneous pouring type colorant dispenser of latex paint.

According to some embodiments of the present disclosure, as shown in FIG. 24, the outpouring tube 20 is provided with a valve structure 83, wherein the valve structure 83 is configured to control an outpouring amount or opening and closing of the outlet end 22.

Thus, when the outlet end 22 is in the operating state, the amount of color paste pumped into the second container 40 from the outlet end 22 can be controlled by the valve structure 83, so that the second container 40 can be ensured to receive an appropriate amount of color paste.

In addition, when the outlet end 22 is in the operating state but there is no need to pour out the color paste into the second container 40, the valve structure 83 can be controlled to close the passage in the outpouring tube 20, so as to prevent the color paste from flowing out of the outlet end 22 to the second container 40.

Certainly, when the outlet end 22 is in the non-operating state, the valve structure 83 also can be controlled to close the passage in the outpouring tube 20, so as to prevent the color paste from flowing out of the outlet end 22 into the first container 10.

In some embodiments of the present disclosure, as shown in FIG. 22, the pump 50 is a piston pump, and the piston pump can be installed on the canister body 11 in an inverted manner. The piston pump communicates with the inner space of the canister body 11 through a diversion valve 51, wherein the diversion valve 51 is located above the piston pump, and a liquid outlet of the diversion valve 51 is connected to the inlet end 21 of the outpouring tube 20.

Thus, the gas in the color paste can rise to the diversion valve 51 on the top, and the gas in the diversion valve 51 can be discharged quite easily just by discharging a part of the color paste outwards.

Optionally, as shown in FIG. 22 and FIG. 23, regardless of whether the piston pump is upside down or upright (the diversion valve 51 is located below the piston pump), the outpouring tube 20 has a bent section 23 located in a lower part, and a lowest point of the bent section 23 is lower than a lowest liquid level of the color paste in the color-paste canister, so that ambient air can be avoided from being siphoned into the diversion valve 51, the piston pump or the canister body 11.

After the color paste is pumped out from the outlet end 22, due to viscosity of the color paste, a phenomenon that the color paste protrudes from an end portion of the outlet end 22 will occur, consequently, in the process of switching the outlet end 22 between the non-operating state and the operating state, the protruding color paste drop is quite easy to drop, and thus contaminating the first container 10, the second container 40 or other parts below a movement route.

In addition, after the color paste is pumped into the first container 10 from the outlet end 22, the color paste drop which should have dropped downwards protrudes from the end portion of the outlet end 22 due to the viscosity, but when it is switched to the operating state, and the color paste is pumped out from the outlet end 22, the color paste drop protruding from the outlet end 22 will affect the accuracy of the outpouring amount of the color paste.

Generally, the higher the viscosity of the color paste is, the more likely the color paste drop protrudes from the end portion of the outlet end 22, which is commonly known as drop hanging problem.

Therefore, the present disclosure provides a color-paste outpouring method, and this color-paste outpouring method can be applied to the colorant dispenser 100 of the above embodiments.

As shown in FIG. 32, the color-paste outpouring method at least includes following steps:
pumping out the color paste from the outlet end 22; and
the pump 50 operating so as to make the color paste in the outpouring tube 20 move towards the first container 10 by a preset distance.

After the color paste is pumped out from the outlet end 22, the color paste drop may protrude from the end portion of the outlet end 22, that is, the phenomenon of drop hanging may occur. By controlling the pump 50 to operate, the color paste in the outpouring tube 20 can be sucked back towards the first container 10 for a certain distance, so that the color paste drop protruding from the end portion of the outlet end 22 is moved towards the inside of the outpouring tube 20, and the color paste drop no longer protrudes from the end portion of the outlet end 22.

Thus, in the process of switching the outlet end 22 between the non-operating state and the operating state, if the position of the outlet end 22 in the operating state is different from the position in the non-operating state, in the process of moving the outlet end 22, by using the color-paste outpouring method of this embodiment, the problem of the color paste drop dropping downwards from the outlet end 22 and contaminating the canister body is alleviated. Meanwhile, as the color paste drop no longer protrudes from the end portion of the outlet end 22, when the outlet end 22 is in the operating state and the color paste is poured outwards, the accuracy of the outpouring amount of the color paste is improved.

It should be noted that the port of the outlet end 22 generally faces downwards, and that the color paste drop in the embodiments of the present disclosure does not protrude from the end portion of the outlet end 22 refers to that a lowest point of the color paste drop is not lower than the end portion of the outlet end 22.

In some embodiments of the present disclosure, pumping out the color paste from the outlet end 22 refers to pumping out the color paste from the outlet end 22 in the operating state, or pumping out the color paste from the outlet end 22 in the non-operating state.

That is to say, after the outlet end 22 is in the operating state and the color paste is poured out, the pump 50 can operate and make the color paste in the outpouring tube 20 suck back for a certain distance, so that the color paste drop will not protrude from the end surface of the outlet end 22. Alternatively, after the outlet end 22 is in the non-operating state and the color paste is poured out, the pump 50 can operate and make the color paste in the outpouring tube 20 suck back for a certain distance, so that the color paste drop will not protrude from the end surface of the outlet end 22.

In some embodiments of the present disclosure, a distance between the liquid level of the color paste in the outpouring tube 20 and the end surface of the outlet end 22 is s, satisfying 0 mm≤s≤5 mm.

When the port of the outlet end 22 faces downwards, the liquid level of the color paste in the outpouring tube 20 refers to a part of the color paste in the outpouring tube 20 located at a lowest position; and the end surface of the outlet end 22 refers to the end surface where a color paste outlet of the outlet end 22 is located.

For example, the distance s between the liquid level of the color paste in the outpouring tube 20 and the end surface of the outlet end 22 may be 0 mm, 0.5 mm, 1 mm, 1.5 mm, 2 mm, 2.5 mm, 3 mm, 3.5 mm, 4 mm, 4.5 mm, 5 mm.

Thus, the color paste drop in the outpouring tube 20 can be ensured not to protrude from the end surface of the outlet end 22, and meanwhile, the problem that the accuracy of outpouring amount of the color paste is reduced due to a too large distance between the liquid level of the color paste in the outpouring tube 20 and the end surface of the outlet end 22 will not appear.

According to some embodiments of the present disclosure, 0 mm≤s≤3 mm. For example, the distance s between the liquid level of the color paste in the outpouring tube 20 and the end surface of the outlet end 22 may be 0 mm, 0.3 mm, 0.6 mm, 0.9 mm, 1.2 mm, 1.5 mm, 1.8 mm, 2.1 mm, 2.4 mm, 2.7 mm, 3 mm.

Thus, the color paste drop in the outpouring tube 20 can be further ensured not to protrude from the end surface of the outlet end 22, and meanwhile, the influence of the distance between the liquid level of the color paste and the outlet end 22 on the accuracy of outpouring amount of the color paste can be further reduced.

Another color-paste outpouring method in the embodiments of the present disclosure is briefly described below.

The color-paste outpouring method according to the embodiments of the present disclosure is applied to the colorant dispenser 100 of any one of the above embodiments. As shown in FIG. 33, the color-paste outpouring method includes at least following steps:
making the outlet end 22 in the non-operating state; and
the pump 50 operating so as to pour out the color paste in the outlet end 22 into the first container.

When the outlet end is in the non-operating state, at least a part of the outlet end 22 is located in the moisturizing space 101 of the first container 10. In this case, the moisturizing space 101 is in a closed state, and thus the color paste vapor inside the moisturizing space 101 can moisturize the outlet end 22.

In a period when the outlet end 22 is in the non-operating state, the color paste at the outlet end 22 can be poured out through the pump 50. Thus, even if a part of the original color paste at the outlet end 22 has been evaporated, the previous color paste at the outlet end 22 can be quickly replaced by the fresh color paste, thus further reducing the probability of dryness and blockage occurring to the outlet end 22. In addition, as the outlet end 22 is located in the first container 10, the color paste pumped out from the outlet end 22 can flow back into the color paste in the first container 10, and the problem of wasting the color paste will not occur.

The color paste at the outlet end 22 can be poured into the first container 10 at preset intervals, so as to further reduce the probability of dryness and blockage occurring to the outlet end 22. It is also feasible that the color paste is poured outwards before the outlet end 22 is in the operating state.

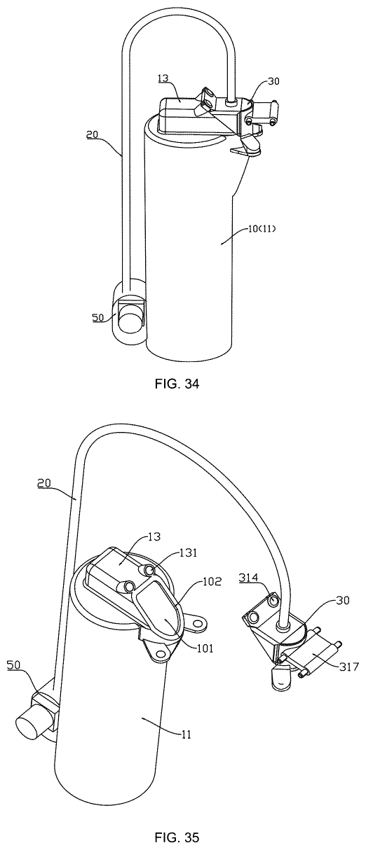

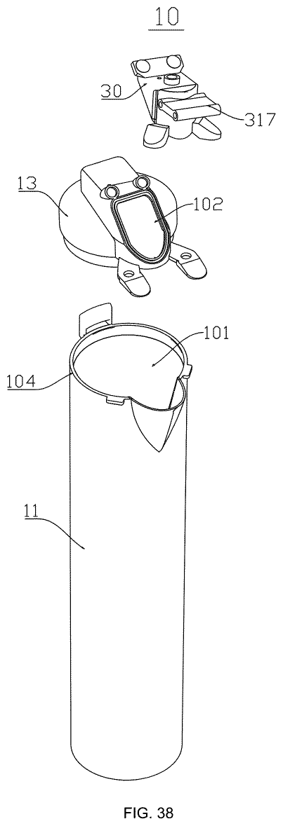

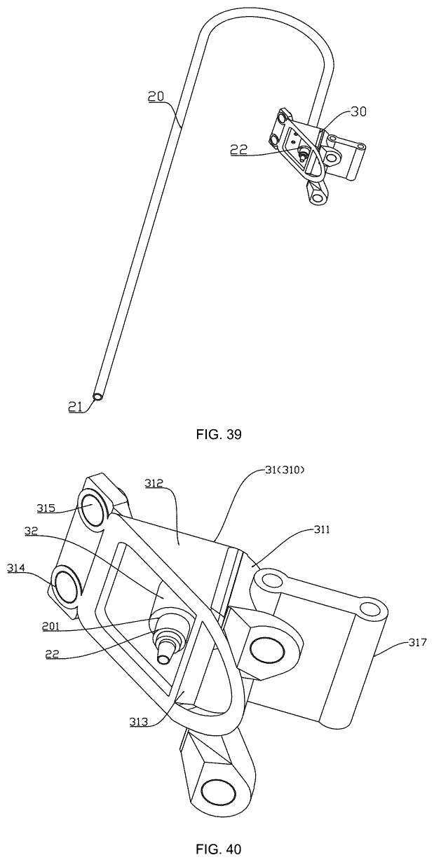

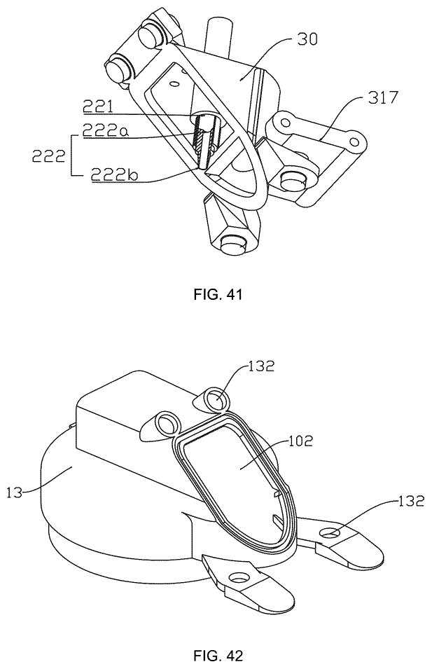

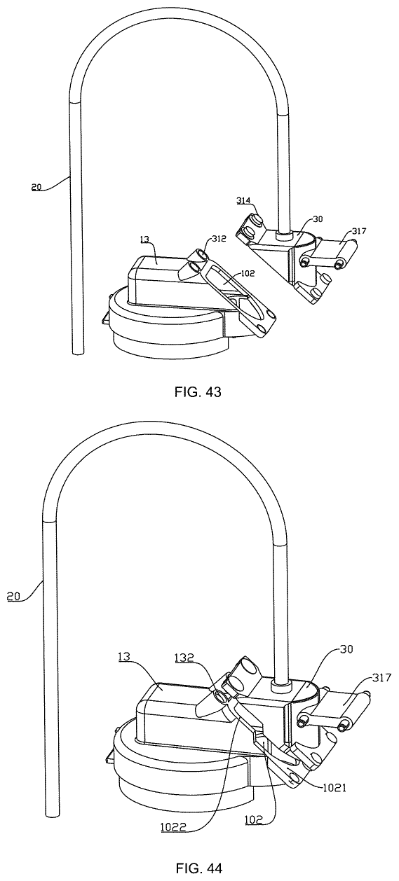

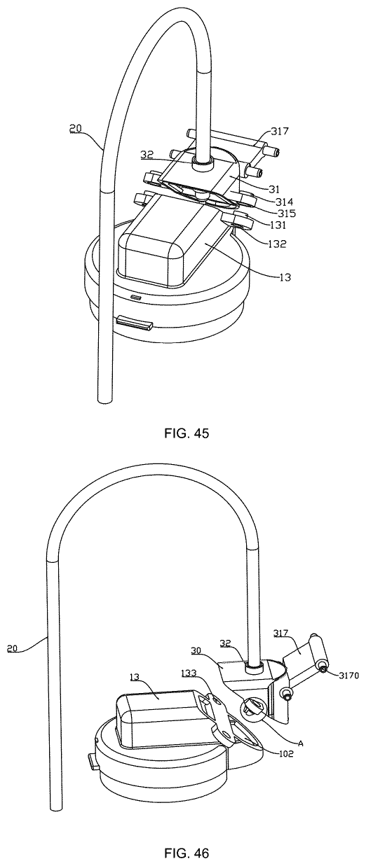

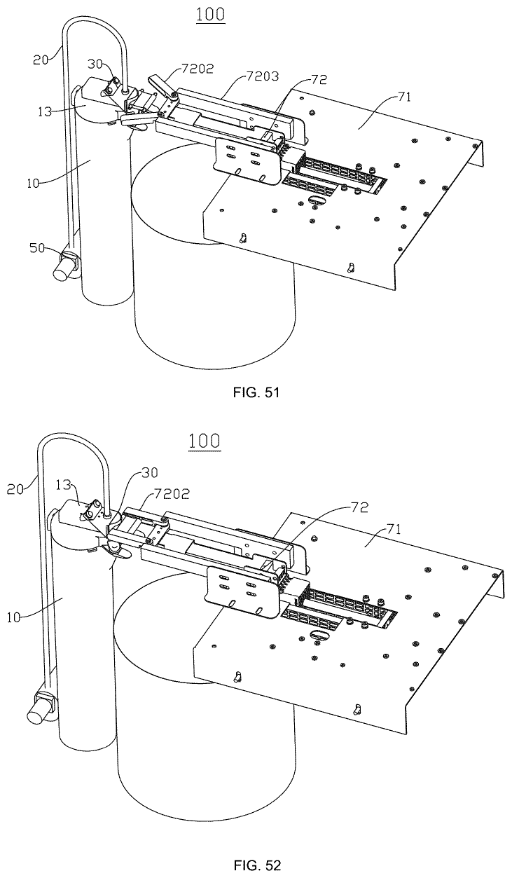

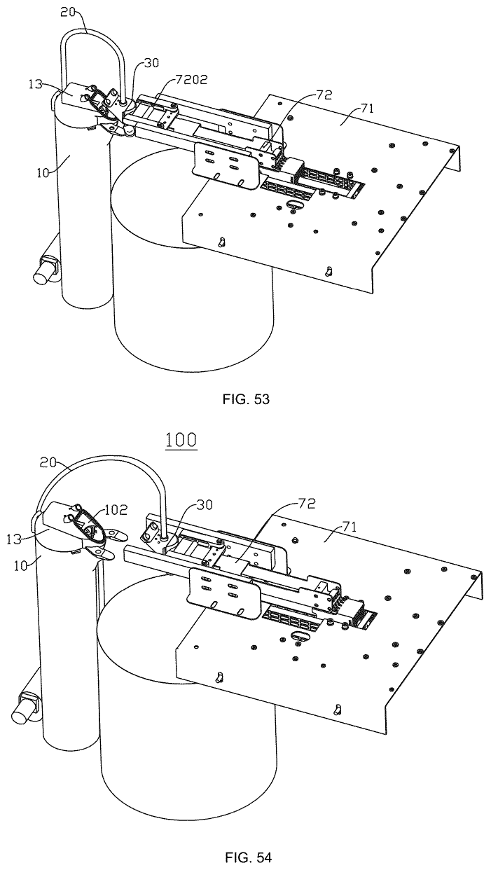

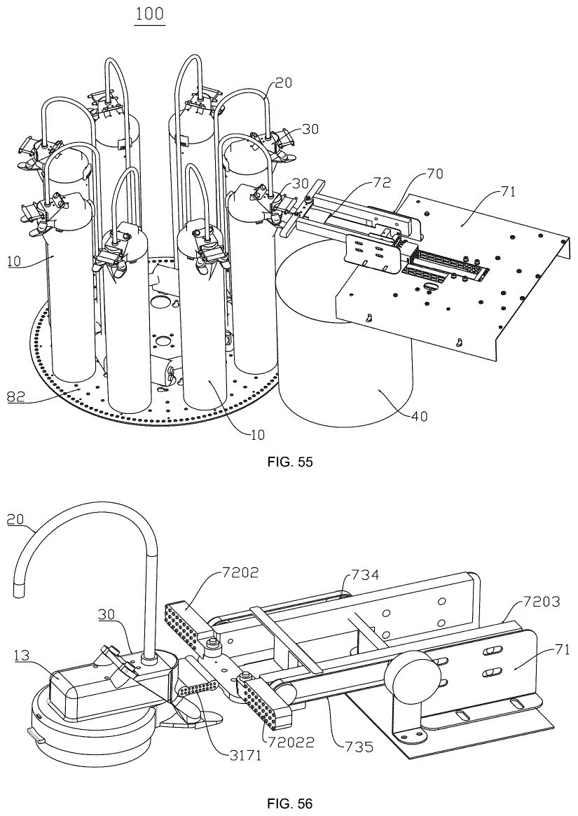

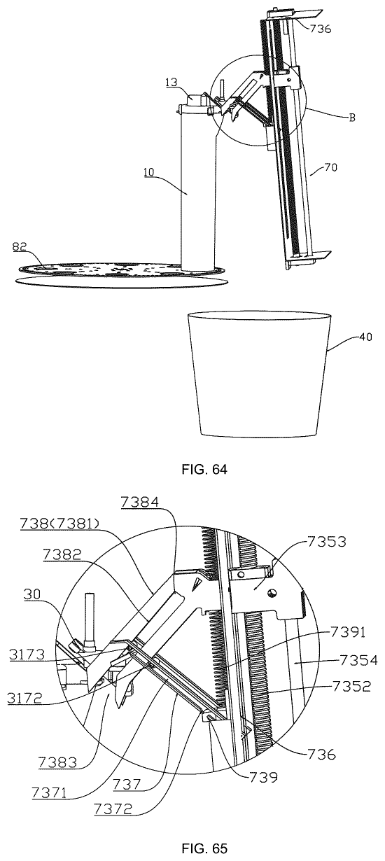

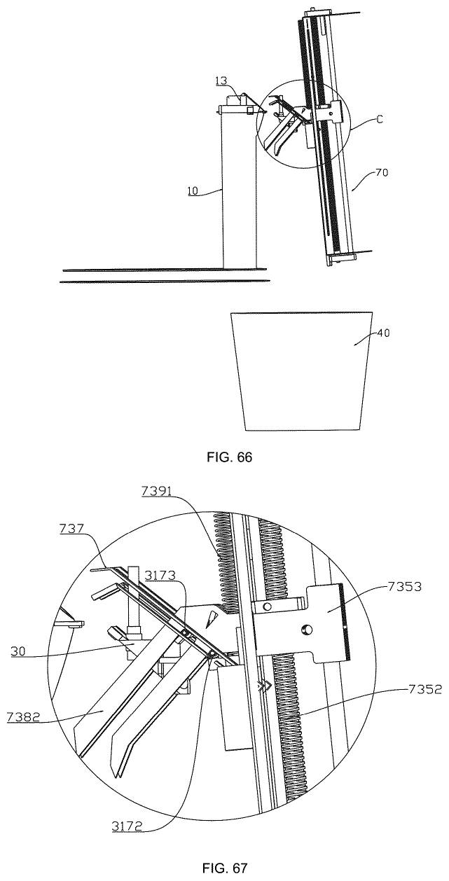

As shown in FIG. 34 to FIG. 67, some specific embodiments of the colorant dispenser of the present disclosure are described in detail below.

In some embodiments, referring to FIG. 40, the sealing lid 30 has a first through hole 201, and the outlet end 22 passes through the first through hole 201. By forming the first through hole 201 on the sealing lid 30 for the outlet end 22 of the outpouring tube 20 to pass therethrough, connection between the sealing lid 30 and the outlet end 22 is realized.

In the above, the outlet end 22 and the first through hole 201 may be connected in various methods, for example, the outlet end 22 and the first through hole 201 may be bonded, interference-fitted or threaded, or a fastener is first fixed at an outer tube wall of the outpouring tube 20 in proximity to the outlet end 22, and then the outlet end 22 is fixed in the first through hole 201 by means of a screw or a snap-fit. A specific connection method may be determined according to actual situations.

Exemplarily, the outlet end 22 and the first through hole 201 are in interference fit. By adopting the method of interference fit between the outlet end 22 and the first through hole 201, the interference fit has the advantages of simple connection, good alignment, large carrying capacity, less weakening structural strength of the outpouring tube 20 and good impact resistance.

In some embodiments, with continued reference to FIG. 40, the sealing lid 30 includes a body 31 and a sleeve 32, wherein the sleeve 32 is connected to the body 31, the sleeve 32 has a central hole forming the first through hole 201. By providing the sleeve 32 in the sealing lid 30, the central hole of the sleeve 32 forms the first through hole 201 of the sealing lid 30, then the outpouring tube 20 passes through the sleeve 32, and the sleeve 32 is connected to the outlet end 22 of the outpouring tube 20, which may have a certain protecting effect on the outpouring tube 20.

In the above, the sleeve 32 and the body 31 may be fixedly connected to each other, or may be integrally formed. In the present embodiment, the sleeve 32 and the body 31 are integrally formed, thus ensuring overall structural stability of the sealing lid 30.

In some embodiments, the sleeve 32 protrudes from an inner surface and/or an outer surface of the body 31. Compared with a case where the sleeve 32 is flush with the inner surface of the body 31, in a situation that a thickness of the sealing lid 30 is certain, the sleeve 32 can play a role in prolonging a connection length and a connection area with the outpouring tube 20, and protecting and strengthening the outlet end 22 of the outpouring tube 20. When the sleeve 32 protrudes from the inner surface of the body 31, the sleeve 32 can reinforce a side of the outlet end 22 located on the inner surface of the body 31. When the sleeve 32 protrudes from the outer surface of the body 31, the sleeve 32 can reinforce a side of the outpouring tube 20 located on the outer surface of the body 31. When the sleeve 32 protrudes from the inner surface and the outer surface of the body 31, the sleeve 32 can reinforce both sides of the outpouring tube 20 located on the outer surface and the inner surface of the body 31, thus improving connection stability between the outpouring tube 20 and the sealing lid 30, and avoiding a problem of poor sealing performance caused by a gap generated between joining parts of the outpouring tube 20 and the sealing lid 30 due to repeated use.

In some embodiments, the body 31 includes a top wall 310, a first side wall 311 and two second side walls 312 provided opposite to each other, wherein the first side wall 311 and the two second side walls 312 are connected to a bottom side of the top wall 310, and sides of the first side wall 311 and the two side walls away from the top wall 310 are enclosed with the top wall 310. The sleeve 32 protrudes from the inner surface and/or the outer surface of the top wall 310.

In some embodiments, a reinforcing rib 313 is connected between the two second side walls 312. By connecting the reinforcing rib 313 between the two second side walls 312, the reinforcing rib 313 can integrally connect the two second side walls 312, so that the second side walls 312 of the body 31 are not deformed when being extruded, thus enhancing the structural stability of the body 31, and ensuring integrity of a covering surface of the body 31.

Certainly, the reinforcing rib 313 can also be connected to the first side wall 311. By making the reinforcing rib 313 connect to the two second side walls 312 as well as the first side wall 311, the reinforcing rib 313 can integrally connect the first side wall 311 and the two second side walls 312 into one piece, so that integrity of the three side walls of the body 31 is stronger, deformation resistance of the body 31 is improved, the cover surface correspondingly is unlikely to deform, and covering sealability of the canister lid 13 and the sealing lid 30 is ensured. Certainly, a material of the reinforcing rib 313 may be different from or the same as that of the body 31. In the present embodiment, the reinforcing rib 313 and the body 31 are integrally formed.

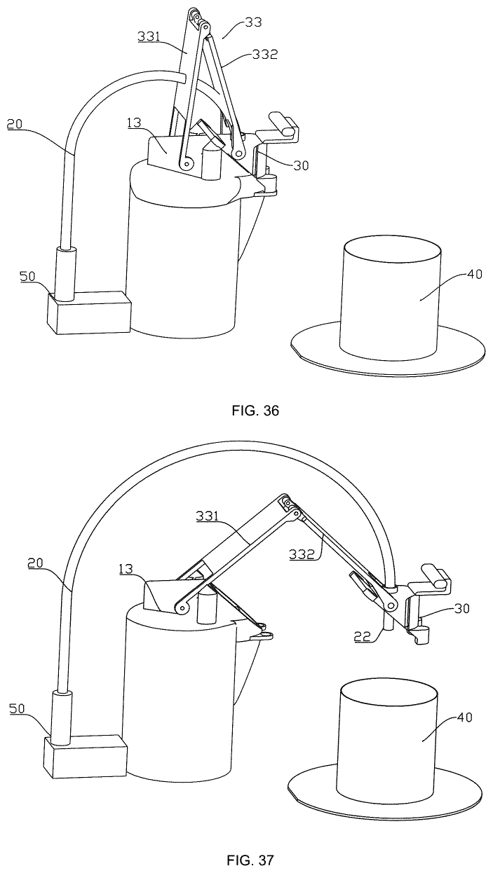

In some embodiments, referring to FIG. 40, the outlet end 22 at least includes a first pipe section 221 and a second pipe section 222, wherein an inside diameter of the second pipe section 222 is smaller than that of the first pipe section 221. By making the inside diameter of the second pipe section 222 smaller than that of the first pipe section 221, a hole size of the outlet end 22 of the outpouring tube 20 is reduced, and it can be seen according to the principle of hydromechanics that an outpouring speed of the outlet end 22 will be increased, which facilitates flow cutoff when the outpouring of the color paste is stopped. The second pipe section 222 has a fifth end 222a and a sixth end 222b in an axial direction, wherein the fifth end 222a is connected to the first pipe section 221, and the inside diameter of the second pipe section 222 is gradually reduced in a direction from the fifth end 222a to the sixth end 222b. By gradually reducing the inside diameter of the second pipe section 222, that is, gradually reducing an inside diameter of a tail end of the outpouring tube 20, the outpouring speed of the color paste from a paste pouring end of the outpouring tube 20 is higher, and the outpouring is smoother, thus reducing the probability of drop hanging occurring to the outlet end 22. Certainly, a dedicated outpouring nozzle part may also be inserted into the outlet end 22 of the outpouring tube 20 to make it form the inside diameter of the second pipe section 222. The fifth end 222a and the sixth end 222b have the same diameter which is smaller than the inside diameter of the first pipe section 221, forming the inside diameter of the outlet end 22 and forming the outlet end 22 for pouring out the color paste. In a latex-paint colorant dispenser for storefronts, a diameter of the outlet end 22 is usually between ϕ5 and ϕ1.5, a diameter of the outlet end 22 of the outpouring nozzle part is as close to an outside diameter thereof as possible, and in this way, the port of the outlet end 22 can be very thin, and is not prone to drop hanging, which generally is achieved by forming the outside of the outlet end 22 of the outpouring nozzle part into a tapered surface as shown in FIG. 37.

It may be understood that the drop hanging is that after the color paste has been pumped out from the outlet end 22, under a comprehensive effect of gravity, surface tension and viscosity of the color paste liquid, and wettability of the color paste on the outlet end, the color paste remaining in the outpouring tube 20 or the outlet end 22 flows to the tail end of the outlet end 22 and hangs at the outlet end 22, wherein the color paste is stringy in severe cases, and the phenomenon of drop hanging will affect accuracy of the color of the color paste. Certainly, the thinner the wall of the second pipe section, the better; and certainly, the tail end of the second pipe section may be of a knife-edge type.

In addition, the first container 10 may be of an integrated structure or a split-type structure. Besides, the first container 10 may be in various shapes, for example, the first container 10 may be in a spherical shape, a cylindrical shape, a square shape, a box shape, or the like. In the present embodiment, the first container 10 is in a cylindrical shape.

In some embodiments, a guiding unit 33 is provided between the sealing lid 30 and the canister lid 13, wherein the guiding unit 33 is configured to guide a movement track of the sealing lid 30 when being separated from the canister lid 13. There may be various kinds of guiding units 33. For example, referring to FIG. 36 and FIG. 37, the guiding unit 33 may include a first hinge member 331 and a second hinge member 332, wherein the first hinge member 331 has one end hinged with the canister lid 13 and the other end hinged with the second hinge 332, and one end of the second hinge member 332 facing back to the first hinge member 331 is hinged with the sealing lid 30. By providing the first hinge member 331 and the second hinge member 332, the sealing lid 30, when being moved in a position region where the sealing lid 30 is coupled with and separated from the canister lid 13, moves in a direction in which the first hinge member 331 and the second hinge member 332 can swing, which serves a function of guiding and limiting the movement of the sealing lid 30, so as to ensure movement accuracy of the sealing lid 30 and prevent occurrence of a phenomenon of deviation of the movement of the sealing lid 30.

In the above, the sealing lid 30 may be provided with one or more first magnetic parts 314, and the canister lid 13 may also be provided with one or more second magnetic parts 131. In a case where the sealing lid 30 has one first magnetic part 314, the sealing lid 30 and the canister lid 13 are connected through one magnetic point. When the sealing lid 30 has a plurality of first magnetic parts 314, the plurality of first magnetic parts 314 and the plurality of second magnetic parts 131 are in one-to-one correspondence in position, and the sealing lid 30 and the canister lid 13 are connected through a plurality of magnetic points.

Exemplarily, referring to FIG. 40 to FIG. 45, the sealing lid 30 is provided with a plurality of first magnetic parts 314, the canister lid 13 is provided with a plurality of second magnetic parts 131, and the plurality of first magnetic parts 314 and the plurality of second magnetic parts 131 are in one-to-one correspondence in position. By providing a plurality of first magnetic parts 314 and a plurality of second magnetic parts 131, there are a plurality of magnetic points between the canister lid 13 and the sealing lid 30, magnetic connection between the sealing lid 30 and the canister lid 13 is more stable, and even in a case where one or more magnetic parts of the sealing lid 30 and the canister lid 13 fail, the sealing lid 30 can still cover the first opening 102, thus ensuring the sealing between the sealing lid 30 and the canister lid 13.

In the above, the number of the first magnetic parts 314 may be any integer value, such as two, three, four or five. In the present embodiment, the number of the first magnetic parts 314 is four, and certainly, the number of the second magnetic parts 131 is also four. All of the first magnetic parts 314 and the second magnetic parts 131 may be permanent magnets, particularly neodymium-iron-boron strong magnets, and the magnetic connection between the first magnetic parts 314 and the second magnetic parts 131 is realized according to the principle that like poles repel each other and unlike poles attract each other. Alternatively, the first magnetic parts 314 and the second magnetic parts 131 may also be magnets and metal components which are magnetically connected, and the magnetic connection between the sealing lid 30 and the canister lid 13 can also be realized.

In addition, magnetic pole directions of various first magnetic parts 314 of the plurality of first magnetic parts 314 on the sealing lid 30 may be the same, or different, that is, the magnetic pole directions are opposite. Definitely, no matter the magnetic pole directions of various first magnetic parts 314 of the plurality of first magnetic parts 314 are the same or different, it needs to satisfy that the second magnetic part 131 at corresponding positions on the canister lid 13 and the first magnetic parts 314 at corresponding positions on the sealing lid 30 have opposite magnetic pole directions, so as to satisfy that unlike poles attract each other. That is, when the plurality of first magnetic parts 314 on the sealing lid 30 have the same magnetic pole direction, the magnetic pole direction of all of the plurality of second magnetic parts 131 on the canister lid 13 is opposite to the magnetic pole direction of the first magnetic parts 314. When the plurality of first magnetic parts 314 on the sealing lid 30 have different magnetic pole directions, it needs to satisfy that the second magnetic parts 131 at corresponding positions on the canister lid 13 and the first magnetic parts 314 at corresponding positions on the sealing lid 30 have opposite magnetic pole directions.

Exemplarily, the plurality of second magnetic parts 131 are spaced apart along a circumferential direction of the first opening 102, and two adjacent second magnetic parts 131 have opposite magnetic pole directions. By making two adjacent second magnetic parts 131 on the canister lid 13 have opposite magnetic pole directions, in a process of covering the sealing lid 30 on the first opening 102 of the canister lid 13, the first magnetic parts 314 on the sealing lid 30 can only be magnetically fitted with the second magnetic parts 131 at corresponding positions on the canister lid 13, but will not be magnetically attracted to the second magnetic parts 131 adjacent to the corresponding positions on the canister lid 13 or affected by the second magnetic parts 131 adjacent to the corresponding positions on the canister lid 13, because the first magnetic parts 314 at corresponding positions on the sealing lid 30 have the same magnetic pole direction as the second magnetic parts 131 adjacent to the corresponding positions on the canister lid 13, and a repulsive effect will be produced, which is equivalent to a mode of providing opposite magnetic pole directions for two adjacent second magnetic parts 131, and can have a function of self-positioning and correcting the magnetic connection between the sealing lid 30 and the canister lid 13, so that the sealing lid 30 can more accurately cover the first opening 102 of the canister lid 13.

In some embodiments, the sealing lid 30 is formed with a plurality of first mounting grooves 315, and each first magnetic part 314 is at least partially placed in the corresponding first mounting groove 315. By forming the first mounting grooves 315 on the sealing lid 30, the first magnetic parts 314 can be mounted in the first mounting grooves 315, and the first mounting grooves 315 can have a function of positioning and limiting the first magnetic parts 314, so that the first magnetic parts 314 can be mounted on the sealing lid 30 more stably.

In some embodiments, the canister lid 13 is formed with a plurality of second mounting grooves 132, and each second magnetic part 131 is at least partially placed in the corresponding second mounting groove 132. By forming the second mounting grooves 132 on the canister lid 13, the second magnetic parts 131 can be mounted in the second mounting grooves 132, and the second mounting grooves 132 can have a function of positioning and limiting the second magnetic parts 131, so that the second magnetic parts 131 can be mounted on the canister lid 13 more stably.

In the above, the number of the second mounting grooves 132 is corresponding to the number of the second magnetic parts 131. In addition, the first magnetic parts 314 may have various states in the first mounting grooves 315. For example, top surfaces of the first magnetic parts 314 may be flush with groove top surfaces of the first mounting grooves 315, or lower than the first mounting grooves 315, or protrude from the first mounting grooves 315, which may depend on actual situations. Likewise, top surfaces of the second magnetic parts 131 may be flush with groove top surfaces of the second mounting grooves 132, or lower than the second mounting grooves 132, or protrude from the second mounting grooves 132, depending on practical situations. In addition, the first magnetic parts 314 and the second magnetic parts 131 may be in various shapes, for example, the first magnetic parts 314 and/or the second magnetic parts 131 may be in a cylindrical shape, a square shape, a truncated cone shape or a prism shape. In the present embodiment, the first magnetic parts 314 and the second magnetic parts 131 are in a cylindrical shape. Likewise, the first magnetic parts 314 and the second magnetic parts 131 may be respectively fixed in the first mounting grooves 315 and the second mounting grooves 132 by screws (the magnets are provided a fixing hole at the center), glue, ultrasonic welding, clamping or other methods.

In some embodiments, referring to FIG. 46, when the sealing lid 30 closes the first opening 102, parts of the first magnetic parts 314 are placed in the second mounting grooves 132; alternatively, parts of the second magnetic parts 131 are placed in the first mounting grooves 315. When the sealing lid 30 closes the first opening 102, by placing parts of the first magnetic parts 314 in the second mounting grooves 132, that is, inserting the first magnetic parts 314 on the sealing lid 30 partially into the second mounting grooves 132, or inserting the second magnetic parts 131 on the canister lid 13 partially into the first mounting grooves 315 of the sealing lid 30, the sealing lid 30 and the canister lid 13 not only can be tightly attached under adsorption effect of magnetic force, but also can be mutually positioned and plugged, thus having a function of guiding and limiting the sealing lid 30 to cover the canister lid 13, and further improving coupling accuracy and coupling firmness of the sealing lid 30 and the canister lid 13.

In a situation that the number of the first magnetic parts 314 is four, when the sealing lid 30 closes the first opening 102, parts of the two first magnetic parts 314 on the sealing lid 30 are placed in the second mounting grooves 132 of the canister lid 13, and parts of the two second magnetic parts 131 on the canister lid 13 are placed in the first mounting grooves 315 of the sealing lid 30.

In the above, the sealing lid 30 may be provided with one or more snap-in portions 316, and the canister lid 13 may be correspondingly provided with one or more mating portions 133.

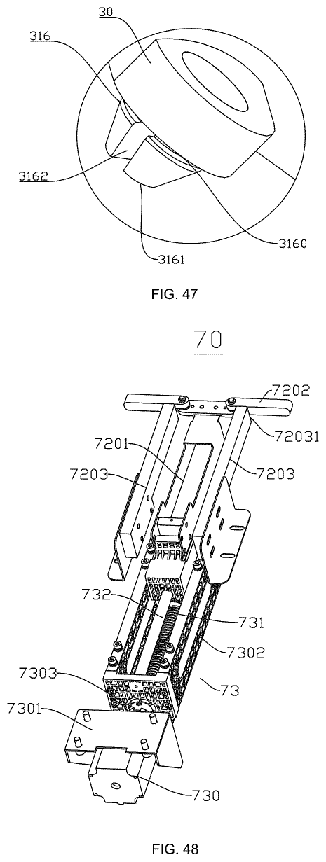

In some embodiments, referring to FIG. 46 and FIG. 47, the sealing lid 30 is provided with a plurality of snap-in portions 316, the canister lid 13 is provided with a plurality of mating portions 133, and the plurality of snap-in portions 316 and the plurality of mating portions 133 are in one-to-one correspondence in position. By providing the plurality of snap-in portions 316 and the plurality of mating portions 133, there are a plurality of snap-in points between the canister lid 13 and the sealing lid 30, connection stability between the sealing lid 30 and the canister lid 13 is higher, and even when one or more snap-in portions 316 or mating portions 133 between the sealing lid 30 and the canister lid 13 fail, the sealing lid 30 can still stably cover the first opening 102, thus ensuring the sealing between the sealing lid 30 and the canister lid 13.

In the above, the number of the snap-in portions 316 may be any integer value such as two, three or four, and the specific number of the snap-in portions 316 may depend on practical situations. The plurality of snap-in portions 316 on the sealing lid 30 may be all buckles, and the plurality of mating portions 133 on the canister lid 13 may be all snap holes. Alternatively, the plurality of snap-in portions 316 on the sealing lid 30 may include buckles and snap holes, and the plurality of mating portions 133 on the canister lid 13 correspondingly may also include snap holes and buckles, as long as it satisfies that the snap holes are snap-fitted with the buckles when the sealing lid 30 is fastened to the canister lid 13. In the present embodiment, two snap-in portions 316 are provided, the two snap-in portions 316 on the sealing lid 30 are both buckles, and the two mating portions 133 on the canister lid 13 are both snap holes.

In addition, the buckles may be in various shapes, for example, the buckles may be in a cylindrical shape, a square shape, a trapezoidal shape, or the like. In the present embodiment, the buckle is in a cylindrical shape.

In a situation that the buckles are in a cylindrical shape, the buckles have a third end 3160 and a fourth end 3161 in an axial direction, wherein the third end 3160 is closer to the sealing lid 30 than the fourth end 3161, a diameter of the buckles is gradually reduced in a direction from the third end 3160 to the fourth end 3161, and a hole diameter of the snap holes is larger than an outside diameter of the third end 3160 and smaller than or equal to an outside diameter of the fourth end 3161. The diameter of the buckles is gradually reduced in the direction from the third end 3160 to the fourth end 3161, so that even when slight deviation appears in the process of coupling the sealing lid 30 and the canister lid 13, the buckles can still be inserted into the snap holes through the fourth ends 3161, and along with increase of an insertion depth of the buckles, inner walls of the snap holes can guide the buckles, so that the sealing lid 30 can be adaptively adjusted in position, so as to be accurately snapped in the snap holes on the canister lid 13.

In order to improve the snapping stability between the sealing lid 30 and the canister lid 13, the buckle is provided with a longitudinal notch 3162 in a direction from the fourth end 3161 to the third end 3160, wherein the notch 3162 divides the buckle into a first buckle portion and a second buckle portion, and the notch 3162 is used for guiding the first buckle portion and the second buckle portion to abut against each other when the buckle is extruded by an extrusion force of the snap hole. By forming the notch 3162 on the buckle, the notch 3162 can be slightly deformed when the buckle receives an extrusion force of the inner wall of the snap hole, and guide the first buckle portion and the second buckle portion to abut against each other, so that the buckle can be more tightly snapped in the snap hole. After the snap-in connection is completed, a pre-tightening force exists between the snap hole and the buckle, and thus the coupling between the sealing lid 30 and the canister lid 13 is relatively more stable, and the canister lid 13 and the sealing lid 30 are less likely to become loose and fall off.

There are various relationships between a plane where the first opening 102 is located and a horizontal plane, and the plane where the first opening 102 is located and the horizontal plane may be perpendicular, parallel or inclined to each other.

Exemplarily, as shown in FIG. 46, the plane where the first opening 102 is located is provided obliquely relative to the horizontal plane. By providing the plane where the first opening 102 is located obliquely relative to the horizontal plane, the first opening 102 is an oblique opening, and in this way, covering the sealing lid 30 at the first opening 102 facilitates the first driving mechanism 70 in pulling the sealing lid 30 to be separated from or coupled with the canister lid 13. Moreover, the first opening 102 obliquely provided can make the sealing lid 30, when being separated, first move forward, or forward and downward, or diagonally forward and upward, or vertically upward, or diagonally forward to left and right.

In the above, the first opening 102 may be in various shapes. The first opening 102 may be in a circular shape, a square shape, a rectangular shape, or the like. An inclined angle of the plane where the first opening 102 is located with respect to the horizontal plane is an acute angle. In the present embodiment, the inclined angle of the plane where the first opening 102 is located with respect to the horizontal plane is 45°. Even the first opening 102 may not be a plane, but is formed by a plurality of planes. As shown in FIG. 44, the plane where the first opening 102 is located at least includes a first plane 1021 and a second plane 1022, wherein the first plane 1021 and the second plane 1022 are distributed in a stepped shape, and correspondingly, a coupling plane of the sealing lid 30 and the first opening 102 is provided corresponding to the plane where the first opening 102 is located.

In some embodiments, referring to FIG. 48 to FIG. 57, the colorant dispenser 100 further includes a second container 40 and a first driving mechanism 70. The first driving mechanism 70 is configured to be connected to the sealing lid 30 so as to drive the sealing lid 30 to move between a first position and a second position. When the sealing lid 30 is located in the first position, the sealing lid 30 closes the first opening 102; when the sealing lid 30 is located in the second position, the sealing lid 30 is separated from the first container 10, so as to pour the paste into the second container 40 through the outlet end 22. By providing the first driving mechanism 70, the first driving mechanism 70 can be connected to the sealing lid 30 and drive the sealing lid 30 to move between the first position and the second position. When the sealing lid 30 is located in the first position, the sealing lid 30 closes the first opening 102, thus realizing closing of an inner space of the first container 10. When the sealing lid 30 is located in the second position, the sealing lid 30 is separated from the first container 10, so as to pour the paste into the second container 40 through the outlet end 22, thus realizing outward pouring of the paste. Therefore, by providing the first driving mechanism 70, human participation is not required, and automation degree is high, reducing workload of workers.

In the above, the second container 40 may be a metal housing or a plastic housing, for example, POM plastic is used, so as to ensure structural strength of the second container 40. Certainly, the second container 40 may also be a housing of other materials, as long as the second container 40 is ensured to have certain structural strength, and it is convenient to mix internal color-matching coatings on a shaker, which is not limited in the present disclosure. The second container 40 can be opened in a top, and in this way, when the first driving mechanism 70 drives the sealing lid 30 to be separated from the first container 10, it is convenient to pour the paste into a top opening of the second container 40 through the outlet end 22, and the pouring of the paste is more convenient. The first driving mechanism 70 can be a variety of driving mechanisms, such as a simple lever that pushes the sealing lid 30 to move along a sliding rail to make the sealing lid 30 close the first opening 102 or make the sealing lid 30 separate from the first container 10, so as to pour the paste into the second container 40 through the outlet end 22, which is prior art and is not illustrated in the drawings. Likewise, a traction mechanism may also be a mechanical hand, such as a multi-axis mechanical arm commonly used in the prior art, for example, a six-axis mechanical arm. Movement in a three-dimensional direction can be realized using the mechanical hand, so as to complete grabbing or releasing of the sealing lid 30, and the flexibility is high, but the mechanical hand is costly. Certainly, the first driving mechanism 70 can also be a grabbing mechanism. All of these mechanisms are also prior art, and are not illustrated herein again.

In a situation that the first driving mechanism 70 is a mechanical hand, the mechanical hand can act on the sealing lid 30, and the mechanical hand separates the sealing lid 30 from the canister lid 13 and then pulls the sealing lid 30 to a paste-pouring position to pour the paste into the second container 40, or move the sealing lid 30 having completed the paste-pouring along with the outlet end 22 back to the first opening 102 of the canister lid 13, to make the outlet end 22 locate in the inner space of the first container 10, thus completing the coupling of the sealing lid 30 with the canister lid 13 and separation of the sealing lid 30 from the canister lid 13. The mechanical hand is highly flexibile, and realizes the paste pouring, sealing and moisturizing of the outlet end 22 of the outpouring tube 20, but is relatively costly and increase the manufacturing cost of products.

In some embodiments, the first driving mechanism 70 includes a grabbing unit 72 and a driving unit 73, wherein the grabbing unit 72 is configured to grab and release the sealing lid 30; and the driving unit 73 is configured to drive the grabbing unit 72 to move back and forth. By providing the grabbing unit 72 for grabbing and releasing the sealing lid 30, and using the driving unit 73 as a power source, the grabbing unit 72 can be driven to move back and forth, so as to realize the separation of the sealing lid 30 from the first container 10 or connection of the sealind lid 30 with the first container 10.

The grabbing unit 72 is in power connection with the driving unit 73, and the grabbing unit 72 is also connected to the sealing lid 30 of the outlet end 22. Thus, the power of the driving unit 73 can be transmitted to the sealing lid 30 through the grabbing unit 72, and the grabbing unit 72 can drive the outlet end 22 to move, so that the grabbing unit 72 drives the outlet end 22 to move closer to or farther away from the first container 10.

When the grabbing unit 72 drives the outlet end 22 to move closer to the first container 10, the outlet end 22 can be inserted into the first container 10. As the air in the inner space of the first container 10 is humid, or the outlet end 22 is directly inserted into the color paste in the first container 10, the outlet end 22 can be moisturized, thus reducing the probability of dryness and blockage of the outlet end 22.

When the grabbing unit 72 drives the outlet end 22 to move away from the first container 10, when the grabbing unit 72 drives the outlet end 22 to move to the paste-pouring position, the color paste can be pumped into the second container 40 from the outlet end 22.

In the above, the grabbing unit 72 may be a variety of grabbing mechanisms. The sealing lid 30 further includes a flip-top 317 provided on the body 31 of the sealing lid 30. In a situation that the body 31 includes a top wall 310, a first side wall 311 and two opposite side walls 312, the flip-top 317 is provided on the first side wall 311. Correspondingly, for grabbing mechanisms of different structures, structures of corresponding flip-tops 317 on the sealing lid 30 are also different.

In addition, the grabbing unit 72 can drive the sealing lid 30 to move in the horizontal direction or the vertical direction. When the grabbing unit 72 drives the outlet end 22 to move closer to or farther away from the first container 10 in the horizontal direction, a movement track of the outlet end 22 is simple, and thus a structure of the grabbing unit 72 driving the outlet end 22 to move can also be relatively simple, so as to reduce a manufacturing cost of the grabbing unit 72 at least to some extent. Certainly, when the grabbing unit 72 drives the outlet end 22 to move closer to or farther away from the first container 10 in the vertical direction, some extensibility requirements of the colorant dispenser can be met, so as to meet diversification of products.

In a situation that the grabbing unit 72 drives the sealing lid 30 to move in the horizontal direction, referring to FIG. 50 to FIG. 57, the grabbing unit 72 includes a moving member 7201, two clamping arms 7202, two resilient members 7204 and a guiding component, wherein the moving member 7201 is connected to the driving unit 73, and the driving unit 73 is configured to drive the moving member 7201 to move back and forth in a first direction X; the two clamping arms 7202 are distributed at intervals in a second direction Y, wherein each clamping arm 7202 has one end hinged to the moving member 7201 and the other end being a free end, and the first direction X is perpendicular to the second direction Y; each resilient member 7204 is connected between corresponding clamping arm 7202 and the moving member 7201; the guiding component includes two guiding plates 7203 provided opposite to each other in the second direction Y, and the guiding plates 7203 each have a front end 72031 close to the first container 10; when the moving member 7201 drives the two clamping arms 7202 to enter between the two guiding plates 7203 from the front ends 72031, the front ends 72031 extrude corresponding clamping arms 7202, so that the free ends of the two clamping arms 7202 are close to each other, so as to clamp the sealing lid 30; and when the moving member 7201 drives the two clamping arms 7202 to extend from the front ends 72031, the resilient members 7204 drive the free ends of the two clamping arms 7202 to move away from each other.

By connecting the moving member 7201 to the driving unit 73, the moving member 7201 is used as a carrying body of the grabbing unit 72, and the two clamping arms 7202 are provided on the moving member 7201, the two clamping arms 7202 can cooperate with each other to grip and release the sealing lid 30. The guiding component is provided and has a guiding and limiting function, and the two guiding plates 7203 in the guiding component cooperate with the two clamping arms 7202, so that the two clamping arms 7202 can realize clamping and opening states, thus gripping and releasing the sealing lid 30. When the moving member 7201 drives the two clamping arms 7202 to enter between the two guiding plates 7203 from the front ends 72031, the front ends 72031 of the two guiding plates 7203 can respectively extrude the corresponding clamping arms 7202, so that the free ends of the two clamping arms 7202 are close to each other, thus clamping the sealing lid 30, and in this case, the resilient members 7204 accummulate elastic potential energy; when the moving member 7201 drives the two clamping arms 7202 to extend from the front ends 72031 of the guiding plates 7203, the resilient members 7204 release the elastic potential energy, so that the free ends of the two clamping arms 7202 are driven to move away from each other, thus releasing the sealing lid 30.

In the above, the clamping arms 7202 are hinged to the moving member 7201 through hinge shafts, torsional springs are chosen as the resilient members 7204, and the torsional springs are sleeved on the hinge shafts. A distance between the hinge shafts of the two clamping arms 7202 is smaller than a distance between the two guiding plates 7203.

A specific operating process is as follows: when the moving member 7201 drives the two clamping arms 7202 to extend from the front ends 72031 of the two guiding plates 7203, the resilient members 7204 drive the free ends of the two clamping arms 7202 to move away from each other, that is, the two clamping arms 7202 are unfolded under a restoring effect of the two resilient members 7204, and in this case, the sealing lid 30 covers the first opening 102 of the canister lid 13. The driving unit 73 drives a first lead screw 731 to rotate, and a first screw nut 733 moves away from the first container 10, that is, moves towards a rear-end direction of the two guiding plates 7203. As the distance between the hinge shafts of the two clamping arms 7202 is smaller than the distance between the two guiding plates 7203, when the two clamping arms 7202 enter between the two guiding plates 7203 from the front ends 72031, the front ends 72031 of the guiding plates 7203 extrude the corresponding clamping arms 7202, the two clamping arms 7202 overcome elastic forces of the resilient members 7204, so that the two clamping arms 7202 rotate towards a direction in which the free ends of the two clamping arms 7202 approach each other; protrusions 3170 at inner sides of the clamping arms 7202 are embedded in slots 72021 on the sealing lid 30, so as to clamp the sealing lid 30; and the moving member 7201 drives the clamping arms 7202 to continue to move to the paste-pouring position along the rear-end direction of the guiding plate 7203, and the paste is poured into the second container 40 using the outlet end 22 on the sealing lid 30. After the paste pouring has been completed using the outlet end 22 on the sealing lid 30, the first lead screw 731 is rotated reversely, the moving member 7201 drives the two clamping arms 7202 to move towards the front ends 72031 of the guiding plates 7203 until the moving member 7201 brings the two clamping arms 7202 to extend from the front ends 72031 of the guiding plates 7203, in this case, the sealing lid 30 covers the canister lid 13 and closes the first opening 102, and the outlet end 22 is already located in the first container 10. The resilient members 7204 release the elastic potential energy, and drive the free ends of the two clamping arms 7202 to move gradually away from each other, so that the two clamping arms 7202 are detached from the sealing lid 30 until the two clamping arms 7202 are unfolded, and wait for clamping the sealing lid 30 next time.

In addition, after the free ends of the two clamping arms 7202 are unfolded, the two clamping arms 7202 can be distributed in a straight-line shape; and when the free ends of the two clamping arms 7202 move closer to each other and clamp the sealing lid 30, the two clamping arms 7202 can be parallel to each other. The two clamping arms 7202 are in the straight-line shape when being unfolded, in this way, the two clamping arms 7202 are completely separated from the canister lid 13, and will not interfere with the movement of the color-paste canister, thus facilitating next color-paste canister to move to a target position. Moreover, when the two clamping arms 7202 are in a gripping state, the two clamping arms 7202 are parallel to each other, which facilitates that the clamping arms 7202 are completely in contact with a second positioning portion of the canister lid 13, and has a large contact area, and thus the clamping arms 7202 clamp the canister lid 13 more stably.

In some embodiments, sides of the clamping arms 7202 close to the guiding plates 7203 are provided with guiding slopes, wherein the guiding slopes are shaped as arc-shaped surfaces, and the guiding slopes are configured to guide the clamping arms 7202 to rotate once the clamping arms 7202 are extruded by the front ends 72031 of the guiding plates 7203, thus facilitating switching a state of the clamping arms 7202.

In the above, when clamping the sealing lid 30, the clamping arms 7202 can clamp the sealing lid 30 in an extruding way without a connection relationship. Certainly, the clamping arms 7202 can also clamp the sealing lid 30 with a connection relationship, so that the clamping arms 7202 can clamp the sealing lid 30 more stably, the stability of the sealing lid 30 during movement is improved, and the probability of the sealing lid 30 falling during the movement is reduced.

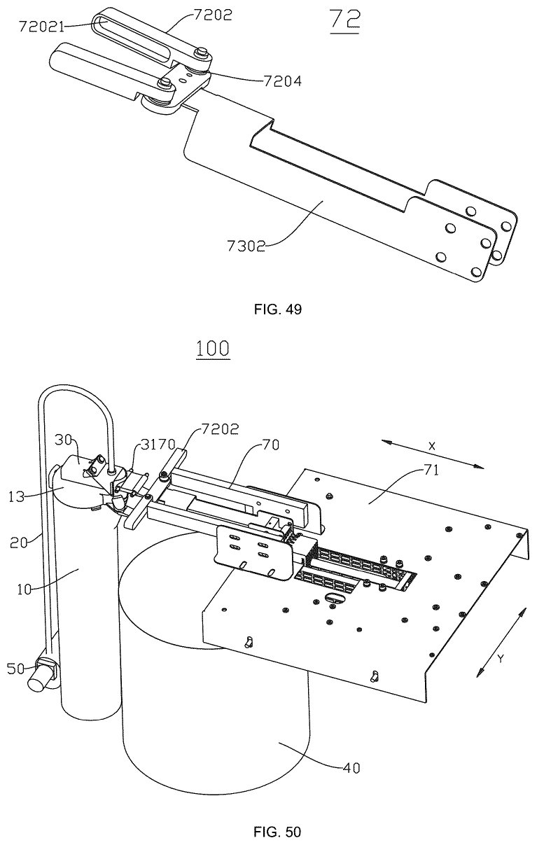

In some embodiments, referring to FIG. 49, inner sides of the clamping arms 7202 are formed with the slots 72021, the sealing lid 30 is provided with the protrusion 3170, and when the clamping arms 7202 clamp the sealing lid 30, the protrusion 3170 is embedded into the slots 72021. By forming the slots 72021 on the clamping arms 7202 and the protrusion 3170 on the sealing lid 30, when the clamping arms 7202 clamp the sealing lid 30, the protrusion 3170 is embedded into the slots 72021, thus realizing clamping of the sealing lid 30 by the clamping arms 7202, improving the stability in a process of the two clamping arms 7202 clamping the sealing lid 30 to move in a region between the two guiding plates 7203, and reducing the probability of the sealing lid 30 falling during the movement.

However, the present disclosure is not limited thereto. Between the clamping arms 7202 and the sealing lid 30, it is also feasible that the inner sides of the clamping arms 7202 are provided with protrusions 3170, and the sealing lid 30 is formed with the slot 72021, and when the clamping arms 7202 clamp the sealing lid 30, the protrusions 3170 are embedded into the slot 72021.

In some embodiments, the slots 72021 extend along a length direction of the clamping arms 7202. By forming the slots 72021 as elongated grooves, even if positions of the clamping arms 7202 are deviated to a certain extent, as the slots 72021 are longer, the protrusion 3170 on the sealing lid 30 can still be embedded into the slots 72021, thus increasing a fault tolerance rate when clamping the sealing lid 30 by the clamping arms 7202.

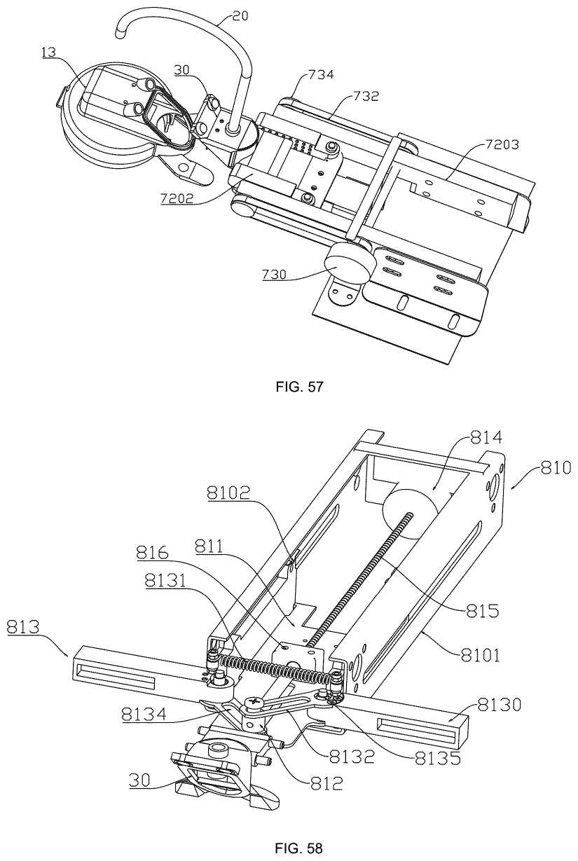

In some embodiments, referring to FIG. 56 and FIG. 57, inner sides of the clamping arms 7202 are provided with a plurality of first anti-slip stripes 72022, the sealing lid 30 is provided with a plurality of second raised points 3171, and when the clamping arms 7202 clamp the sealing lid 30, the plurality of first anti-slip stripes 72022 and the plurality of second raised points 3171 are distributed in a staggered manner. By providing the first anti-slip stripes 72022 on the inner sides of the clamping arms 7202 and the second raised points 3171 on the sealing lid 30, when the clamping arms 7202 clamp the sealing lid 30, the first anti-slip stripes 72022 and the second raised points 3171 are distributed in a staggered manner, so that a frictional force between the sealing lid 30 and the clamping arms 7202 can be increased, the sealing lid 30 and the clamping arms 7202 are unlikely to move relative to each other, and the stability of the sealing lid 30 during movement is improved. In the above, the first anti-slip stripes 72022 and the second raised points 3171 may be made of an elastic material.

In some other embodiments, the grabbing unit 72 can also be other grabbing structures, for example, the grabbing unit 72 may be an electric clamping jaw, a pneumatic clamping jaw, or the like, on a mechanical grabbing arm, for example, when the grabbing unit 72 is an electric clamping jaw, the electric clamping jaw is connected to the driving unit, and the electric clamping jaw can realize an action of gripping or releasing the sealing lid 30. After the driving unit drives the electric clamping jaw to approach the sealing lid 30, the electric clamping jaw first grips the sealing lid 30, and then the driving unit drives the electric clamping jaw to bring the sealing lid 30 to move to the paste-pouring position and perform the paste pouring. Certainly, the grabbing unit can also be other mechanisms.

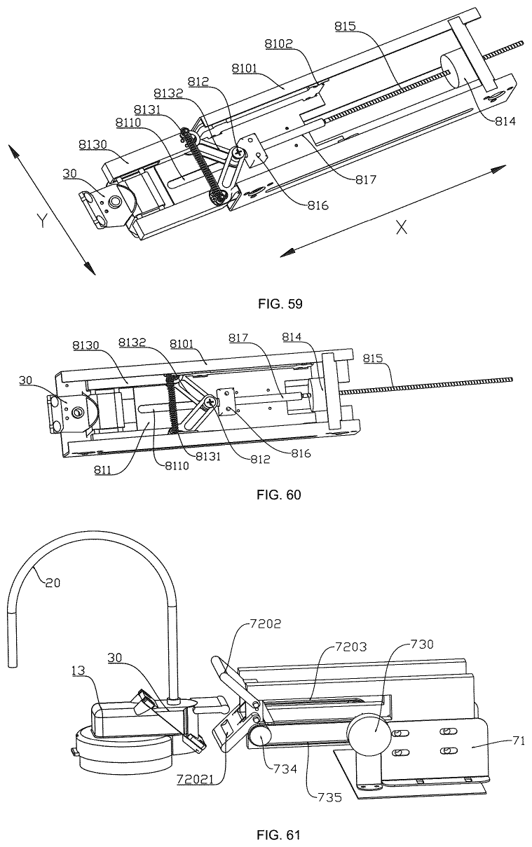

Optionally, referring to FIG. 58, FIG. 59 and FIG. 60, the grabbing unit 72 can further include a mounting rack 810, a gripper base 811, a grappler-arm push column 812 and a clamping component 813, wherein the gripper base 811 is slidably provided on the mounting rack 810 in the first direction X, the mounting rack 810 is correspondingly provided with grappler-arm guiding rails 8101 at two sides of the gripper base 811, and the grappler-arm guiding rails 8101 are slidably fitted with the gripper base 811; the gripper base 811 is formed with a guiding hole 8110 in the first direction X, the grappler-arm push column 812 is slidably provided in the guiding hole 8110, and a driving end of the driving unit is connected to the grappler-arm push column 812. The clamping component 813 includes two grappler-arm driving plates 8132, two grappler arms 8130 and a grappler-arm reset spring 8131, wherein the two grappler arms 8130 are spaced apart from each other on the gripper base 811 in the second direction Y, each grappler arm 8130 has one end hinged to the gripper base 811 and the other end being a free end; sliding holes 8134 formed in the two grappler-arm driving plates 8132 in the middle are connected to an outer cylindrical surface of the grappler-arm push column 812 together in a way of notch sliding connection, the other ends of the two grappler-arm driving plates 8132 are respectively fixed to the two grappler arms 8130, and the two grappler-arm driving plates 8132 are hinged to the gripper base 811 through grappler-arm rotation shafts 8135. The grappler-arm push column 812 is in sliding fit with the sliding holes 8134 on the two grappler-arm driving plates 8132. Two ends of the grappler-arm reset spring 8131 are respectively connected between the two grappler arms 8130, and the grappler-arm reset spring 8131 provides an auxiliary reset force for the grappler arms 8130. The gripper base 811 is provided with a blocking plate 816 on one side of the guiding hole 8110 facing away from the first container, wherein the blocking plate 816 is used for preventing the grappler-arm push column 812 from continuing to slide in the guiding hole 8110, so as to drive the gripper base 811 to slide on the mounting rack 810 in the first direction X.

In the above, the mounting rack 810 is provided with a top leaf spring 8102. The top leaf spring 8102 is provided on the grappler-arm guiding rail 8101 and is used for providing a blocking force for the gripper base 811, so that the grappler-arm push column 812 prevents the gripper base 811 from moving relative to the mounting rack 810 during sliding in the guiding hole 8110. When the grappler-arm push column 812 slides to contact the blocking plate 816, under action of the driving unit 73, the grappler-arm push column 812 can drive the gripper base 811 to compress the top leaf spring 8102 and make the gripper base 811 detach from the top leaf spring 8102 and then slide on the grappler-arm guiding rail 8101.

The driving unit 73 may include a screw motor 814 and a screw 815, wherein the screw motor 814 is mounted on the mounting rack 810, the screw motor 814 is connected to the screw 815, the screw 815 is rotatably mounted on the mounting rack 810, the screw 815 is in threaded fit with a grappler-arm guiding shaft 817, and the grappler-arm guiding shaft 817 is connected to the grappler-arm push column 812.

In addition, the second direction Y may be the vertical direction, that is, the two clamping arms 7202 are spaced apart in the vertical direction, and clamp the flip-top 317 on the sealing lid 30 in an up-down clamping manner. The second direction Y may also be the horizontal direction, that is, the two clamping arms 7202 are spaced apart in the horizontal direction, and clamp the flip-top 317 on the sealing lid 30 in a horizontal clamping manner.

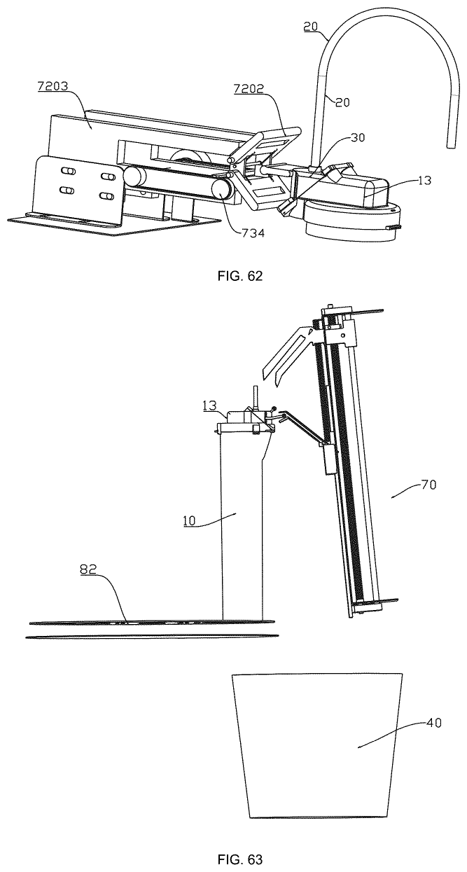

Optionally, referring to FIG. 61 and FIG. 62, the second direction may be the vertical direction. When the second direction is the vertical direction, that is, the two clamping arms 7202 are spaced apart in the vertical direction, and the two clamping arms 7202 clamp the sealing lid 30 in the up-down clamping manner. Likewise, the two guiding plates 7203 in the guiding component can still play a rold in guiding and directing the clamping arms 7202, thus realizing the clamping and releasing of the sealing lid 30 by the clamping arms 7202. Moreover, a clamping arm 7202 of the two clamping arms 7202 located in a lower position can play a certain role in supporting the sealing lid 30, so that the sealing lid 30 is clamped more stably, and the probability of falling of the sealing lid 30 is reduced.

Optionally, the second direction Y is the horizontal direction. The two clamping arms 7202 are spaced apart in the horizontal direction, and the two clamping arms 7202 clamp the sealing lid 30 in the horizontal clamping manner, which likewise can realize the clamping and releasing of the sealing lid 30.

In some embodiments, the first driving mechanism 70 further includes a base 71 to which the driving unit 73 and the guiding component are both mounted. By providing the base 71, the base 71 provides a platform for mounting the driving unit 73 and the guiding component.

In the above, the driving unit 73 may be a variety of linear driving mechanisms, for example, the driving unit 73 may be an air cylinder, a hydraulic cylinder, a linear module, a screw-nut auxiliary mechanism, a linear motor, a timing belt 735 transmission mechanism or a gear-rack transmission mechanism, etc.

Optionally, referring to FIG. 48, the driving unit 73 includes a first driving member 730, the first lead screw 731, a guiding rod 732 and a first screw nut 733, wherein the first driving member 730 is mounted on the base 71, the first lead screw 731 is rotatably mounted on the base 71 in the first direction X, a driving end of the first driving member 730 is in driving connection with the first lead screw 731 for driving the first lead screw 731 to rotate, the guiding rod 732 is provided on the base 71 in the first direction X, the first screw nut 733 is in threaded fit with the first lead screw 731, the first screw nut 733 is slidably provided on the guiding rod 732 in the first direction X, and the moving member 7201 is mounted on the first screw nut 733. By using a first lead screw-nut pair mechanism as the driving unit 73, the first screw nut 733 and the first lead screw 731 are in threaded fit, the first nut 733 is driven by the first driving member 730 to move back and forth along the first lead screw, and transmission accuracy of the first lead screw 731 is relatively high, measurement accuracy of the moving member 7201 can be ensured, and the first lead screw 731 has a simple structure, thus fault points are reduced, reliability thereof can be improved, and the manufacturing cost can also be greatly reduced.

Specifically, under a driving effect of the first driving member 730, the first lead screw 731 is driven by the first driving member 730 to rotate in an axial direction thereof. As the first screw nut 733 is not only in threaded fit with the first lead screw 731, but also in sliding fit with the guiding rod 732, under a rotating effect of the first lead screw 731, the guiding rod 732 prevents the first screw nut 733 from rotating with the first lead screw 731. Therefore, under a limiting effect of the guiding rod 732, the first screw nut 733 can only move back and forth on the first lead screw 731 in the first direction X, thereby driving the moving member 7201 to move back and forth in the first direction X.

In the above, one or two guiding rods 732 may be provided. In the present embodiment, one guiding rod 732 is provided. The first driving member 730 is a pull rod motor, also called as forward-reverse motor. The driving unit 73 further includes a motor base 7301 and a pull rod rack 730. The first lead screw 731 is rotatably mounted on the pull rod rack 7302. The pull rod motor is fixedly mounted on the base 71 through the motor base 7301. A drive shaft of the pull rod motor is connected to one end of the first lead screw 731 through a coupling 7303, and the other end of the first lead screw 731 is rotatably mounted on the pull rod rack 7302 through a bearing. The guiding rod 732 is fixedly mounted in the pull rod rack 7302 and is provided in the same direction as an extension direction of the first lead screw 731. The first screw nut 733 is in threaded fit with the first lead screw 731 and is in sliding fit with the guiding rod 732. The moving member 7201 is a frame structure. The moving member 7201 is fixedly mounted on the first screw nut 733. The pull rod rack 7302 or the base 71 is fixed with fixing plates on two sides of the first lead screw 731, and the two guiding plates 7203 are respectively fixedly mounted to inner sides of the two fixing plates through screws.

Optionally, referring to FIG. 56 to FIG. 62, the driving unit 73 includes the first driving member 730, the pulley 734 and the timing belt 735, wherein the first driving member 730 is mounted on the base 71, the pulley 734 is rotatably mounted on the base 71, the first driving member 730 is configured to drive the pulley 734 to rotate, the timing belt 735 is in transmission fit with the pulley 734 and is provided to extend in the first direction X, and the moving member 7201 is connected to the timing belt 735 and moves with the timing belt 735 on the base 71 in the first direction X under action of the first driving member 730. By a transmission method in which a timing belt 735 is used as the driving unit 73, the moving member 7201 can be more stably drived to move back and forth in the first direction X, so as to ensure that the grabbing unit 72 accurately grabs or release the sealing lid 30. Moreover, by the transmission method in which the driving unit 73 is the timing belt 735, a length thereof in the first direction X is generally shorter than that of a lead screw-nut pair or a linear guiding rail module, so that a length of a space occupied by this mechanism can be reduced, overall cost thereof is relatively low, and in terms of routine maintenance and repair, it is more convenient and more economical to maintain and disassemble the timing belt 735.

When the grabbing unit 72 drives the sealing lid 30 to move in the vertical direction:

In some embodiments, referring to FIG. 63 to FIG. 67, the grabbing unit 72 includes a bracket 736, a press-down portion 738 and a sliding rail 737, wherein the bracket 736 is used for mounting the driving unit 73; the press-down portion 738 is connected to the driving unit 73, and the driving unit 73 is configured to drive the press-down portion 738 to be slidably provided on the bracket 736 in the vertical direction; the sliding rail 737 is obliquely provided on the bracket 736, and the press-down portion 738 is used for driving the outlet end 22 to move along an extension direction of the sliding rail 737, so that the outlet end 22 is close to or away from the first container 10 in the vertical direction and the horizontal direction.

By providing the sliding rail 737, the sliding rail 737 can guide the press-down portion 738 to move, and the press-down portion 738 applies a downward pressure to the outlet end 22 on the sealing lid 30. The outlet end 22 can be driven by the driving unit 73 to move closer to or away from the first container 10 in the vertical direction and the horizontal direction, in this way, the outlet end 22 and the sealing lid 30 can be displaced in the horizontal direction and the vertical direction when being moved, so that when the grabbing unit 72 drives the outlet end 22 of the sealing lid 30 to move away from the first container 10, displacement in the vertical direction can be achieved. Compared with that the grabbing unit 72 drives the sealing lid 30 to move in the horizontal direction to pour the paste, the outlet end 22 on the sealing lid 30 can be closer to the second container 40, and the second container 40 can also be placed below the first container 10, thus reducing the space occupied by the colorant dispenser 100 in the horizontal direction, and making the structure of the colorant dispenser more compact.

In some embodiments, the sliding rail 737 has a first guiding slot 7371 extending along a length direction thereof, the sealing lid 30 is provided with a first pull-connection end 3172 and a second pull-connection end 3173, wherein the first pull-connection end 3172 optionally slides in the first guiding slot 7371, and the first guiding slot 7371 has a first opening end 7372 for the first pull-connection end 3172 to be detached from the first guiding slot 7371. A height of the sliding rail 737 is gradually decreased in the direction of approaching the bracket 736. The grabbing unit 72 further includes a supporting portion 739, wherein the supporting portion 739 is provided on the bracket 736 through a tension spring 7391, and the tension spring 7391 extends in the vertical direction, wherein the tension spring 7391 has an upper end connected to the bracket 736 and a lower end connected to the supporting portion 739, and the supporting portion 739 is slidably provided on the bracket 736 and located below the opening end of the sliding rail. The press-down portion 738 includes two press-down claws 7381 provided opposite each other, wherein the press-down claws 7381 have a second guiding slot 7832, the second pull-connection end 3173 optionally slides in the second guiding slot 7382. The second guiding slot 7382 has a first upper stop end 7384 close to the bracket 736 and a second opening end 7383 away from the bracket 736, wherein a height of the first upper stop end 7384 is greater than that of the second opening end 7383. The driving unit 73 is configured to drive the press-down claw 7381 to move on the bracket 736 in the vertical direction.

In the above, as shown in FIG. 67, when the press-down claws 7381 are moved downwards to a third position, the sealing lid 30 slides along the first guiding slot 7371 to be separated from the first opening end 7372 and then is supported by the supporting portion 739, the second pull-connection end 3173 slides along the second guiding slot 7382 to be abutted against by the first upper stop end 7384, and the sealing lid 30 completes the movement in the horizontal direction and is close to the bracket 736. When the press-down claws 7381 continue to move downwards and drive the sealing lid 30 and the supporting portion 739 to move downwards together to the paste-pouring position, the tension spring 7391 accumulates elastic potential energy. When the press-down claws 7381 are moved upwards to the third position, the supporting portion 739 can push the first pull-connection end 3172 of the sealing lid 30 to enter the first guiding slot 7371 through the opening end, and the second pull-connection end 3173 is separated from the first upper stop end 7384, and can move along the first guiding slot 7371 and the second guiding slot 7382 toward a side away from the bracket 736 to an initial position.

In the above technical solution, after the second guiding slot 7382 in the two press-down claws 7381 in the press-down portion 738 is connected to the corresponding second pull-connection end 3173 on the sealing lid 30, a downward pressure can be applied to the sealing lid 30, then the pull-connection end of the sealing lid 30 can slide along the first guiding slot 7371 and the second guiding slot 7382, the height of the sliding rail 737 is gradually decreased in the direction of approaching the bracket 736, and the height of the first upper stop end 7384 is greater than that of the second opening end 7383, so that when the press-down portion 738 is moved downwards, the sealing lid 30 can be firstly horizontally displaced to be close to the bracket 736, and then continues to move downwards with the press-down portion 738; when the press-down claws 7381 are moved to the third position, the sealing lid 30 slides along the first guiding slot 7371 and the second guiding slots 7382 until the first pull-connection end 3172 is separated from the first opening end 7372 and then abuts against the supporting portion 739, the second pull-connection end 3173 is abutted against by the first upper stop end 7384, thus the sealing lid 30 completes the movement in the horizontal direction and is close to the bracket 736, and a positioning connection between the sealing lid 30 and the press-down portion 738 is completed. The press-down portion 738 continues to move downwards in the vertical direction, the tension spring 7391 accumulates elastic potential energy, and when the press-down portion 738 is moved to the paste-pouring position, the operation of pouring the paste is performed at the outlet end 22 on the canister lid 13. When the press-down claws 7381 are moved upwards to the third position, the supporting portion 739 pushes the first pull-connection end 3172 of the sealing lid 30 to enter the first guiding slot 7371 through the first opening end 7372, and the second pull-connection end 3173 is separated from the first upper stop end 7384, to complete the separation of the sealing lid 30 from the supporting portion 739, and can move along the first guiding slot 7371 and the second guiding slots 7382 toward a side away from the bracket 736, until the sealing lid 30 is moved to the first opening 102 on the canister lid 13 and perform coupling.

The driving unit 73 includes a motor, a second lead screw 7352, a second screw nut 7353 and a guiding mechanism 7354, wherein the motor drives the second lead screw 7352 to rotate, the second lead screw 7352 is rotatably installed on a vertical frame, the second screw nut 7353 is in threaded fit with the second lead screw 7352, the guiding mechanism 7354 provides a guiding function for the second screw nut 7353, and the press-down portion 738 is mounted on the second screw nut 7353.

Certainly, the grabbing unit 72 can further include a moving member 7201 and a pulling claw, wherein the moving member 7201 is connected to the driving end of the driving unit 73, the moving member 7201 is provided on the pulling claw, a free end of the pulling claw is provided with a hook portion, and the hook portion is provided with a guiding surface, correspondingly, the flip-top 317 on the sealing lid 30 is correspondingly provided with a hanging portion, the hanging portion has a hanging groove, and an opening of the hanging groove faces towards one side of the sealing lid 30, that is, facing away from one side of the moving member 7201. When the moving member 7201 is moved in a direction away from the first container 10, the hook portion of the pulling claw is fitted with the hanging groove, then the moving member 7201 continues to move in a direction away from the first container 10, and the pulling claw brings the sealing lid 30 to move to an outpouring position to pour the paste. After the moving member 7201 brings the sealing lid 30 to move in a direction toward the first container 10 until the sealing lid 30 covers the first opening 102, the moving member 7201 continues to move in a direction toward the first container 10 so as to be separated from the hanging portion.

Although the present disclosure has been described with reference to preferred embodiments, various improvements could be made thereto and the components therein could be replaced with equivalents without departing from the scope of the resent disclosure. In particular, various technical features mentioned in various embodiments can be combined in any way as long as there is no structural conflict. The present disclosure is not limited to specific embodiments disclosed herein, but includes all technical solutions falling within the scope of the claims.

What is claimed is:

1. A colorant dispenser, comprising:
a pump;
a first container, configured to accommodate a color paste;
an outpouring tube, having an inlet end and an outlet end, wherein the inlet end is connected to the first container through the pump, and the outlet end is configured for pouring out the color paste; and
a second container,
wherein the outlet end has an operating state and a non-operating state, when the outlet end is in the operating state, the color paste is pumped out from the outlet end into the second container, and when the outlet end is in the non-operating state, at least a part of the outlet end is located in a moisturizing space of the first container.

2. The colorant dispenser according to claim 1, wherein the moisturizing space is a space in the first container above a liquid level of the color paste.

3. The colorant dispenser according to claim 2, wherein the first container has a first highest liquid-level line, and the moisturizing space is a space in the first container above the first highest liquid-level line.

4. The colorant dispenser according to claim 2, wherein a position of the outlet end is fixed;
when the outlet end is in the non-operating state, the moisturizing space is closed; and
when the outlet end is in the operating state, the moisturizing space is opened to allow the second container to enter the first container.

5. The colorant dispenser according to claim 4, wherein the first container comprises a canister body and a canister lid, wherein the canister body is configured for accommodating the color paste, the canister body has an opening, and the canister lid is configured for covering the opening;
the canister lid comprises a fixed portion and a movable portion, wherein the fixed portion is fixed to the canister body, the outlet end is coupled to the fixed portion, and the outlet end is fixed relative to the canister body; and
the movable portion is configured to move relative to the fixed portion, so as to close or open the moisturizing space.

6. The colorant dispenser according to claim 5, wherein two movable portions are provided, the fixed portion is located between the two movable portions, and the two movable portions are configured to be rotatable relative to the fixed portion, so as to make the two movable portions move closer to or farther away from each other, thereby closing or opening the moisturizing space.

7. The colorant dispenser according to claim 1, wherein the moisturizing space is a space in the first container below a liquid level of the color paste.

8. The colorant dispenser according to claim 1, wherein when the outlet end is in the non-operating state, the outlet end is coupled to the first container, and when the outlet end is in the operating state, the outlet end is detached from the first container.

9. The colorant dispenser according to claim 8, wherein the first container has a first opening, and when the outlet end is in the non-operating state, the outlet end is coupled to the first opening.

10. The colorant dispenser according to claim 9, wherein when the outlet end is in the non-operating state, the outlet end closes the first opening.

11. The colorant dispenser according to claim 9, wherein the first container comprises a canister body and a leading-out pipe, wherein the leading-out pipe has a first end and a second end, the first end is connected to the canister body and communicates with an inner space of the canister body, and the second end has the first opening.

12. The colorant dispenser according to claim 11, wherein the second end is higher than the first end.

13. The colorant dispenser according to claim 9, wherein the first container comprises a canister body and a canister lid, the canister body has a second opening in a top, the canister lid covers the second opening, and the first opening is formed at the canister lid.

14. The colorant dispenser according to claim 13, wherein the outlet end is provided with a sealing structure, and when the outlet end is in the non-operating state, the sealing structure closes the first opening.

15. The colorant dispenser according to claim 14, wherein the sealing structure is a sealing lid, and when the outlet end is in the non-operating state, the sealing lid is coupled with the canister lid.

16. The colorant dispenser according to claim 15, wherein the sealing lid has a first through hole, the outlet end passes through the first through hole and is fixedly connected to the sealing lid.

17. The colorant dispenser according to claim 15, wherein the first container is fixed, and the colorant dispenser further comprises:
a first driving mechanism, wherein the first driving mechanism is configured to drive the sealing lid to move, so as to make the sealing lid couple with or separate from the canister lid.

18. The colorant dispenser according to claim 9, wherein the first container comprises a first sub-container and a second sub-container, the first sub-container has a paste outlet at bottom, the paste outlet communicates with an inner space of the second sub-container, the inner space of the second sub-container communicates with outside, the first opening is formed on a top wall of the second sub-container, and the paste outlet is lower than the top wall of the second sub-container;
an inlet of the pump communicates with the inner space of the second sub-container, and when the outlet end is in the non-operating state, the outlet end is coupled to the first opening and inserted into the inner space of the second sub-container.

19. The colorant dispenser according to claim 8, wherein the first container is provided therein with a partitioning portion so as to divide the inner space of the first container into a first subspace and a second subspace, wherein the first subspace has a volume larger than that of the second subspace, an inlet of the pump communicates with the first subspace; and when the outlet end is in the non-operating state, the outlet end is inserted into the second subspace.

20. The colorant dispenser according to claim 19, wherein the partitioning portion has an overflow hole, the overflow hole is configured to guide the color paste in the second subspace to the first subspace when an amount of the color paste in the second subspace reaches a threshold.
